(19) United States
(12) Patent Application Publication
(10) Pub. No.: US 2024/0266501 A1
(43) Pub. Date: Aug. 8, 2024

(54) LITHIUM-ION BATTERIES WITH HIGH-PERFORMANCE ANODES COMPRISING GRAPHITE(S) AND SILICON-BASED NANOCOMPOSITES

(71) Applicant: Sila Nanotechnologies, Inc., Alameda, CA (US)

(72) Inventors: Gleb Nikolayevich YUSHIN, Atlanta, GA (US); Ismael RODRÍGUEZ PÉREZ, Oakland, CA (US); Samik JHULKI, Emeryville, CA (US); Adam Paul KAJDOS, Alameda, CA (US); Valentin LULEVICH, Stockton, CA (US); Matthew O'Reilly CLARK, Oakland, CA (US); Aditya RAGHUNATHAN, Union City, CA (US); John Frederick TANNACI, Santa Cruz, CA (US)

(21) Appl. No.: 18/434,744

(22) Filed: Feb. 6, 2024

Related U.S. Application Data
(60) Provisional application No. 63/483,680, filed on Feb. 7, 2023.

(51) Int. Cl. H01M 4/36; H01M 4/02; H01M 4/38; H01M 4/583; H01M 10/0525

(52) U.S. Cl. CPC H01M 4/364; H01M 4/386; H01M 4/583; H01M 10/0525; H01M 2004/027

(57) ABSTRACT

A battery anode includes a binder, a conductive additive, and an active material blend including silicon (Si)-comprising active material particles and graphite active material particles. In some embodiments, the battery anode has a reversible capacity loading in a range of about 2 mAh/cm² to about 16 mAh/cm², the silicon (Si)-comprising active material particles exhibit a specific capacity in a range of about 800 mAh/g to about 3000 mAh/g, and the silicon (Si)-comprising active material particles contribute from about 25% to about 99% of a total capacity of the battery anode.

### CROSS-REFERENCE TO RELATED APPLICATIONS

The present Application for Patent claims the benefit of U.S. Provisional Application No. 63/483,680, entitled “LITHIUM-ION BATTERIES WITH HIGH-PERFORMANCE ANODES COMPRISING GRAPHITE(S) AND SILICON-BASED NANOCOMPOSITES,” filed Feb. 7, 2023, assigned to the assignee hereof, and expressly incorporated herein by reference in its entirety.

### BACKGROUND

### Field

Aspects of the present disclosure relate generally to energy storage devices, and more particularly to battery technology and the like.

### Background

Owing in part to their relatively high energy densities, relatively high specific energy, light weight, and potential for long lifetimes, advanced rechargeable batteries are desirable for a wide range of consumer electronics, electric vehicles, grid storage and other important applications. However, despite the increasing commercial prevalence of batteries, further development of these batteries is needed, particularly for applications in low- or zero-emission, hybrid-electric or fully electric vehicles, consumer electronics, wearable devices, energy-efficient cargo ships and locomotives, drones, aerospace applications, and power grids. Further improvements are desired for various rechargeable batteries, such as rechargeable Li and Li-ion batteries, Na and Na-ion batteries, K and K-ion batteries, and dual ion batteries, to name a few.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state). A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries.

In certain types of rechargeable batteries, charge storing anode active materials may be produced as high-capacity (nano)composite powders, which exhibit moderately high volume changes (e.g., about 8-180 vol. %) during the first charge-discharge cycle and moderate volume changes (e.g., about 5-50 vol. % or about 5-50 vol. %) during the subsequent charge-discharge cycles. A subset of such charge-storing anode particles includes anode particles with an average size (e.g., diameter or thickness) in the range of about 0.2 to about 40 microns (micrometers, or μm), as measured using laser particle size distribution analysis (LPSA), laser image analysis, electron microscopy, optical microscopy or other suitable techniques. Such a class of charge-storing particles offers great promises for scalable manufacturing and achieving high cell-level energy density and other performance characteristics.

An example of high-performance anodes may comprise the mixture of novel silicon-based (or, broadly, silicon-comprising) anode active materials with graphite-based active material, so-called silicon-graphite blends. In some examples of a blended anode, the Si-comprising anode active material may be Si-comprising and C-comprising nanocomposite (referred to herein as Si—C composite or Si—C nanocomposite or Si—C composite (or nanocomposite) particles, with the C being separate from the graphite-based active material, even if such particles comprise elements other than Si and C in relatively small quantities of less than about 10-20 at %) is from about 20 to 99% by capacity, while the rest of the capacity is from the graphite-based active material. Such anodes offer much higher volumetric and gravimetric energy density than the intercalation-type graphite-only anodes commonly used in commercial Li-ion batteries. In addition, in such blended anodes, the graphite-based active material may be composed of natural, artificial or a mixture of natural and artificial graphites. The Si—C nanocomposite-graphite blended anodes may offer overall moderate volume changes during the first cycle and low volume changes during the subsequent charging cycles.

However, when blended anodes are produced using graphite(s) typically used in Li-ion batteries and with novel Si-based (or, broadly, silicon-comprising, e.g., nanocomposite) anode active materials, the blended anodes typically suffer from insufficiently high stability, excessive volume changes, insufficiently high electrical and ionic conductivity, low packing density, insufficiently high volumetric capacity and other limitations.

Accordingly, there remains a need for improved batteries, components, and other related materials and manufacturing processes.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a battery anode includes a binder; a conductive additive; and an active material blend comprising silicon (Si)-comprising active material particles and graphite active material particles, wherein: the battery anode has a reversible capacity loading in a range of about 2 mAh/cm² to about 16 mAh/cm²; the Si-comprising active material particles exhibit a specific capacity in a range of about 800 mAh/g to about 3000 mAh/g; the Si-comprising active material particles contribute from about 25% to about 99% of a total capacity of the battery anode; and at least a subset of the graphite active material particles is characterized by a Raman spectrum in which a full-width half-maximum (FWHM) of a D band is in a range of about 30 cm⁻¹ to about 90 cm⁻¹, a FWHM of a G band is in a range from about 5 cm⁻¹ to about 105 cm⁻¹, a FWHM of a 2D₁ band is in a range from about 30 cm⁻¹ to about 110 cm⁻¹, and a D/G peak intensity ratio, defined as an intensity of a D peak divided by an intensity of a G peak, is in a range from about 0.02 to about 1.12.

In some aspects, the D/G peak intensity ratio is in a range from about 0.12 to about 0.30.

In some aspects, a 2D₁/G peak intensity ratio, defined as an intensity of a 2D₁ peak of the Raman spectrum divided by the intensity of the G peak, is in a range from about 0.10 to about 0.90.

In some aspects, the at least the subset of the graphite active material particles is characterized by an X-ray diffraction (XRD) spectrum in which a FWHM of a (002) reflection peak is within a range from about 0.220 degrees to about 5.620 degrees.

In some aspects, the FWHM of the (002) reflection peak is within a range from about 0.220 degrees to about 0.620 degrees.

In some aspects, an average crystallite size of the at least the subset of the graphite active material particles as estimated by applying the Scherrer formula to the (002) reflection peak is in a range of about 1 nm to about 40 nm.

In some aspects, the average crystallite size is within a range of about 15 nm to about 30 nm.

In some aspects, an average pressure (Cx) required to deform the at least the subset of the graphite active material particles by 10% during a micro-compression hardness test ranges from about 1 MPa to about 30 MPa.

In some aspects, the average pressure ranges from about 1 MPa to about 18 MPa.

In some aspects, a tap density of the at least the subset of the graphite active material particles ranges from about 0.10 g/cc to about 1.25 g/cc.

In some aspects, the tap density ranges from about 0.90 g/cc to about 1.10 g/cc.

In some aspects, a pycnometry density of the at least the subset of the graphite active material particles ranges from about 2.15 g/cc to about 2.35 g/cc.

In some aspects, a fiftieth-percentile volume-weighted particle size parameter (D₅₀) of the at least the subset of the graphite active material particles ranges from about 2 m to about 22 m.

In some aspects, the D₅₀ ranges from about 12 m to about 17 m.

In some aspects, a ninetieth-percentile volume-weighted particle size parameter (D₉₀) of the at least the subset of the graphite active material particles ranges from about 4 m to about 30 m.

In some aspects, the D₉₀ ranges from about 19 μm to about 26 m.

In some aspects, a tenth-percentile volume-weighted particle size parameter (D₁₀) of the at least the subset of the graphite active material particles ranges from about 0.5 m to about 15 μm.

In some aspects, the D₁₀ ranges from about 7 μm to about 11 am.

In some aspects, a Brunauer-Emmett-Teller (BET) specific surface area (SSA) of the at least the subset of the graphite active material particles ranges from about 0.450 m²/g to about 450 m²/g.

In some aspects, the BET-SSA ranges from about 1 m²/g to about 5 m²/g.

In some aspects, a weight fraction of the at least the subset of the graphite active material particles in the battery anode is in a range of about 1 wt. % to about 50 wt. % of the active material blend.

In some aspects, the weight fraction is in a range of about 2 wt. % to about 20 wt. % of the active material blend.

In some aspects, the Si-comprising active material particles comprise oxygen (O) atoms at about 5 wt. % or less of a total mass of the Si-comprising active material particles.

In some aspects, the Si-comprising active material particles comprise silicon (Si) atoms and carbon (C) atoms, in aggregate, in a range of 80 wt. % to about 100 wt. % of a total mass of the Si-comprising active material particles.

In some aspects, the Si-comprising active material particles comprise Si—C nanocomposite particles.

In some aspects, the at least the subset of the graphite active material particles exhibits a specific capacity in a range of about 320 mAh/g to about 372 mAh/g.

In an aspect, a lithium-ion battery includes a battery anode; a cathode; a separator electrically separating the battery anode and the cathode; and an electrolyte ionically coupling the battery anode and the cathode.

In an aspect, a battery anode includes a binder; a conductive additive; and an active material blend comprising silicon (Si)-comprising active material particles and graphite active material particles, wherein: a mass fraction of the Si in the Si-comprising active material particles is in a range of about 20 wt. % to about 80 wt. %; a mass ratio of the Si-comprising active material particles to the graphite active material particles is in a range of about 60:40 to about 98:2; at least a subset of the graphite active material particles is characterized by a Raman spectrum in which a full-width half-maximum (FWHM) of a D band is in a range of about 30 cm⁻¹ to about 90 cm¹, a FWHM of a G band is in a range from about 5 cm⁻¹ to about 105 cm¹, a FWHM of a 2D₁ band is in a range from about 30 cm⁻¹ to about 110 cm¹, and a D/G peak intensity ratio, defined as an intensity of a D peak divided by an intensity of a G peak, is in a range from about 0.02 to about 1.12; and an average pressure (Cx) required to deform the at least the subset of the graphite active material particles by 10% during a micro-compression hardness test ranges from about 1 MPa to about 18 MPa.

In some aspects, the mass ratio of the Si-comprising active material particles to the graphite active material particles is in a range of about 75:25 to about 95:5.

In some aspects, the average pressure ranges from about 7 MPa to about 18 MPa.

In some aspects, the average pressure ranges from about 10 MPa to about 18 MPa.

In some aspects, the D/G peak intensity ratio is in a range from about 0.12 to about 0.30.

In some aspects, a tap density of the at least the subset of the graphite active material particles ranges from about 0.10 g/cc to about 1.25 g/cc.

In some aspects, the tap density ranges from about 0.90 g/cc to about 1.10 g/cc.

In some aspects, a fiftieth-percentile volume-weighted particle size parameter (D₅₀) of the at least the subset of the graphite active material particles ranges from about 2 m to about 22 m.

In some aspects, the D₅₀ ranges from about 11 m to about 17 m.

In some aspects, the D₅₀ ranges from about 12 m to about 17 m.

In some aspects, a ninetieth-percentile volume-weighted particle size parameter (D₉₀) of the at least the subset of the graphite active material particles ranges from about 4 m to about 30 m.

In some aspects, the D₉₀ ranges from about 19 μm to about 30 am.

In some aspects, the D₉₀ ranges from about 19 μm to about 26 m.

In some aspects, a tenth-percentile volume-weighted particle size parameter (D₁₀) of the at least the subset of the graphite active material particles ranges from about 0.5 m to about 15 m.

In some aspects, the D₁₀ ranges from about 5 am to about 11 am.

In some aspects, the D₁₀ ranges from about 7 am to about 11 am.

In some aspects, a Brunauer-Emmett-Teller (BET) specific surface area (SSA) of the at least the subset of the graphite active material particles ranges from about 0.450 m²/g to about 450 m²/g.

In some aspects, the BET-SSA ranges from about 1 m²/g to about 5 m²/g.

In some aspects, the BET-SSA ranges from about 1 m²/g to about 3 m²/g.

In some aspects, the Si-comprising active material particles comprise oxygen (O) atoms at about 5 wt. % or less of a total mass of the Si-comprising active material particles.

In some aspects, the Si-comprising active material particles comprise silicon (Si) atoms and carbon (C) atoms, in aggregate, in a range of about 80 wt. % to about 100 wt. % of a total mass of the Si-comprising active material particles.

In some aspects, the Si-comprising active material particles comprise Si—C nanocomposite particles.

In some aspects, the at least the subset of the graphite active material particles exhibits a specific capacity in a range of about 320 mAh/g to about 372 mAh/g.

In some aspects, the battery anode has a reversible capacity loading in a range of about 2 mAh/cm² to about 16 mAh/cm².

In an aspect, a lithium-ion battery includes a battery anode; a cathode; a separator electrically separating the battery anode and the cathode; and an electrolyte ionically coupling the battery anode and the cathode.

In an aspect, a battery anode includes a binder; a conductive additive; and an active material blend comprising silicon (Si)-comprising active material particles and graphite active material particles, wherein: a mass fraction of the Si in the Si-comprising active material particles is in a range of about 20 wt. % to about 80 wt. %; a mass ratio of the Si-comprising active material particles to the graphite active material particles is in a range of about 7:93 to about 40:60; at least a subset of the graphite active material particles is characterized by a Raman spectrum in which a full-width half-maximum (FWHM) of a D band is in a range of about 30 cm⁻¹ to about 90 cm⁻¹, a FWHM of a G band is in a range from about 5 cm⁻¹ to about 105 cm⁻¹, a FWHM of a 2D₁ band is in a range from about 30 cm⁻¹ to about 110 cm⁻¹, and a D/G peak intensity ratio, defined as an intensity of a D peak divided by an intensity of a G peak, is in a range from about 0.02 to about 1.12; and an average pressure (Cx) required to deform the at least the subset of the graphite active material particles by 10% during a micro-compression hardness test ranges from about 20 MPa to about 30 MPa.

In some aspects, the mass ratio of the Si-comprising active material particles to the graphite active material particles is in a range of about 10:90 to about 30:70.

In some aspects, the average pressure ranges from about 24 MPa to about 30 MPa.

In some aspects, the D/G peak intensity ratio is in a range from about 0.08 to about 0.30.

In some aspects, a tap density of the at least the subset of the graphite active material particles ranges from about 0.10 g/cc to about 1.25 g/cc.

In some aspects, the tap density ranges from about 0.90 g/cc to about 1.20 g/cc.

In some aspects, the tap density ranges from about 0.90 g/cc to about 1.10 g/cc.

In some aspects, a fiftieth-percentile volume-weighted particle size parameter (D₅₀) of the at least the subset of the graphite active material particles ranges from about 2 m to about 22 m.

In some aspects, the D₅₀ ranges from about 11 m to about 17 m.

In some aspects, the D₅₀ ranges from about 12 m to about 17 m.

In some aspects, a ninetieth-percentile volume-weighted particle size parameter (D₉₀) of the at least the subset of the graphite active material particles ranges from about 4 m to about 30 m.

In some aspects, the D₉₀ ranges from about 19 μm to about 30 m.

In some aspects, a tenth-percentile volume-weighted particle size parameter (D₁₀) of the at least the subset of the graphite active material particles ranges from about 0.5 m to about 15 m.

In some aspects, the D₁₀ ranges from about 5 μm to about 11 m.

In some aspects, a Brunauer-Emmett-Teller (BET) specific surface area (SSA) of the at least the subset of the graphite active material particles ranges from about 0.450 m²/g to about 450 m²/g.

In some aspects, the BET-SSA ranges from about 1 m²/g to about 5 m²/g.

In some aspects, the BET-SSA ranges from about 1 m²/g to about 3 m²/g.

In some aspects, the Si-comprising active material particles comprise oxygen (O) atoms at about 5 wt. % or less of a total mass of the Si-comprising active material particles.

In some aspects. The Si-comprising active material particles comprise silicon (Si) atoms and carbon (C) atoms, in aggregate, in a range of about 80 wt. % to about 100 wt. % of a total mass of the Si-comprising active material particles.

In some aspects, the Si-comprising active material particles comprise Si—C nanocomposite particles.

In some aspects, the at least the subset of the graphite active material particles exhibits a specific capacity in a range of about 320 mAh/g to about 372 mAh/g.

In some aspects, the battery anode has a reversible capacity loading in a range of about 2 mAh/cm² to about 16 mAh/cm².

In an aspect, a lithium-ion battery includes a battery anode; a cathode; a separator electrically separating the battery anode and the cathode; and an electrolyte ionically coupling the battery anode and the cathode.

In an aspect, a battery anode includes a binder; a conductive additive; and an active material blend comprising silicon (Si)-comprising active material particles and graphite active material particles, wherein: the battery anode has a reversible capacity loading in a range of about 2 mAh/cm² to about 16 mAh/cm²; the Si-comprising active material particles exhibit a specific capacity in a range of about 800 mAh/g to about 3000 mAh/g; the Si-comprising active material particles contribute from about 25% to about 99% of a total capacity of the battery anode; and at least some of the graphite active material particles are characterized by a Raman spectrum in which a full-width half-maximum (FWHM) of a D band is in a range of about 30 cm⁻¹ to about 90 cm⁻¹, a FWHM of a G band is in a range from about 5 cm⁻¹ to about 105 cm⁻¹, a FWHM of a 2D₁ band is in a range from about 30 cm⁻¹ to about 110 cm⁻¹, and a D/G peak intensity ratio, defined as an intensity of a D peak divided by an intensity of a G peak, is in a range from about 0.02 to about 1.12.

In some aspects, the D/G peak intensity ratio is in a range from about 0.12 to about 0.30.

In some aspects, a 2D₁/G peak intensity ratio, defined as an intensity of a 2D₁ peak of the Raman spectrum divided by the intensity of the G peak, is in a range from about 0.10 to about 0.90.

In some aspects, the at least some of the graphite active material particles are characterized by an X-ray diffraction (XRD) spectrum in which a FWHM of a (002) reflection is within a range from about 0.220 degrees to about 5.620 degrees.

In some aspects, the FWHM of the (002) reflection is within a range from about 0.220 degrees to about 0.620 degrees.

In some aspects, an average crystallite size of the at least some of the graphite active material particles as estimated by applying the Scherrer formula to the (002) reflection is in a range of about 1 nm to about 40 nm.

In some aspects, the average crystallite size is within a range of about 15 nm to about 30 nm.

In some aspects, an average pressure (Cx) required to deform the at least some of the graphite active material particles by 10% during a micro-compression hardness test ranges from about 1 MPa to about 30 MPa.

In some aspects, the average pressure ranges from about 1 MPa to about 18 MPa.

In some aspects, a tap density of the at least some of the graphite active material particles ranges from about 0.10 g/cc to about 1.25 g/cc.

In some aspects, the tap density ranges from about 0.90 g/cc to about 1.10 g/cc.

In some aspects, a pycnometry density of the at least some of the graphite active material particles ranges from about 2.15 g/cc to about 2.35 g/cc.

In some aspects, a fiftieth-percentile volume-weighted particle size parameter D50 of the at least some of the graphite active material particles ranges from about 2 m to about 22 m.

In some aspects, the D50 ranges from about 12 m to about 17 m.

In some aspects, a ninetieth-percentile volume-weighted particle size parameter D₉₀ of the at least some of the graphite active material particles ranges from about 4 m to about 30 m.

In some aspects, the D₉₀ ranges from about 19 μm to about 26 m.

In some aspects, a tenth-percentile volume-weighted particle size parameter D₁₀ of the at least some of the graphite active material particles ranges from about 0.5 m to about 15 μm.

In some aspects, the D₁₀ ranges from about 7 m to about 11 am.

In some aspects, a Brunauer-Emmett-Teller (BET) specific surface area (SSA) of the at least some of the graphite active material particles ranges from about 0.450 m²/g to about 450 m²/g.

In some aspects, the BET-SSA ranges from about 1 m²/g to about 5 m²/g.

In some aspects, a weight fraction of the at least some of the graphite active material particles in the battery anode is in a range of about 1 wt. % to about 50 wt. % of the active material blend.

In some aspects, the weight fraction is in a range of about 2 wt. % to about 20 wt. % of the active material blend.

In some aspects, the Si-comprising active material particles comprise oxygen (O) atoms at about 5 wt. % or less of a total mass of the Si-comprising active material particles.

In some aspects, the Si-comprising active material particles comprise silicon (Si) atoms and carbon (C) atoms, in aggregate, in a range of 80 wt. % to about 100 wt. % of a total mass of the Si-comprising active material particles.

In some aspects, the Si-comprising active material particles comprise Si—C nanocomposite particles.

In some aspects, the at least some of the graphite active material particles exhibit a specific capacity in a range of about 320 mAh/g to about 372 mAh/g.

In an aspect, a lithium-ion battery includes a battery anode; a cathode; a separator electrically separating the battery anode and the cathode; and an electrolyte ionically coupling the battery anode and the cathode.

Other objects and advantages associated with the aspects disclosed herein will be apparent to those skilled in the art based on the accompanying drawings and detailed description.

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery in which the components, materials, processes, and/or other techniques described herein may be implemented.

FIG. 2 shows a Table 1 listing example graphite particles and/or other electrochemically-active material particles and measured average values of pressure required to deform the respective particles by 10%, denoted as Cx and expressed in MPa.

FIG. 3 shows a Table 2 listing example graphite particle samples and measured values of tap density of the respective graphite particle samples.

FIG. 4 shows a Table 3 listing example graphite particle samples and measured values of the density of the respective graphite particle samples obtained using Nitrogen (N₂) gas pycnometry.

FIGS. 5A, 5B, 5C, 5D, 5E, and 5F show scanning electron microscope (SEM) images of example graphite samples G1, G2, G3, G4, G5, and G6, respectively.

FIG. 6 shows a Table 4 listing example graphite particle samples and values of a tenth-percentile volume-weighted particle size parameter D₁₀, a fiftieth-percentile volume-weighted particle size parameter D₅₀, and a ninetieth-percentile volume-weighted particle size parameter D₉₀, of the particle size distributions (PSDs) of the respective example graphite particle samples.

FIG. 7 shows a Table 5 listing example graphite particle samples and values of Brunauer-Emmett-Teller (BET) specific surface area (SSA) of the respective example graphite particle samples.

FIG. 8A shows a graphical plot of x-ray diffraction data for example graphite samples G1, G2, G3, G4, and G6.

FIG. 8B shows a Table 6 listing example graphite particle samples and selected x-ray diffraction data for the respective graphite particle samples.

FIG. 9A shows Raman spectra for example graphite samples G1, G3, G4, and G6.

FIG. 9B shows a Table 7 listing example graphite particle samples and selected Raman data relating to the D and G spectral features for the respective graphite particle samples.

FIG. 9C shows a Table 8 listing example graphite particle samples and selected Raman data relating to the 2D₁ and G spectral features for the respective graphite particle samples.

FIG. 10A shows a graphical plot of the cycle life, expressed as estimated number of cycles to reach 80% of cycling-start gravimetric charge capacity (N80), of lithium-ion battery test cells in which the anodes are blended anodes comprising Si—C nanocomposite particles and respective example graphite particles.

FIG. 10B shows graphical plots of the capacity of lithium-ion battery test cells (“full cells”) in which the each of the anodes is one of the following: (1) a blended anode comprising Si—C nanocomposite particles and a respective example graphite particle sample, and (2) an anode comprising Si—C nanocomposite particles with no graphite particles added. Capacity is normalized by the weight of the anode.

FIG. 10C shows graphical plots of (a) the lithiated anode coating density, (b) the as-coated and calendered coating density, (c) the volumetric energy density, and (d) the volumetric capacity of the anode at cycling start, of lithium-ion battery test cells in which the each of the anodes is one of the following: (1) a blended anode comprising Si—C nanocomposite particles and a respective example graphite particle sample, and (2) an anode comprising Si—C nanocomposite particles with no graphite particles added.

FIG. 11 is a flow diagram of a process of making a Li-ion rechargeable battery cell in accordance with certain embodiments.

FIG. 12 shows graphical plots of the dependence of estimated cycle life (N80) on cycle number for lithium-ion battery test cells: (1) comprising no graphite particles (graphical plot 1202); (2) comprising graphite particles at 10 wt. % of the anode active material (graphical plot 1204); (3) comprising graphite particles at 20 wt. % of the anode active material (graphical plot 1206); and (4) comprising graphite particles at 30 wt. % of the anode active material (graphical plot 1208).

FIG. 13 shows Table 9, listing example graphite particle samples, their selected characteristics (Cx, tap density, particle size distribution (PSD) characteristics, BET-SSA values, and D/G ratio values), and certain battery performance characteristics of lithium-ion battery cells employing the example graphite particle samples, at lower mass fractions of the graphite particles in the respective anode active materials.

FIG. 14 shows Table 10, listing example graphite particle samples, their selected characteristics (Cx, tap density, particle size distribution characteristics, BET-SSA values, and D/G ratio values), and certain battery performance characteristics of lithium-ion battery cells employing the example graphite particle samples, at higher mass fractions of the graphite particles in the respective anode active materials.

FIG. 15 shows Table 11, listing certain anode characteristics (the particle size (D₅₀) values of the respective Si—C nanocomposite particle populations, calendering pressure during battery anode formation, binder material used in battery anode formation) and certain battery performance characteristics of lithium-ion battery cells employing graphite particles (G1) and the Si—C nanocomposite particles (with the graphite particles G1 at a mass fraction of 10 wt. % in the respective anode active materials).

FIG. 16 shows graphical plots of the DC resistance (DCR) values of lithium-ion battery cells employing a PAA salt copolymer-based (acrylic) anode binder (1602) and a CMC:SBR anode binder (1604). Both types of lithium-ion battery cells employed a blended anode of Si—C nanocomposite particles and graphite particles (G1) (with the mass fraction of graphite particles G1 at 10 wt. % of the respective anode active materials).

FIG. 17 shows graphical plots of the dependence of the relative discharge capacities on normalized discharge rate (C-rate) for lithium-ion battery cells employing a PAA salt copolymer-based anode binder (1702) and a CMC:SBR anode binder (1704). Both types of lithium-ion battery cells employed a blended anode of Si—C nanocomposite particles and graphite particles (G1) (with the mass fraction of graphite particles G1 at 10 wt. % of the respective anode active materials).

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

Aspects of the present disclosure provide for processes of making advanced carbon-containing composite particles for use in electrodes (e.g., anode electrodes or cathode electrodes) of Li-ion or Na-ion or K-ion rechargeable batteries, among other types of batteries, electrochemical capacitors and hybrid electrochemical energy storage devices.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., . . . from about −61° C. to about −60° C., as if the intervening numbers (in ° C.) between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around”, “≈” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., binders, molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types, such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| Material | | Measurement | |
|---|---|---|---|
| Type | Property Type | Instrumentation | Measurement Technique |
| Active | Coulombic | Potentiostat | Charge (current) is passed to |
| Material | Efficiency | | an electrode containing the |
| | | | active material of interest until |
| | | | a given voltage limit is |
| | | | reached. Then, the current is |
| | | | reversed (discharge current) |
| | | | until a second voltage limit is |
| | | | reached. The ratio of the two |
| | | | charges passed determines the |
| | | | Coulombic Efficiency (CE). In |
| | | | the simplest case, the charge |
| | | | and discharge currents may be |
| | | | constant and often have |
| | | | absolute values that are the |
| | | | same or close to each other. It |
| | | | should be understood though |
| | | | that in some experiments, |
| | | | either charge current or |
| | | | discharge current or both may |
| | | | be changing during such |
| | | | experiments (e.g., be initially |
| | | | constant and when the voltage |
| | | | limit is reached, diminishing |
| | | | to a predetermined value). In |
| | | | addition, the absolute value of |
| | | | the charge and discharge |
| | | | currents may differ. |
| Active | Partial Vapor | Manometer | The partial vapor pressure of |
| Material | Pressure (e.g., | | an active material in a mixture |
| | Torr.) at a | | (e.g., composite particle) at a |
| | Temperature | | particular temperature is given |
| | (e.g., K) | | by the known vapor pressure |
| | | | of the active material |
| | | | multiplied by its mole fraction |
| | | | in the mixture. |
| Active | Volume | Gas pycnometer | Gas pycnometer measures the |
| Material | | | skeletal volume of a material |
| Particle | | | by gas displacement using the |
| | | | volume-pressure relationship |
| | | | of Boyle's Law. A sample of |
| | | | known mass is placed into the |
| | | | sample chamber and |
| | | | maintained at a constant |
| | | | temperature. An inert gas, |
| | | | typically helium, is used as the |
| | | | displacement medium. |
| | | | Note: A vol. % change may be |
| | | | calculated from two volume |
| | | | measurements of the active |
| | | | material particle. |
| Active | Open Internal | nitrogen | Nitrogen sorption/desorption |
| Material | Pore Volume | sorption/desorption | isotherm (typically at 77 K) is |
| Particle | (e.g., cc/g or | isotherm | collected and analyzed to |
| | cm³/g) | | estimate the total amount of |
| | | | gas adsorbed/desorbed and |
| | | | internal pore volume of the |
| | | | sample with known mass is |
| | | | estimated from such |
| | | | measurements. Pore size |
| | | | distribution (PSD) may be |
| | | | further estimated from the |
| | | | sorption/desorption isotherm |
| | | | using various analyses, such as |
| | | | Non-Local Density Functional |
| | | | Theory (NLDFT) |
| Active | Volume- | PSA, scanning | PSA using laser scattering, |
| Material | Average Pore | electron microscope | electron microscopy (SEM, |
| Particle | Size and Pore | (SEM), transmission | TEM, STEM) in combination |
| | Size | electron microscope | with image analyses, laser |
| | Distributions | (TEM), scanning | microscopy (for larger |
| | (e.g., nm) | transmission | particles and larger pores) in |
| | | microscope (STEM), | combination with image |
| | | laser microscope, | analyses, optical microscopy |
| | | Synchrotron X-ray, | (for larger particles and larger |
| | | X-ray microscope | pores), neutron scattering, X- |
| | | | ray scattering, X-ray |
| | | | microscopy imaging may be |
| | | | employed to measure pore |
| | | | sizes (average pore size or |
| | | | pore size distribution) in |
| | | | different size ranges (in |
| | | | addition to the analysis of the |
| | | | sorption/desorption |
| | | | isotherms). |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas pycnometer |
| | | | (or a nitrogen gas pycnometer) |
| | | | and comparing them to the |
| | | | theoretical density of the |
| | | | individual material |
| | | | components present in Si— |
| | | | comprising particles. In |
| | | | addition, closed internal pore |
| | | | volume may be estimated by |
| | | | comparing the total pore |
| | | | volume estimated from |
| | | | neutron scattering and the |
| | | | nitrogen-accessible pore |
| | | | volume estimated from |
| | | | nitrogen sorption isotherms. |
| Active | Closed | Gas pycnometer | With a pycnometer, the |
| Material | Internal | | amount of a certain medium |
| Particle | Volume- | | (liquid or Helium or other |
| | Average Size | | analytical gases) displaced by |
| | (e.g., nm) | | a solid can be determined. |
| Active | Size | TEM, STEM, SEM, | Laser particle size distribution |
| Material | (e.g., nm, μm, | X-Ray, PSA, etc. | analysis (LPSA), laser image |
| Particle | etc.) | | analysis, electron microscopy, |
| | | | optical microscopy or other |
| | | | suitable techniques |
| | | | transmission electron |
| | | | microscopy (TEM), scanning |
| | | | transmission electron |
| | | | microscopy (STEM), scanning |
| | | | electron microscopy (SEM)), |
| | | | X-ray microscopy, X-ray |
| | | | diffraction, neutron scattering |
| | | | and other suitable techniques |
| Active | Composition | Balance | Note #1: A wt. % change may |
| Material | (e.g., mass | | be calculated by comparing |
| Particle | fraction or wt. | | the mass fraction of a material |
| | %, mg, number of | | in the particle relative to the |
| | atoms, etc.) | | total particle mass. |
| | | | Note #2: The capacity |
| | | | attributable to particular active |
| | | | material(s) in the particle may |
| | | | be derived from the |
| | | | composition, based on the |
| | | | known (e.g., theoretical or |
| | | | practically attainable) |
| | | | capacity(ies) of each active |
| | | | material. |
| | | | Note #3: The composition of |
| | | | the particle may be |
| | | | characterized in terms of |
| | | | weight (e.g., mg). The |
| | | | composition of may |
| | | | alternatively be characterized |
| | | | by a number of atoms of a |
| | | | particular element (e.g., Si, C, |
| | | | etc.). In case of atoms, the |
| | | | number of atoms may be |
| | | | estimated from the weight of |
| | | | that atom in the particle (e.g., |
| | | | based on gas chromatography) |
| Active | Composition | X-ray Fluorescence | |
| Material | (e.g., mass | (XRF), Inductively | |
| Particle | fraction or wt. | Coupled Plasma | |
| | % of various | Optical Emission | |
| | atomic | Spectroscopy (ICP- | |
| | elements or | OES); Energy | |
| | molecules, | Dispersive | |
| | atomic | Spectroscopy (EDS), | |
| | fraction or at. | Wavelength | |
| | % of various | Dispersive | |
| | elements, etc.) | Spectroscopy (WDS), | |
| | | Electron Energy Loss | |
| | | Spectroscopy (EELS), | |
| | | Nuclear Magnetic | |
| | | Resonance (NMR); | |
| | | Secondary Ion Mass | |
| | | Spectrometry (SIMS); | |
| | | X-Ray Photoelectron | |
| | | Spectroscopy (XPS); | |
| | | Fourier Transform | |
| | | Infrared Spectroscopy | |
| | | (FTIR) and Raman | |
| | | Spectroscopy | |
| | | (Raman) | |
| Active | Specific | Potentiostat | An electrode containing an |
| Material | Capacity | | active anode or cathode |
| Particle, | | | material of interest is charged |
| Battery Half- | | | or discharged (by passing |
| Cell | | | electrical current to the |
| | | | electrode) within certain |
| | | | potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) gives |
| | | | this quantity (e.g., in mAh/g). |
| | | | The active mass is computed |
| | | | by multiplying the total mass |
| | | | of the electrode by the active |
| | | | material mass fraction. Both |
| | | | reversible and irreversible |
| | | | capacity during charge or |
| | | | discharge may be calculated in |
| | | | this way. |
| Active | BET SSA | BET instrument | A sample is placed into a |
| Material | (e.g., m²/g) | | sealed chamber at 77 K, where |
| Particle | | | nitrogen is introduced at |
| | | | increasing pressure. The |
| | | | change in pressure of the |
| | | | nitrogen is used to calculate |
| | | | the surface area of the sample. |
| Active | Aspect Ratio | SEM, TEM | The dimensions and shape of |
| Material | | | the particles are typically |
| Particle | | | measured by using SEM or |
| | | | TEM or (for large particles) by |
| | | | using optical microscopy. |
| Active | True Density | Argon Gas | True density values may be |
| Material | of Particle | Pycnometer or | measured by using an argon |
| Particle | (e.g., g/cc or | nitrogen gas | gas pycnometer (or a nitrogen |
| | | pycnometer | gas pycnometer) and |
| | g/cm³) | | comparing to the theoretical |
| | | | density of the individual |
| | | | material components present |
| | | | in the particle. |
| Active | Particle Size | Dynamic light | laser particle size distribution |
| Material | Distribution | scattering particle size | analysis (LPSA) on well- |
| Particle | (e.g., nm or | analyzer, scanning | dispersed particle suspensions |
| Population | μm) | electron microscope | in one example or by image |
| | | | analysis of electron |
| | | | microscopy images, or by |
| | | | other suitable techniques. |
| | | | While there are diverse |
| | | | processes of measuring PSDs, |
| | | | laser particle size distribution |
| | | | analysis (LPSA) is quite |
| | | | efficient for some applications. |
| | | | Note that other types of |
| | | | particle size distribution (e.g., |
| | | | by SEM image analysis) could |
| | | | also be utilized (and may even |
| | | | lead to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D₁₀), a fiftieth- |
| | | | percentile volume-weighted |
| | | | particle size parameter (e.g., |
| | | | abbreviated as D₅₀), a |
| | | | ninetieth-percentile volume- |
| | | | weighted particle size |
| | | | parameter (e.g., abbreviated as |
| | | | D₉₀), and a ninety-ninth- |
| | | | percentile volume-weighted |
| | | | particle size parameter (e.g., |
| | | | abbreviated as D₉₉). |
| Active | Width (e.g., | PSA | Parameters relating to |
| Material | nm) | | characteristic widths of the |
| Particle | | | PSD may be derived from |
| Population | | | these particle size parameters, |
| | | | such as D₅₀-D₁₀ |
| | | | (sometimes referred to herein |
| | | | as a left width), D₉₀-D₅₀ |
| | | | (sometimes referred to herein |
| | | | as a right width), and D₉₀-D₁₀ |
| | | | (sometimes referred to |
| | | | herein as a full width). |
| Active | Cumulative | Computed via LPSA | A cumulative volume fraction, |
| Material | Volume | data | defined as a cumulative |
| Particle | Fraction | | volume of the composite |
| Population | | | particles with particle sizes of |
| | | | a threshold particle size or |
| | | | less, divided by a total volume |
| | | | of all of the composite |
| | | | particles, may be estimated by |
| | | | LPSA. |
| Active | Composition | Balance | The mass of active materials |
| Material | (e.g., wt. %) | | added to the electrode divided |
| Particle | | | by the total mass of the |
| Population | | | electrode. |
| Active | BET SSA | BET Isotherm | obtained from the data of |
| Material | (e.g., m²/g) | | nitrogen sorption-desorption at |
| Particle | | | cryogenic temperatures, such |
| Population | | | as about 77 K |
| Electrolyte | Salt | balance, volumetric | Total volume of the solution is |
| | Concentration | pipette | computed either via the sum of |
| | (e.g., M or | | the volume of the constituents |
| | mol. %) | | (measured by a volumetric |
| | | | pipette), or by the mass of the |
| | | | constituents divided by the |
| | | | density. The molar mass of the |
| | | | salt is then used to calculate |
| | | | the total number of moles of |
| | | | salt in the solution. The moles |
| | | | of salt is then divided by the |
| | | | total volume to obtain the |
| | | | solvent concentration in M |
| | | | (mol/L). |
| Electrolyte | Solvent | balance, volumetric | Total volume of the solution is |
| | Concentration | pipette | computed either via the sum of |
| | (e.g., M or | | the volume of the constituents |
| | mol. %) | | (measured by a volumetric |
| | | | pipette), or by the mass of the |
| | | | constituents divided by the |
| | | | density. The molar volume of |
| | | | each solvent is then used to |
| | | | calculate the total number of |
| | | | moles of solvent in the |
| | | | solution. The moles of solvent |
| | | | is then divided by the total |
| | | | volume to obtain the solvent |
| | | | concentration in M (mol/L). |
| Electrode | Composition | Balance | The mass fraction of a |
| | (e.g., mass | | material (e.g., active material, |
| | fraction or wt. | | active material particle, |
| | %) | | binder, etc.) in the electrode is |
| | | | calculated based on a |
| | | | measured or estimated mass of |
| | | | the material and a measured or |
| | | | estimated mass of the |
| | | | electrode, excluding the |
| | | | electrode current collector. |
| | | | Note: The mass of individual |
| | | | components (e.g., composite |
| | | | active material particles, |
| | | | graphite particles, binder, |
| | | | function additive(s), etc.) of |
| | | | the battery electrode |
| | | | composition may be measured |
| | | | before being mixed into a |
| | | | slurry to estimate their mass in |
| | | | a casted electrode. The mass |
| | | | of materials deposited onto the |
| | | | casted electrode may be |
| | | | measured by comparing the |
| | | | weight of the casted electrode |
| | | | before/after the material |
| | | | deposition. |
| Electrode | Areal Binder | balance | A mass fraction of the binder |
| | Loading (e.g., | | in the battery electrode, |
| | mg/m²) | | divided by a product of (1) a |
| | | | mass fraction of the active |
| | | | material (e.g., Si—C |
| | | | nanocomposite, etc.) particles |
| | | | in the battery electrode, and |
| | | | (2) a Brunauer-Emmett-Teller |
| | | | (BET) specific surface area of |
| | | | the active material particle |
| | | | population. |
| Electrode | Capacity | Calculated | Measure the mass (wt.) of |
| | Attributable | | active material in the |
| | to Active | | electrode, and calculate |
| | Material | | electrode capacity based on |
| | (active | | the known theoretical capacity |
| | material | | of the active material. For |
| | capacity | | example, the average wt. % of |
| | fraction) | | active material in each active |
| | | | material particle may be |
| | | | measured and used to calculate |
| | | | the mass of the active material |
| | | | based on the mass of the active |
| | | | material particles before being |
| | | | mixed in the slurry. This |
| | | | process may be repeated if the |
| | | | electrode includes two or more |
| | | | active materials to calculate |
| | | | the relative capacity |
| | | | attribution for each active |
| | | | material in the electrode. |
| Electrode | Capacity | Potentiostat and | Determine the average specific |
| | Attributable | balance | capacity (mAh/g) of active |
| | to Active | | material particles. For |
| | Material | | example, the average specific |
| | Particles | | capacity may be estimated |
| | (active | | from the average wt. % of |
| | material | | active material(s) in each |
| | particle | | particle and its associated |
| | capacity | | known theoretical |
| | fraction) | | capacity(ies). Then, measure |
| | | | the mass (wt.) of active |
| | | | material particles in the |
| | | | electrode before being mixed |
| | | | in slurry, which may be used |
| | | | to calculate the capacity |
| | | | attributable to that active |
| | | | material. This process may be |
| | | | repeated if the electrode |
| | | | includes two or more active |
| | | | material particle types to |
| | | | calculate the relative capacity |
| | | | attribution for each active |
| | | | material particle type in the |
| | | | electrode. |
| Electrode | Mass of | balance | The average wt. % of active |
| | Active | | material in each active |
| | Material in | | material particle may be |
| | Electrode | | measured, and used to |
| | | | calculate the mass of the |
| | | | active material based on the |
| | | | mass of the active material |
| | | | particles before being mixed in |
| | | | slurry. |
| Electrode | Mass of | balance | Measure the active material |
| | Active | | particle before the active |
| | Material | | material particle type is mixed |
| | Particle in | | in the slurry. |
| | Electrode | | |
| Electrode | Areal | Potentiostat and | Areal capacity loading is the |
| | Capacity | balance | weight of the coated active |
| | Loading (e.g., | | material per unit area (g/cm²) |
| | mAh/cm²) | | multiplied by the gravimetric |
| | | | capacity of the active material |
| | | | (not the electrode, but the |
| | | | active material itself with zero |
| | | | binder and zero electrolyte; |
| | | | mAh/g). |
| Electrode | Coulombic | Potentiostat | The change in charge inserted |
| | Efficiency | | (or extracted) to an electrode |
| | | | divided by the charge |
| | | | extracted (or inserted) from |
| | | | the electrode during a |
| | | | complete electrochemical |
| | | | cycle within given voltage |
| | | | limits. Because the direction |
| | | | of charge flow is opposite for |
| | | | cathodes and anodes, the |
| | | | definition is dependent on the |
| | | | electrode. |
| | | | Coulombic Efficiency is |
| | | | measured for both materials by |
| | | | constructing a so-called half- |
| | | | cell, which is an |
| | | | electrochemical cell consisting |
| | | | of a cathode or anode material |
| | | | of interest as the working |
| | | | electrode and a lithium metal |
| | | | foil which functions as both |
| | | | the counter and reference |
| | | | electrode. Then, charge is |
| | | | either inserted or removed |
| | | | from the material of interest |
| | | | until the cell voltage reaches |
| | | | an appropriate limit. Then, the |
| | | | process is reversed until a |
| | | | second voltage limit is |
| | | | reached, and the charge passed |
| | | | in both steps is used to |
| | | | calculate the Coulombic |
| | | | Efficiency, as described |
| | | | above. |
| Battery Cell | Rate | Potentiostat | This is the time it takes to |
| | Performance | | charge or discharge a battery |
| | | | between a given state of |
| | | | charge. It is measured by |
| | | | charging or discharging a |
| | | | battery and measuring the time |
| | | | until a specified amount of |
| | | | charge is passed, or until the |
| | | | battery operating voltage |
| | | | reaches a specified value. |
| Battery Cell | Cell | Potentiostat | A battery consisting of a |
| | Discharge | | relevant anode and cathode is |
| | Voltage | | charged and discharged within |
| | (e.g., V) | | certain voltage limits and the |
| | | | charge-weighted cell voltage |
| | | | during discharge is computed. |
| Battery Cell | Operating | Potentiostat and | Average temperature of |
| | Temperature | thermocouples | battery cell as measured at the |
| | | | positive/negative terminal/ |
| | | | cell shaft/etc. while |
| | | | charging/discharging, or at a |
| | | | certain voltage level, or while |
| | | | a load is applied, etc. |
| Battery Half- | Anode | Potentiostat | An electrode containing an |
| Cell | Discharge | | active anode material (or a |
| | (de-lithiation) | | mixture of active materials) of |
| | Potential | | interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell potential |
| | | | upon discharge (corresponding |
| | | | to de-lithiation of the anode) is |
| | | | computed. |
| Battery Half- | Cathode | Potentiostat | An electrode containing an |
| Cell | Discharge | | active cathode material (or a |
| | (lithiation) | | mixture of active materials) of |
| | Potential | | interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell potential |
| | | | upon discharge (corresponding |
| | | | to lithiation of the cathode) is |
| | | | computed. |
| Battery Cell | Volumetric | Potentiostat | The VED is calculated by first |
| | Energy | | calculating the energy per unit |
| | Density | | area of the battery, and then |
| | (VED) | | dividing the energy per unit |
| | | | area by the sum of the |
| | | | illustrative anode, cathode, |
| | | | separator, and current collector |
| | | | thicknesses |
| Battery Cell | Internal | Potentiostat | The internal resistance (also |
| | Resistance | | known as impedance in many |
| | (impedance) | | contexts) is measured by |
| | | | applying small pulses of |
| | | | current to the battery cell and |
| | | | recording the instantaneous |
| | | | change in cell voltage. |

In certain aspects, the disclosure relates to batteries. While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline ion batteries, flow batteries, etc.) as well as electrochemical capacitors and hybrid energy storage devices.

While the description below may describe certain examples in the context of composites comprising specific (e.g., alloying-type or conversion-type) active anode materials (such as Si, among others) or specific (e.g., intercalation-type or conversion-type) active cathode materials, it will be appreciated that various aspects may be applicable to many other types and chemistries of conversion-type anode and cathode active materials, intercalation-type anode and cathode active materials, pseudocapacitive anode and cathode active materials, and materials that may exhibit mixed electrochemical energy storage mechanisms.

While the description below may also describe certain examples of the material formulations in a Li-free state (for example, as in silicon-comprising nanocomposite anodes or metal fluoride cathodes or sulfur cathodes, etc.), it will be appreciated that various aspects may be applicable to Li-comprising electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, Zr, Ti, Mg, Nb, and various other metals and metal alloys and mixtures of such and/or other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated intercalation-type cathode materials, partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Unless stated or implied otherwise, reference to such Li-dependent anode material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector.

While the description below may describe certain examples in the context of some specific alloying-type, conversion-type and intercalation-type chemistries for anode active materials and conversion-type and intercalation-type chemistries for cathode active materials for Li-ion batteries (such as silicon-comprising anodes or metal fluoride-comprising or lithium sulfide-comprising cathodes), it will be appreciated that various aspects may be applicable to other chemistries for Li-ion batteries (other conversion-type and alloying-type electrodes as well as various intercalation-type anodes and cathodes) as well as to other battery chemistries. In the case of metal-ion batteries (such as Li-ion batteries), examples of other suitable conversion-type electrodes include, but are not limited to, metal fluorides, metal oxyfluorides, metal chlorides, metal iodides, metal bromides, sulfur, metal sulfides (including, but not limited to lithium sulfide), selenium, metal selenide (including, but not limited to lithium sulfide), metal oxides, metal nitrides, metal phosphides, metal hydrides, their various mixtures, composites (including nanocomposites) and alloys and others.

During battery (such as a Li-ion battery) operation, conversion materials change (convert) from one crystal structure to another (hence the name “conversion”-type), where a material structure and composition may chemically and structurally change to one or multiple structures. This process is also accompanied by breaking chemical bonds and forming new ones. During battery (e.g., Li-ion battery) operation, Li ions are inserted into alloying-type materials forming lithium alloys (hence the name “alloying”-type). Sometimes, “alloying”-type electrode materials are considered to be a subclass of “conversion”-type electrode materials.

While the description below may describe certain examples in the context of Si—C composite (e.g., nanocomposite) anode active materials (e.g., nanocomposite particles which comprise silicon (Si) and carbon (C) and may comprise other elements, such as nitrogen (N), phosphorus (P), boron (B), oxygen (O), hydrogen (H), sulfur (S), fluorine (F), to name a few and where a total mass of the Si and the C atoms may contribute from about 75 wt. % to about 100 wt. % of the total mass of the composite particles), it will be appreciated that various aspects may be applicable to other types of the high-capacity silicon-comprising anode active materials (including but not limited to, for example, various silicon-comprising or silicon oxide-comprising or silicon nitride-comprising or silicon oxy-nitride-comprising or silicon phosphide-comprising particles or particles comprising a mixture or alloy or other combinations of such active materials, various other types of Si-comprising composites including, but not limited to core-shell or hierarchical or nanocomposite particles, etc.).

An aspect is directed to a battery anode and/or a battery anode precursor composition comprising a population of Si-comprising particles (e.g., nanocomposite particles, among others), in which some or all of the Si-comprising particles comprise silicon (Si) and carbon (C) elements and may comprise other elements, such as nitrogen (N), phosphorus (P), boron (B), oxygen (O), hydrogen (H), sulfur (S), fluorine (F), to name a few. In some embodiments, the total mass of the Si and the C (on average) in the Si-comprising particles may contribute from about 75 wt. % to about 100 wt. % of the total mass of the Si-comprising particles. Such composite particles are sometimes referred to herein as Si—C composites (or nanocomposites, if Si and/or C are nanostructures, for example).

In some embodiments, the total mass of O may contribute (on average) from about 0 wt. % to about 10 wt. % of the total mass of the Si-comprising particles (in some designs, from about 0 wt. % to about 1 wt. %; in other designs, from about 1 wt. % to about 2.5 wt. %; in other designs, from about 2.5 wt. % to about 5 wt. %; in other designs, from about 5 wt. % to about 10 wt. %). In some embodiments, the total mass of O may contribute (on average) to less than about 5 wt. % of the total mass of the Si-comprising particles. In some embodiments, the total mass of N may contribute (on average) from about 0 wt. % to about 10 wt. % of the total mass of the Si-comprising particles (in some designs, from about 0 wt. % to about 0.1 wt. %; in other designs, from about 0.1 wt. % to about 2 wt. %; in other designs, from about 2 wt. % to about 5 wt. %; in yet other designs, from about 5 wt. % to about 10 wt. %). In some embodiments, the total mass of P may contribute (on average) from about 0 wt. % to about 10 wt. % of the total mass of the Si-comprising particles (in some designs, from about 0 wt. % to about 0.1 wt. %; in other designs, from about 0.1 wt. % to about 1 wt. %; in other designs, from about 1 wt. % to about 5 wt. %; in yet other designs, from about 5 wt. % to about 10 wt. %). In some embodiments, the total mass of B may contribute (on average) from about 0 wt. % to about 5 wt. % of the total mass of the Si-comprising particles (in some designs, from about 0 wt. % to about 0.1 wt. %; in other designs, from about 0.1 wt. % to about 2.5 wt. %; in yet other designs, from about 2.5 wt. % to about 5 wt. %). In some embodiments, the total mass of H may contribute (on average) from about 0 wt. % to about 2 wt. % of the total mass of the Si-comprising particles (in some designs, from about 0 wt. % to about 0.5 wt. %; in other designs, from about 0.5 wt. % to about 1 wt. %; in yet other designs, from about 1 wt. % to about 2 wt. %). In some embodiments, the total mass of S may contribute (on average) from about 0 wt. % to about 2.5 wt. % of the total mass of the Si-comprising particles (in some designs, from about 0 wt. % to about 0.1 wt. %; in other designs, from about 0.1 wt. % to about 0.5 wt. %; in yet other designs, from about 0.5 wt. % to about 2.5 wt. %). In some embodiments, the total mass of F may contribute (on average) from about 0 wt. % to about 2.5 wt. % of the total mass of the Si-comprising particles (in some designs, from about 0 wt. % to about 0.1 wt. %; in other designs, from about 0.1 wt. % to about 0.5 wt. %; in yet other designs, from about 0.5 wt. % to about 2.5 wt. %).

In some embodiments, a total atomic fraction of the Si and the C may contribute from about 75 at. % or about 80 at. % to about 100 at. % of the overall composite particles. Such composite particles are sometimes referred to herein as Si—C composites. In some embodiments, such composite particles comprise nano-sized or nanostructured elements (e.g., nano-sized or nanostructured Si, Si nanoparticles, nanoporous Si nanoparticles, nano-sized, nanoporous or nanostructured C, or both), which may be referred to as nanocomposite particles. In some implementations, the Si or Si-comprising active material present in such nanocomposites may be in the form of nanoparticles. In some implementations, the mass-average size of Si or Si-comprising material nanoparticles (e.g., silicon nanoparticles or nanocrystals) may range from about 1 nm to about 200 nm (in some designs, from about 1.0 nm to about 10.0 nm; in other designs, from about 10.0 nm to about 30.0 nm; in yet other designs, from about 30.0 nm to about 100.0 nm; in yet other designs, from about 100.0 nm to about 200.0 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and/or other suitable techniques. In some designs, Si or Si-comprising material nanoparticles (e.g., silicon nanoparticles) may be doped (e.g., in some designs with Group V or Group III elements, such as N, P, B, etc.; or, in other designs, with Group IV elements, such as C, etc.; or their various combinations). The degree of doping may range from about 10 ppm to about 50,000 ppm (e.g., in some designs, from about 10 ppm to about 100 ppm; in other designs, from about 100 ppm to about 1000 ppm; in other designs, from about 1000 ppm to about 10,000 ppm; in yet other designs, from about 10,000 ppm to about 50,000 ppm), in some designs. X-ray diffraction may be particularly convenient and easy for identifying the average size of Si nanocrystals. Too small (e.g., smaller than about 1.0 nm in some designs or, e.g., about 2 nm in other designs) Si nanocrystals may exhibit too high reactivity during synthesis and become less active or induce too high fist cycle capacity losses, while too large (e.g., larger than about 200 nm in some designs or, e.g., about 100 nm in other designs) Si crystals may reduce cycle stability of such Si—C composites (nanocomposites) or, broadly, nanocomposite silicon. As used here, a “nano”-material (e.g., nanostructure or nanoparticle or nanocomposite, etc.) may refer to any material that exhibits at least one dimension that is less than about 200 nm.

An aspect is directed to a battery anode and/or a battery anode precursor composition comprising a population of Si-comprising composite particles (e.g., nanocomposite particles, among others), in which each of the Si-comprising composite particles comprises Si and C, and the Si-comprising composite particles have certain characteristics. In some embodiments, a mass fraction of the silicon in the Si-comprising composite particles is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 50 wt. % to about 60 wt. %; in yet other designs, from about 60 to about 70 wt. %; in yet other designs, from about 70 wt. % to about 80 wt. %; in yet other designs, from about 20 wt. % to about 80 wt. %; in yet other designs, from about 35 wt. % to about 60 wt. %). In some embodiments, a Brunauer-Emmett-Teller (BET) specific surface area (SSA) of the Si-comprising composite particles (e.g., nanocomposite particles, among others) is in a range of about 0.5 m²/g to about 150 m²/g (in some designs, from about 0.5 to about 3 m²/g; in other designs, from about 3 m²/g to about 12 m²/g; in yet other designs, from about 12 m²/g to about 18 m²/g; in yet other designs, from about 18 m²/g to about 30 m²/g; in other designs, from about 30 m²/g to about 50 m²/g; in yet other designs, from about 50 m²/g to about 150 m²/g). In some embodiments, about 90% or more of the Si-comprising composite particles (e.g., nanocomposite particles, among others) in the population are characterized by aspect ratios of about 2.3 or less, or aspect ratios of about 2.1 or less. In some embodiments, about 50% or more of the composite particles in the population are characterized by aspect ratios of about 1.25 or more, or aspect ratios of about 1.35 or more.

An aspect is directed to a battery electrode and/or a battery electrode precursor composition comprising a population of Si-comprising active material particles (e.g., nanocomposite particles, among others), in which the particle population of may be characterized by a particle size distribution (PSD) as determined by laser particle size distribution analysis (LPSA), image analysis of electron microscopy images, or other suitable techniques. The particle size distribution (PSD) that characterizes a particle population may be determined by laser particle size distribution analysis (LPSA) on well-dispersed particle suspensions in one example or by image analysis of electron microscopy images, or by other suitable techniques. While there are diverse processes of measuring PSDs, laser particle size distribution analysis (LPSA) is quite efficient for some applications. Using LPSA, particle size parameters of a population's PSD can be measured, such as: a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). Additionally, parameters relating to characteristic widths of the PSD may be derived from these particle size parameters, such as D₅₀-D₁₀ (sometimes referred to herein as a left width), D₉₀-D₅₀ (sometimes referred to herein as a right width), and D₉₀-D₁₀ (sometimes referred to herein as a full width). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD of Si-comprising active material particles may advantageously be in a range of about 0.5 μm to about 25.0 μm, or in a range of about 0.5 to about 4.0 μm, or in a range of about 4.0 to about 6.0 μm, or in a range of about 6.0 to about 8.0 μm or in a range of about 8.0 to about 16.0 μm or in a range of about 16.0 to about 25.0 μm. A cumulative volume fraction, defined as a cumulative volume of the composite particles with particle sizes of a threshold particle size or less, divided by a total volume of all of the composite particles, may be estimated by LPSA. In some embodiments (e.g., when the D₅₀ is in a range from about 0.5 μm to about 4.0 μm), the cumulative volume fraction, with the threshold particle size at 5 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 4.0 μm to about 6.0 μm), the cumulative volume fraction, with the threshold particle size at 7 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 6.0 μm to about 8.0 μm), the cumulative volume fraction, with the threshold particle size at 10 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 8.0 μm to about 16.0 μm), the cumulative volume fraction, with the threshold particle size at 20 μm, may advantageously be about 99 vol. % or less, or about 95 vol. % or less, or about 90 vol. % or less, or about 85 vol. % or less, or about 80 vol. % or less. In yet other embodiments (e.g., when the D₅₀ is in a range from about 16.0 μm to about 25.0 μm), the cumulative volume fraction, with the threshold particle size at 30 μm, may advantageously be about 99 vol. % or less, or about 95 vol. % or less, or about 90 vol. % or less, or about 85 vol. % or less, or about 80 vol. % or less. In some embodiments, D₅₀ in a range from about 7.0 μm to about 13.0 μm may be particularly advantageous. In such embodiments, the cumulative volume fraction, with the threshold particle size at 20 μm, may advantageously be about 99 vol. % or less, or about 95 vol. % or less, or about 90 vol. % or less, or about 85 vol. % or less, or about 80 vol. % or less.

Note that in some designs the presence of excessively large Si-comprising active material particles (e.g., in the form of nanocomposite particles, among others) may reduce cell performance characteristics (e.g., reduce cell stability, increase its impedance, reduce rate performance, reduce packing density, reduce electrode smoothness or uniformity, reduce electrode mechanical properties, reduce volumetric capacity, increase (e.g., localized) volume expansion, etc.). In some embodiments (e.g., when the D₅₀ is in a range from about 0.5 μm to about 4.0 μm), the cumulative volume fraction, with the threshold particle size at about 10 μm, may advantageously be about 80 vol. % or more, or about 85 vol. % or more, or (in some designs) even about 90 vol. % or more. In some embodiments (e.g., when the D₅₀ is in a range from about 0.5 μm to about 4.0 μm), the cumulative volume fraction, with the threshold particle size at 12 μm, may advantageously be about 90 vol. % or more, or about 95 vol. % or more, or (in some designs) even about 98 vol. % or more. In other embodiments (e.g., when the D₅₀ is in a range from about 4.0 μm to about 6.0 μm), the cumulative volume fraction, with the threshold particle size at 15 μm, may advantageously be about 80 vol. % or more, or about 85 vol. % or more, or (in some designs) even about 90 vol. % or more. In other embodiments (e.g., when the D₅₀ is in a range from about 4.0 μm to about 6.0 μm), the cumulative volume fraction, with the threshold particle size at 25 μm, may advantageously be about 90 vol. % or more, or about 95 vol. % or more, or (in some designs) even about 98 vol. % or more. In other embodiments (e.g., when the D₅₀ is in a range from about 6.0 μm to about 8.0 μm), the cumulative volume fraction, with the threshold particle size at about 18 μm, may advantageously be about 80 vol. % or more, or about 85 vol. % or more, or (in some designs) even about 90 vol. % or more. In other embodiments (e.g., when the D₅₀ is in a range from about 6.0 μm to about 8.0 μm or from about 8.0 μm to about 12.0 μm), the cumulative volume fraction, with the threshold particle size at about 22 μm or about 25 μm, may advantageously be about 80 vol. % or more, or about 85 vol. % or more about 90 vol. % or more, or about 95 vol. % or more, or (in some designs) even about 98 vol. % or more. In other embodiments (e.g., when the D₅₀ is in a range from about 8.0 μm to about 16.0 μm or from about 12.0 μm to about 16.0 μm), the cumulative volume fraction, with the threshold particle size at about 30 μm or about 40 μm, may advantageously be about 80 vol. % or more, or about 85 vol. % or more, or (in some designs) even about 90 vol. % or more. In other embodiments (e.g., when the D₅₀ is in a range from about 8.0 μm to about 16.0 μm), the cumulative volume fraction, with the threshold particle size at 50 μm, may advantageously be about 90 vol. % or more, or about 95 vol. % or more, or (in some designs) even about 98 vol. % or more. In other embodiments (e.g., when the D₅₀ is in a range from about 7.0 μm to about 13.0 μm), the cumulative volume fraction, with the threshold particle size at 30 μm, may advantageously be about 90 vol. % or more, or about 95 vol. % or more, or (in some designs) even about 98 vol. % or more. In other embodiments (e.g., when the D₅₀ is in a range from about 7.0 μm to about 13.0 μm), the cumulative volume fraction, with the threshold particle size at 40 μm, may advantageously be about 90 vol. % or more, or about 95 vol. % or more, or (in some designs) even about 98 vol. % or more.

In one or more embodiments of the present disclosure, Si-comprising active material particles (e.g., Si-comprising active material composite particles) may exhibit true density (e.g., as measured by using nitrogen gas pycnometer, hence in this case sometimes referred to as pycnometer-measured density or pycnometer density or pyc density) in the range from about 1.1 g/cc to about 2.8 g/cc (in some designs, from about 1.1 g/cc to about 1.5 g/cc; in other designs, from about 1.5 g/cc to about 1.8 g/cc; in other designs, from about 1.8 g/cc to about 2.1 g/cc; in other designs, from about 2.1 g/cc to about 2.4 g/cc; in yet other designs, from about 2.4 g/cc to about 2.8 g/cc).

In one or more embodiments of the present disclosure, Si-comprising active material particles may comprise internal pores. In some designs, the open (e.g., to nitrogen gas at 77K) pore volume (e.g., as measured by nitrogen sorption/desorption isotherm measurement technique and including the pores in the range from about 0.4 nm to about 100 nm) may range from about 0.00 cc/g to about 0.50 cc/g (assuming theoretical density of the individual material components present in Si-comprising active material particles)-in some designs, from about 0.00 cc/g to about 0.10 cc/g; in other designs, from about 0.10 cc/g to about 0.20 cc/g; in other designs, from about 0.20 cc/g to about 0.30 cc/g; in other designs, from about 0.30 cc/g to about 0.40 cc/g; in other designs, from about 0.40 cc/g to about 0.50 cc/g. In some designs, the closed (e.g., to nitrogen gas at 77K) pore volume (e.g., measured by analyzing true density values measured by using an argon gas pycnometer and comparing to the theoretical density of the individual material components present in Si-comprising active material particles) may range from about 0.00 cc/g to about 1.00 cc/g-in some designs, from about 0.00 cc/g to about 0.10 cc/g; in other designs, from about 0.10 cc/g to about 0.20 cc/g; in other designs, from about 0.20 cc/g to about 0.30 cc/g; in other designs, from about 0.30 cc/g to about 0.40 cc/g; in other designs, from about 0.40 cc/g to about 0.50 cc/g; in other designs, from about 0.50 cc/g to about 0.60 cc/g; in other designs, from about 0.60 cc/g to about 0.70 cc/g; in other designs, from about 0.70 cc/g to about 0.80 cc/g; in other designs, from about 0.80 cc/g to about 0.90 cc/g; in other designs, from about 0.90 cc/g to about 1.00 cc/g). In some designs, the volume-average size of the open (e.g., to nitrogen gas at 77K) pores may range from about 0.5 nm to about 100 nm-in some designs, from about 0.5 nm to about 5 nm; in other designs, from about 5 nm to about 20 nm; in other designs, from about 20 nm to about 50 nm; in yet other designs, from about 50 nm to about 100 nm. In some designs, the volume-average size of the closed (e.g., to nitrogen gas at 77K) pores (e.g., measured by image analysis of cross-sectional electron microscopy images such as SEM or TEM or measured by the neutron scattering or other suitable technique) may range from about 0.5 nm to about 200 nm-in some designs, from about 0.5 nm to about 5 nm; in other designs, from about 5 nm to about 20 nm; in other designs, from about 20 nm to about 50 nm; in other designs, from about 50 nm to about 100 nm; in yet other designs, from about 100 nm to about 200 nm.

In one or more embodiments of the present disclosure, Si-comprising active material particles may exhibit moderate (e.g., about 7-120 vol. %) or high (e.g., about 120-200 vol. %) volume changes during initial lithiation (e.g., down to around 0.01 V vs. Li/Li+). In some designs, Si-comprising active material particles may exhibit volume changes in the range from about 8 vol. % to about 180 vol. % during one or more charge-discharge cycles of the battery cell. In one or more embodiments of the present disclosure, Si-comprising active material particles may exhibit moderately small (e.g., about 3-7 vol. %) or moderate (e.g., about 7-120 vol. %) volume changes during electrochemical battery cycling from about 0-5% state of charge (SOC) to about 90-100% SOC and back during battery operation.

In one or more embodiments of the present disclosure, a preferred anode for a battery cell may comprise a mixture of Si-comprising active material particles (e.g., nanocomposite Si—C particles, nanocomposite Si particles, among others) and graphite active material particles (or, more broadly, carbon active material particles) as the anode active material particles, a so-called blended anode. In addition to the anode active material particles, an anode may comprise inactive material, such as binder(s) (e.g., polymer binder) and/or other functional additives (e.g., surfactants, electrically conductive additives, etc.). In some implementations, the anode active material particles may be in a range of about 85 wt. % to about 89 wt. %; in other designs, from about 89 wt. % to about 98 wt. % of the total weight of the anode (not counting the weight of the current collector)-in some designs, from about 89 wt. % to about 91 wt. %; in other designs, from about 91 wt. % to about 93 wt. %; in other designs, from about 93 wt. % to about 95 wt. %; in yet other designs, from about 95 wt. % to about 98 wt. %.

In some implementations, blended anodes may comprise Si-comprising active material particles (e.g., Si—C nanocomposite particles, among others) ranging from about 7 wt. % to about 98 wt. % of all the anode active material particles and the graphite (e.g., particles) making up the remainder of the mass (the weight) of the anode active material particles (from about 2 wt. % to about 93 wt. %). In some designs, the Si-comprising active material particles (e.g., Si—C nanocomposite particles, etc.) comprise from about 7 wt. % to about 15 wt. % of the blended anode active material particles; in other designs—from about 15 wt. % to about 25 wt. % of the blended anode active material particles; in other designs—from about 25 wt. % to about 40 wt. % of the blended anode active material particles; in other designs—from about 40 wt. % to about 60 wt. % of the blended anode active material particles; in other designs—from about 60 wt. % to about 80 wt. % of the blended anode active material particles; in yet other designs—from about 80 wt. % to about 98 wt. % of the blended anode active material particles.

While the descriptions below may also describe certain examples of the blended anode formulations expressed as mass (wt. %) of Si-comprising active material particles (e.g., Si—C nanocomposite particles, among others) among the anode active materials or as mass (wt. %) of Si-comprising active material particles (e.g., Si—C nanocomposite particles, etc.) in the total anode (not counting the weight of the current collector), it will be appreciated that various aspects of this disclosure may be applicable to blended anode formulations expressed as wt. % of Si in the anode (counting the weight of all the active material particles, binder, conductive and/or other additives, but not counting the weight of the current collector). In some implementations, a blended anode composition of about 7 wt. % of Si-comprising active material particles (e.g., Si—C nanocomposite particles, among others) (relative to the total weight of all the active materials in the anode, binder(s), conductive and/or other additive(s), but not counting the weight of the current collector) may correspond, for example, to about 3 wt. % of Si in the blended anode. In some implementations, a blended anode composition of about 19 wt. % of Si-comprising active material particles (e.g., Si—C nanocomposite particles, among others) may correspond, for example, to about 8 wt. % of Si in the blended anode. In some implementations, a blended anode composition of about 35 wt. % of Si-comprising active material particles (e.g., Si—C nanocomposite particles, among others) may correspond, for example, about 15 wt. % of Si in the blended anode. In some implementations, a blended anode composition of about 50 wt. % of Si-comprising active material particles (e.g., Si—C nanocomposite particles, among others) may correspond, for example, to about 21 wt. % of Si in the blended anode. In some implementations, a blended anode composition of about 70 wt. % of Si-comprising active material particles (e.g., Si—C nanocomposite particles, among others) may correspond, for example, to about 30 wt. % of Si in the blended anode. In some implementations, a blended anode composition of about 90 wt. % of Si-comprising active material particles (e.g., Si—C nanocomposite particles, among others) may correspond, for example, to about 38 wt. % of Si in the blended anode. The wt. % of Si in the anode depends on the wt. % of Si in the Si-comprising active material particles, the wt. % of the binder and conductive additives and the wt. % of the graphite in the blended anode. Smaller fractions of inactive materials (e.g., binder and conductive or other additives), higher fraction of Si in the Si-comprising anode material particles (e.g., Si—C composite particles) and smaller fraction of graphite in the blended anode result in higher wt. % Si in the anode. For example, in some implementations, a blended anode composition of about 80 wt. % of Si-comprising active material particles (e.g., Si—C nanocomposite particles, among others) and about 20 wt. % of the total of binder(s), conductive or other additive(s) (if present) and graphite may correspond, for example, to about 30 wt. % of Si in the blended anode. In other implementations, a blended anode composition of about 80 wt. % of Si-comprising active material particles (e.g., Si—C nanocomposite particles, among others) and about 20 wt. % of the total of binder(s), conductive or other additive(s) (if present) and graphite may correspond, for example, to about 40 wt. % of Si in the blended anode. In other implementations, a blended anode composition of about 80 wt. % of Si-comprising active material particles (e.g., Si—C nanocomposite particles, among others) and about 20 wt. % of the total of binder(s), conductive or other additive(s) (if present) and graphite may correspond, for example, to about 50 wt. % of Si in the blended anode. In other implementations, a blended anode composition of about 80 wt. % of Si-comprising active material particles (e.g., Si—C nanocomposite particles, among others) and about 20 wt. % of the total of binder(s), conductive or other additive(s) (if present) and graphite may correspond, for example, to about 60 wt. % of Si in the blended anode. In respective implementations, blended anodes may be obtained in which the mass (weight) of the silicon is in a range of about 3 wt. % to about 60 wt. % of a total mass of the anode (not counting the weight of the current collector).

While the descriptions below may also describe certain examples of the blended anode formulations expressed as mass (wt. %) of Si-comprising active material particles (e.g., Si—C nanocomposite particles, etc.) in the active material blends, it will be appreciated that various aspects of this disclosure may be applicable to blended anode formulations attributing a fraction (e.g., %) of the total capacity of the blended anode to the capacity of the Si-comprising active material particles. In some implementations, for example, about 25% of the total capacity of the blended anode may be obtained from the Si-comprising active material particles (e.g., Si—C nanocomposite particles, etc.) in a blended anode composition of about 5-8 wt. % of Si-comprising active material particles (e.g., Si—C nanocomposite particles, etc.) relative to the total weight of active material particles (both Si-comprising and graphite active material particles). In some other implementations, as another example, about 50% of the total capacity of the blended anode may be obtained from the Si-comprising active material particles (e.g., Si—C nanocomposite particles, etc.) in a blended anode composition of about 15-21 wt. % of Si-comprising active material particles (e.g., Si—C nanocomposite particles, etc.). In some other implementations, about 70% of the total capacity of the blended anode may be obtained from the Si-comprising active material particles (e.g., Si—C nanocomposite particles, etc.) in a blended anode composition of about 30-40 wt. % of Si-comprising active material particles (e.g., Si—C nanocomposite particles, etc.). In some other implementations, about 80% of the total capacity of the blended anode may be obtained from the Si-comprising active material particles (e.g., Si—C nanocomposite particles, etc.) in a blended anode composition of about 45-55 wt. % of active material Si-comprising active material particles (e.g., Si—C nanocomposite particles, etc.). In some other implementations, about 92% of the total capacity of the blended anode may be obtained from the Si-comprising active material particles (e.g., Si—C nanocomposite particles, etc.) in a blended anode composition of about 65-75 wt. % of Si-comprising active material particles (e.g., Si—C nanocomposite particles, etc.). In some other implementations, about 95% of the total capacity of the blended anode may be obtained from the Si-comprising active material particles (e.g., Si—C nanocomposite particles, etc.) in a blended anode composition of about 75-85 wt. % of Si-comprising active material particles (e.g., Si—C nanocomposite particles, etc.). In some other implementations, about 98% of the total capacity of the blended anode may be obtained from the Si-comprising active material particles (e.g., Si—C nanocomposite particles, etc.) in a blended anode composition of about 85-95 wt. % of Si-comprising active material particles (e.g., Si—C nanocomposite particles, etc.). Note that the exact % capacity provided by the Si-comprising active material particles in the blended anode having a specific wt. % of the Si-comprising active material particles depends on the specific capacity of the plurality of the Si-comprising active material particles and the specific capacity of the plurality of graphite (or, broadly, carbon) active material particles.

In some embodiments, the battery anode composition may advantageously comprise one, two or more carbon-comprising functional additives (e.g., additives that enhance electrical conductivity or rate performance of mechanical properties of the electrode). In some embodiments, the carbon-comprising functional additive(s) is (are) selected from: carbon nanotubes (CNTs) (e.g., single walled carbon nanotubes (SWCNTs), double walled carbon nanotubes (DWCNTs), multi-walled carbon nanotubes (MWCNTs)), carbon nanofibers, carbon black, graphite, graphite ribbons, exfoliated graphite (e.g., exfoliated graphite flakes), graphene oxide (e.g., graphite oxide flakes) and graphene (e.g., flakes) (including, but not limited to, e.g., single-layered and/or multi-layered graphene or graphene oxide). In some embodiments, carbon additives may be purified, defective, curved and/or comprise chemical functional groups. In some embodiments, the battery electrode composition may comprise one or more binders (in some designs, two or more binder components).

An aspect is directed to a battery anode. In some embodiments, the battery anode comprises any of the foregoing battery anode electrode compositions, disposed on or in a current collector (e.g., Cu-based or Cu-containing current collector, such as a dense or porous foil or a mesh or a foam or a nanowire-comprising or nanoflake-comprising current collector, etc.). In some embodiments, the battery anode comprises a battery electrode composition and a binder. In some embodiments, a coating density of the battery electrode is in a range of about 0.8 to about 1.7 g/cm³ (in some designs, from about 0.8 to about 0.9 g/cm³; in other designs, from about 0.9 to about 1.0 g/cm³; in other designs, from about 1.0 to about 1.2 g/cm³; in other designs, from about 1.2 to about 1.4 g/cm³, in yet other designs, from about 1.4 to about 1.7 g/cm³). Higher fraction of suitable graphite material in a blended anode may benefit from higher anode density for better performance (e.g., better stability, better rate performance, higher volumetric capacity, lower swell during cycling, etc.), although excessive density may also be detrimental for the same or other characteristics. As such, a detailed optimization may be conducted for a particular battery design, with respect to factors such as electrode thickness, areal capacity loading, battery cycling environment and regime, among other factors.

An aspect is also directed to a blended battery anode, wherein both the Si-comprising anode active material particles (e.g., nanocomposite Si—C particles, among others) and graphite (or, broadly, carbon-based) active anode material may be present. The anode may preferably comprise a binder amount optimized for the properties of both the Si-comprising active material particles and the graphite particles. For example, the anode may be characterized by an areal binder loading, defined as a mass of the binder in the battery anode (e.g., measured in mg) normalized by the surface area of the active material particles (e.g., Si-comprising (e.g., nanocomposite, etc.) anode active material particles and (if present) graphite active material particles in the same battery anode (e.g., measured in m² and defined by the mass of active material particles (in g) multiplied by the Brunauer-Emmett-Teller (BET) specific surface area (SSA) in m²/g). Since a BET-SSA of both the Si-comprising active material particle population and the graphite active material particle population may vary from slurry to slurry, the binder loading may preferably be adjusted based on the desired areal binder loading. Higher BET-SSA of the active anode materials (measured in m²/g) typically requires a higher mass fraction of the binder in the anode electrode. For example, an anode electrode comprising an active material particle population (e.g., Si-comprising (e.g., nanocomposite, etc.) active anode material particle population or a blend of Si-comprising active material(s) particle(s) and graphite active material(s) particle(s)) with BET-SSA of 10 m²/g would typically require from about 20 mg to about 150 mg of binder per about 1 g of active material particles (approximately 2-13 wt. % relative to the total weight of the binder and the active material composition, not counting the weight of conductive or other additives or the weight of the current collector), while another anode electrode comprising another active material particle population (e.g., Si-comprising (e.g., nanocomposite, etc.) anode active material particle population or a blend of Si-comprising active material(s) particle(s) and graphite active material(s) particle(s)) with BET-SSA of only about 1 m²/g would typically require from about 2 mg to about 40 mg of the binder per about 1 g of active material particles (approximately 0.2-4 wt. % relative to the total weight of the binder+active material composition, not counting the weight of conductive or other additives or the weight of the current collector). However, in some designs, an areal binder loading of the battery anode in both cases is in the range from about 2.0 mg/m² to about 40.0 mg/m² (e.g. in some designs, from about 2.0 mg/m² to about 5.0 mg/m²; in other designs, from about 5.0 mg/m² to about 9.0 mg/m²; in yet other designs, from about 9.0 mg/m² to about 15.0 mg/m²; in yet other designs, from about 15.0 mg/m² to about 40.0 mg/m²). In some designs, a higher fraction of Si-comprising (e.g., nanocomposite, etc.) anode active material particle population in the anode (relative to the total weight of all active materials) may preferably exhibit a higher areal binder loading. In some designs, a larger average particle size of Si-comprising (e.g., nanocomposite, etc.) anode active material particle population in the anode may preferably require a slightly smaller areal binder loading. In some designs, a larger BET-SSA of Si-comprising (e.g., nanocomposite, etc.) anode active material particle population in the anode may preferably exhibit a slightly higher areal binder loading. In some designs, the areal binder loading may also depend on the binder composition and properties (e.g., adhesion, chemical composition, hardness, elastic modulus when exposed to electrolyte, maximum elongation at break, among others). So, in some designs, the optimal areal binder loading content within a range of about 2.0 mg/m² to about 40.0 mg/m² depends on the anode composition. For example, the optimal areal binder loading content in some designs may range from about 2.0 mg/m² to about 5.0 mg/m²; in other designs, from about 5.0 mg/m² to about 9.0 mg/m²; in yet other designs, from about 9.0 mg/m² to about 15.0 mg/m²; in yet other designs, from about 15.0 mg/m² to about 40.0 mg/m²).

While the description below may describe certain examples of suitable intercalation-type graphites to be used in combination with Si-comprising (e.g., Si—C nanocomposites, etc.) active material particles in a blend, it will be appreciated that various aspects of this disclosure may be applicable to various soft-type synthetic graphite (or soft carbon, broadly), various hard-type synthetic graphite (or hard carbon, broadly), and various natural graphite (which may, for example, be pitch carbon coated, among others); including but not limited to those which exhibit discharge capacity from about 320 to about 372 mAh/g (e.g., in some designs, from about 320 to about 350 mAh/g; or in other designs, from about 350 to about 362 mAh/g; or in other designs, from about 362 to about 372 mAh/g); including but not limited to those which exhibit low, moderate and high swelling; including but not limited to those which exhibit good and poor compression, including but not limited to those which exhibit BET-SSA of about 0.5 to about 40 m²/g (e.g., in some designs, from about 0.5 to about 2 m²/g; or in other designs, from about 2 to about 4 m²/g; or in other designs, from about 4 to about 6 m²/g; or in other designs, from about 6 to about 8 m²/g; or in other designs, from about 8 to about 10 m²/g; or in other designs, from about 10 to about 14 m²/g; or in other designs, from about 14 to about 20 m²/g; or in other designs, from about 20 to about 40 m²/g); including but not limited to those which exhibit lithiation efficiency of about 85-90% and more; including but not limited to those which exhibit true densities ranging from about 1.5 g/cm³ to about 2.3 g/cm³ (e.g., in some designs, from about 1.5 to about 1.8 g/cm³, in other designs, from about 1.8 to about 2.3 g/cm³); including but not limited to those which exhibit poor, moderate, or good cycle life when used in Li-ion battery anodes on their own (e.g., without Si-comprising or other active material particles); including but not limited to those which are coated and comprise coatings with coating thickness to appreciably improve compression and springing during cycling.

An aspect is directed to a battery and an anode comprising Si-comprising active material particles that also comprise C (e.g., Si—C nanocomposite particles, C-coated particles, etc.), wherein the average domain size of C ranges from around 10 Å(1 nm) to around 60 Å (6 nm), as determined by Synchrotron X-ray diffraction (XRD) atomic pair distribution function (PDF) analysis. In an aspect, the C-part of such Si—C composite particles may be inactive, and separate from any C-comprising active material (e.g., graphite) in the anode.

An aspect is directed to a battery and an anode comprising Si-comprising active material particles that also comprise C (e.g., Si—C nanocomposite particles, C-coated particles, etc.), wherein the ratio of intensities of the carbon D band and carbon G band (I_{D}/I_{G}) in the Raman spectra of the majority of Si— and C-comprising particles (measured, for example, using the laser wavelength of about 532 nm; and analyzed, for example, in the spectral range from about 1000 to about 2000 wavenumber cm⁻¹ by fitting two Gaussian peaks after a linear background subtraction in this range) to range from I_{D}/I_{G} of about 0.7 to I_{D}/I_{G} of about 2.7 (in some designs, from about 0.7 to about 0.9; in other designs, from about 0.9 to about 1.2; in other designs, from about 1.2 to about 1.5; in other designs, from about 1.5 to about 1.8; in other designs, from about 1.8 to about 2.1; in other designs, from about 2.1 to about 2.4; in yet other designs, from about 2.4 to about 2.7). In an aspect, the C-part of such Si—C composite particles may be inactive, and separate from any C-comprising active material (e.g., graphite) in the anode.

An aspect is also directed to a Li-ion battery comprising: (i) a suitable blended battery anode (wherein both the Si-comprising anode active material particles (e.g., nanocomposite Si—C particles, among others) and suitable graphite (or, broadly, carbon-based) active anode material (e.g., graphite active material particles) are present in the anode) and (ii) a suitable battery cathode, wherein the suitable cathode may comprise one or more of the following, in some designs: (iia) intercalation-type cathode or (iib) conversion-type cathode (which may include a displacement-type cathode, a chemical transformation type cathode or a true conversion-type cathode) or (iic) a mixed intercalation/conversion type cathode. Illustrative examples of suitable intercalation-type cathodes to be used in preferable cells may include, but are not limited to: lithium nickel cobalt aluminum oxides (NCA), lithium nickel cobalt manganese aluminum oxides (NCMA), lithium nickel oxides (LNO), lithium manganese oxides (LMO), lithium nickel manganese cobalt oxides (NCM), lithium cobalt oxide (LCO), lithium cobalt aluminum oxides (LCAO), lithium iron phosphate (LFP), lithium cobalt phosphate (LCP), lithium manganese phosphate (LMP), lithium manganese iron phosphate (LMFP), lithium nickel phosphate (LiNiPO₄), lithium vanadium fluoro phosphate (LiVFPO₄), lithium iron fluoro sulfate (LiFeSO₄F), various Li excess materials (e.g., lithium excess (rocksalt) transition metal oxides and oxy-fluorides such as Li_{1.211}Mo_{0.467}Cr_{0.3}O₂, Li_{1.3}Mn_{0.4}Nb_{0.3}O₂, Li_{1.2}Mn_{0.4}Ti_{0.4}O₂, Li_{1.2}Ni_{0.333}Ti_{0.333}Mo_{0.133}O₂ and many others), various high capacity Li-ion based materials with partial substitution of oxygen for fluorine or iodine (e.g., rocksalt Li₂Mn_{2/3}Nb_{1/3}O₂F, Li₂Mn_{1/2}Ti_{1/2}O₂F, Li_{1.5}Na_{0.5}MnO_{2.85}I_{0.12}, among others) and many other types of Li-comprising disordered, layered, tavorite, olivine, or spinel type active materials or their mixtures comprising at least oxygen or fluorine or sulfur and at least one transition metal and/or other lithium transition metal (TM) oxides or phosphates or sulfates (or mixed) cathode active materials that rely on the intercalation of lithium (Li) and changes in the TM oxidation state (including, but not limited to those that may be doped or heavily doped; including, but not limited to those that have gradient in composition or core-shell morphology; including, but not limited to those that may be partially fluorinated or comprise some meaningful fraction of fluorine (e.g., about 0.001-10 at. %) in their composition, etc.). It will also be appreciated that various aspects may be applicable to high-voltage lithium transition metal oxide (or phosphate or sulfate or mixed or other) cathodes where TMs and oxygen (O) are covalently bonded and both TM and O take part in electrochemical reduction-oxidation (redox) reactions during charge and discharge (including, but not limited to, those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, V, Sn, Si, or Ge). Illustrative examples of suitable conversion-type cathodes to be used in preferable cells may include, but are not limited to: metal fluorides, metal oxy-fluorides, metal chlorides, metal sulfides, metal selenides, their various mixtures, composites and/or others. Illustrative examples of metal fluorides, in a Li-free state, include, but are not limited to FeF₃, FeF₂, MnF₃, CuF₂, NiF₂, BiF₃, BiF₅, SnF₂, SnF₄, SbF₃, SbF₅, CdF₂, ZnF₂, TiF₃, TiF₄, AgF, AgF₂, their various mixtures, alloys and combinations, among others. In some designs, it may be advantageous to produce nanocomposites and/or core-shell structures comprising metal fluorides to enhance their performance and stability. In some designs, it may be advantageous to dope metal fluorides with oxygen or utilize metal oxy-fluorides. In a fully lithiated state, pure metal fluorides convert to a composite comprising a mixture of metal and LiF clusters (or nanoparticles). Examples of the overall reversible reactions of the conversion-type metal fluoride cathodes may include 2Li+CuF₂↔LiF+Cu for CuF₂-based cathodes or 3Li+FeF_{3↔}3LiF+Fe for FeF₃-based cathodes. It will be appreciated that metal fluoride-based cathodes may be prepared in Li-free or partially lithiated or fully lithiated states. In addition to fluorides, other illustrative examples of conversion-type active electrode materials may include, but are not limited to, various metal oxy-fluorides, sulfo-fluorides, chloro-fluorides, oxy-chloro-fluorides, oxy-sulfo-fluorides, fluoro-phosphates, sulfo-phosphates, sulfo-fluoro-phosphates, mixtures of metals (e.g., Fe, Cu, Ni, Co, Bi, Cr, Zn, Ti, other metals, their various mixtures and alloys, partially oxidized metals and metal alloys, etc.) and salts (metal fluorides (including LiF or NaF), metal chlorides (including LiCl or NaF), metal oxy-fluorides, metal oxides, metal sulfo-fluorides, metal fluoro-phosphates, metal sulfides, metal oxy-sulfo-fluorides, their various combinations, etc.), and/or other salts that comprise halogen or sulfur or oxygen or phosphorous or a combination of these elements, among others. In some designs, F in metal fluorides may be fully or partially replaced with another halogen (e.g., Cl or Br or I, etc.) or their mixtures to form the corresponding metal chlorides or metal fluoride-chlorides and/or other metal halide compositions. Yet another example of a promising and suitable conversion-type cathode active material is sulfur (S) (in a Li-free state) or lithium sulfide (Li₂S, in a fully lithiated state). In some designs, selenium (Se) may also be used together with S or on its own for the formation of such cathode active materials. In some designs, it may be advantageous to produce nanocomposites and/or core-shell structures comprising S, Li₂S, Se, Li₂Se or their various mixtures and combinations to enhance their performance and stability. In some designs, conversion-type active cathode materials may also advantageously comprise metal oxides or mixed metal oxides. In some designs, such (nano)composites may advantageously comprise metal sulfides or mixed metal sulfides. In some examples, mixed metal oxides or mixed metal sulfides may comprise lithium. In some examples, mixed metal oxides may comprise titanium or vanadium or manganese or iron metal. In some examples, lithium-comprising metal oxides or metal sulfides may exhibit a layered structure. In some examples, metal oxides or mixed metal oxides or metal sulfides or mixed metal sulfides may advantageously be both ionically and electrically conductive (e.g., in the range from around 10⁻⁷ to around 10+4 S/cm). In some examples, various other intercalation-type active materials may be utilized instead of or in addition to metal oxides or metal sulfides. In some designs, such an intercalation-type active material exhibits charge storage (e.g., Li insertion/extraction capacity) in the potential range close to that of S or Li₂S (e.g., within around 1.5-3.8 V vs. Li/Li+). In some designs, the use of so-called Li-air cathodes (e.g., cathodes with active material in the form of Li₂O₂, Li₂O, LiOH in their lithiation state) or similar metal-air cathodes based on Na, K, Ca, Al, Fe, Mn, Zn and/or other metals (instead of Li) may similarly be beneficial due to their very high capacities. In some designs, such cathode active materials should ideally reversibly react with oxygen or oxygen containing species in the electrochemical cell and may fully disappear upon full de-lithiation (metal removal). Cathode active materials that exhibit such characteristics may also be considered to belong to conversion-type cathodes.

In some of the preferred examples a surface of cathode active materials (e.g., intercalation-type cathode materials, such as LCO, NCM, NCMA, NCA, LMO, LMNO, LFP, LMP, LMFP, etc. or conversion-type active materials comprising S, Li₂S, metal sulfides, metal fluorides, etc.) may be coated with a layer of ceramic material. Illustrative examples of a preferred coating material for such cathodes include, but are not limited to, titanium oxide (e.g., TiO₂), tantalum oxide (Ta₂O₅), aluminum oxide (e.g., Al₂O₃), tungsten oxide (e.g., WO), chromium oxide (e.g., Cr₂O₃), niobium oxide (e.g., NbO or NbO₂) and zirconium oxide (e.g., ZrO₂), lithium phosphate (e.g., Li₃PO₄), lithium oxy-thiophosphate (e.g., Li₃P₁₊ₓO₄S₄ₓ), and their various mixtures, alloys, and combinations. In some designs, such ceramic materials may additionally comprise lithium (Li)- e.g., as lithium phosphate, lithium oxy-thiophosphate, lithium titanium oxide, lithium tantalum oxide, lithium aluminum oxide, lithium tungsten oxide, lithium chromium oxide, lithium niobium oxide, lithium zirconium oxide and their various alloys, mixtures and combinations. In other preferred examples, LCO, NCM, NCMA, NCA, LFP, LMFP, LMP, LMO or LMNO may be doped with Al, Ti, Mg, Nb, Zr, Cr, Hf, Ta, W, Mo or La. In some designs, a preferred cathode current collector material is aluminum or aluminum alloy. In some designs, a preferred battery cell includes a polymer separator. In some of the preferred examples, a polymer separator is made of or comprises polyethylene, polypropylene or a mixture thereof. In some of the preferred examples, a surface of a polymer separator is coated with a layer of ceramic material. Examples of a preferred coating material for polymer separators may include, but not limited to, titanium oxide (TiO₂), aluminum oxide (Al₂O₃), aluminum hydroxide or oxyhydroxide, zirconium oxide (ZrO₂), magnesium oxide (MgO) or magnesium hydroxide or oxyhydroxide. In some designs, a preferred battery cell includes a ceramic-based or ceramic-comprising (e.g., ceramic/polymer composite) separator. The ceramic or ceramic component of such a ceramic or ceramic-comprising separator may comprise titanium oxide (TiO₂), aluminum oxide (Al₂O₃), aluminum hydroxide or oxyhydroxide, zirconium oxide (ZrO₂), magnesium oxide (MgO) or magnesium hydroxide or oxyhydroxide. The ceramic or ceramic component of such a ceramic or ceramic-comprising separator may comprise ceramic particles (e.g., elongated particles, nanofibers, flake-shaped particles, randomly shaped particles including nanoparticles, etc.) in some designs.

An aspect is directed to a Li-ion battery with a blended anode (e.g., comprising Si-comprising active material and graphite active material, etc.) that exhibits a relatively high areal capacity loading and properly matched (by areal capacity) cathode (e.g., with a slightly smaller areal capacity loading, selected according to the desired negative (N) to positive (P) ratio, N/P in the range of around 1:01 to around 1:35-in some designs, from around 1.01 to around 1.05; in other designs, from around 1.05 to around 1.10; in other designs, from around 1.10 to around 1.15; in other designs from around 1.15 to around 1.20; in other designs from around 1.20 to around 1.25; in yet other designs, from around 1.25 to around 1.35; wherein the N/P ratio corresponds to the ratio of the reversible areal capacities of the anode to cathode). Note that in some designs both the performance characteristics and cycle stability of Li-ion battery cells comprising some of such blended anodes (particularly for blended anodes with high fractions of Si or high fractions of Si-comprising active material particles—e.g., for the blended anodes with about 3-60 wt. % Si; in some designs, with about 10-20 wt. % Si or about 20-40 wt. % Si or about 40-60 wt. % Si, or for blended anodes with the Si-comprising active material particles (e.g., Si—C nanocomposite particles, among others) contributing to about 20-100% of the total blended anode capacity; in some designs, with about 50-70% or about 70-80% or about 80-90% or about 90-95% or about 95-99% of the total blended anode capacity) may become particularly unsatisfactory for applications requiring long calendar life or long cycle life or low first cycle losses or other properties, if the electrode areal capacity loading exceeds around 1-2 mAh/cm², even more if the electrode areal capacity exceeds around 4-5 mAh/cm², and further more if the electrode areal capacity exceeds around 6-8 mAh/cm². Higher loading, however, is advantageous for reducing cost of energy storage devices and increasing their energy density. One or more embodiments of the present disclosure are directed to synthesis processes, compositions and various physical and chemical properties of graphite(s) and or binder(s) in such blended anodes that provide satisfactory performance for electrode area loadings in the range from around 2 mAh/cm² to around 5 mAh/cm² and more so for loadings in the range from around 5 mAh/cm² to around 8 mAh/cm² and even more so for loadings in the range from around 8 mAh/cm² to around 16 mAh/cm² (e.g., in some designs, an areal capacity loading of an electrode composition may range from around 2 mAh/cm² to around 16 mAh/cm²).

An aspect is directed to a Li-ion battery with a blended anode (e.g., comprising Si-comprising active material particles and graphite active material particles, etc.) that exhibits high energy. In some designs, degradation of Li-ion cells with blended anodes not comprising suitable graphite(s) or binder(s) may become particularly undesirably fast for multi-layered (e.g., stacked or rolled) medium sized cells (e.g., cells with cell capacity in the range from 0.2 Ah to around 10 Ah), even more so for large cells (e.g., cells with cell capacity in the range from around 10 Ah to around 40 Ah), even more so for ultra-large cells (e.g., cells with cell capacity in the range from around 40 Ah to around 400 Ah) or gigantic cells (e.g., cells with cell capacity in the range from around 400 Ah to around 4,000 Ah or even more), particularly if the blended anodes comprise moderate-to-relatively high fraction of Si (e.g., about 3-60 wt. %; in some designs, about 10-20 wt. % or about 20-40 wt. % or about 40-60 wt. %) or if the Si-comprising active material particles (e.g., Si—C nanocomposite particles, among others) contribute to a moderate or a relatively high fraction of the total anode capacity (e.g., about 20-100%; in some designs, about 50-70% or about 70-80% or about 80-90% or about 90-95% or about 95-99%). However, multi-layered medium or large size cells may be attractive for some electronic devices and multi-layered large, ultra-large or gigantic cells may be particularly attractive for use in some electric transportation or grid storage applications. One or more aspects of the present disclosure facilitates the use of proper graphite(s) (or, more broadly carbon(s)) in the blended anodes with suitable microstructural, chemical, physical and/or other properties, and proper binder(s) to mitigate or overcome some or all of such limitations of blended anodes and substantially enhance performance of such Li-ion cells.

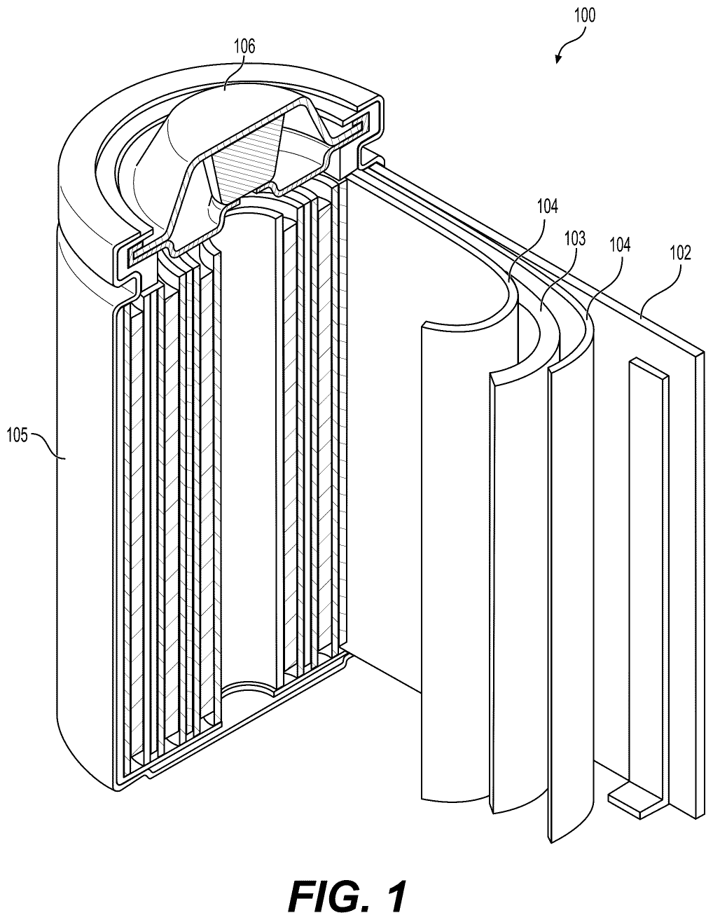

FIG. 1 illustrates an example metal-ion (e.g., Li-ion) battery in which the electrode particles, components, materials, processes, and/or other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on or in the anode current collector and the cathode is disposed on or in the cathode current collector.

An aspect is directed to a Li-ion battery with a blended anode (e.g., comprising Si-comprising active material particles and graphite active material particles, etc.) that exhibits high energy and superior performance characteristics. Intuitively, one of ordinary skill in the art may presume that graphite(s) or, broadly, carbon materials that exhibit superior stability or rate performance in Li-ion battery anodes based on purely intercalation-type graphite (more broadly, carbon) active materials should offer the best performance when used in blended anodes that comprise Si-based active materials (e.g., Si—C nanocomposites, among others). Unexpectedly, the inventors found this presumption not to be the case in many designs. In some designs, graphite(s) that may exhibit relatively poor performance on their own (e.g., relatively low stability or rate performance when calendered/densified to the same density as benchmark graphite anodes or low volumetric capacity for comparable stability characteristics, etc.), may significantly enhance performance of blended anodes, especially when their mass fraction or total capacity contribution is rather small (e.g., when such graphites (broadly-carbons), which may be referred to herein as “graphite for superior blended anodes (GRSBA)” in this disclosure, contribute to about 50% or less reversible capacity relative to the total blended anode reversible capacity; in some designs when such graphite(s) (carbons) offer about 40% or less capacity contribution relative to the total anode capacity; in some designs about 30% or less capacity contribution relative to the total anode capacity; in some designs about 20% or less capacity contribution relative to the total anode capacity; in some designs about 15% or less capacity contribution relative to the total anode capacity; in some designs about 10% or less capacity contribution relative to the total anode capacity; in some designs about 8% or less capacity contribution relative to the total anode capacity; in some designs about 6% or less capacity contribution relative to the total anode capacity; in some designs about 4% or less capacity contribution relative to the total anode capacity; in some designs about 2% or less capacity contribution relative to the total anode capacity; in some designs about 1% or less capacity contribution relative to the total anode capacity; for example, in some designs, when such GRSBAs contribute from about 0.2% to about 1% of the total blended anode capacity; in other designs, from about 1% to about 2% of the total capacity; in other designs, from about 2% to about 4% of the total capacity; in other designs, from about 4% to about 6% of the total capacity; in other designs, from about 6% to about 8% of the total capacity; in other designs, from about 8% to about 10% of the total capacity; in other designs, from about 10% to about 20% of the total capacity; in other designs, from about 20% to about 30% of the total capacity; in other designs, from about 30% to about 40% of the total capacity; in yet other designs, from about 40% to about 50% of the total capacity—e.g., when measured in half cells in the potential range of 0.01-1.00 V vs. Li/Li+). In some designs, it may be advantageous for the ratio of the capacities of GRSBAs to the capacities of all the Si-comprising active material particles (e.g., Si—C nanocomposite particles, among others) to range from about 1:200 to about 1:1 (in some designs, from about 1:200 to about 1:50; in other designs, from about 1:50 to about 1:20; in other designs, from about 1:20 to about 1:9; in other designs, from about 1:9 to about 2:8 or 1:4; in other designs, from about 1:4 to about 3:7; in other designs, from about 3:7 to about 4:6 or 2:3; in yet other designs, from about 2:3 to about 1:1). In some designs, blended anodes may comprise two or more types of Si-comprising active material particles (e.g., each type exhibiting distinctly different composition and/or distinctly different specific capacity and/or distinctly different size distribution and/or distinctly different specific surface area and/or distinctly different morphology, etc.). In some designs, blended anodes may comprise two or more types of graphite (or, broadly, carbon) particles. In some designs, only a portion of graphite (or, broadly, carbon) particles may be of GRSBA-type (the rest being high-performance graphite commonly used in many graphite anodes of conventional commercial Li-ion batteries). In some designs, the total weight of GRSBA in the blended anodes may range from about 1 wt. % to about 80 wt. % relative to the weight of all active material particles in the blended anodes (in some designs, from about 1 wt. % to about 10 wt. %; in other designs, from about 10 wt. % to about 20 wt. %; in other designs, from about 20 to about 50 wt. %; in yet other designs, from about 50 wt. % to about 80 wt. %). In some designs, the total weight of GRSBA in the blended anodes may advantageously range from about 1 wt. % to about 50 wt. % relative to the weight of all active material particle in the blended anodes. In some designs, the total weight of GRSBA in the blended anodes may advantageously range from about 2 wt. % to about 20 wt. % relative to the weight of all active material particles in the blended anodes.

In one or more embodiments of the present disclosure, several key physical, chemical, mechanical, structural, or other characteristics of GRSBA may be particularly advantageous when utilized in Li-ion batteries with the described blended anodes. Various types of graphite (or carbon) suitable for use as GRSBA(s) in blended anodes to achieve superior Li-ion battery performance characteristics as described herein. In some designs, the addition of suitable graphite(s) (GRSBA(s)) to Si-comprising anode composition may provide higher volumetric capacity, lower resistance and better rate performance even compared to “pure” Si-comprising anodes (e.g., non-blended anodes that include Si-comprising active material particles only, without any intercalation-type active material particles). As such, superior Li-ion battery cells, superior Li-ion batteries and superior Li-ion battery packs that include suitable GRSBA(s) in blended anodes are described herein.

In one or more embodiments of the present disclosure, graphite that exhibits a relatively low hardness may be one of the key characteristics to provide superior performance as GRSBA(s) in the described blended anodes (with Si-comprising active material particles). In order to test graphite (carbon) powder sample hardness, graphite (carbon) particles arranged as a dry powder were placed onto a hardened steel disk and distributed as evenly as possible in small quantities with the particles spread out as much as possible so that individual particles are discernible directly on the hardened steel surface. The hardened steel disk with the spread-out graphite particles was then added to a Shimadzu MCT Micro Compression Testing tool. The hardened steel disk was placed on a platform that could move between an optical microscope and a compressor tip. The optical microscope from the tool was used to find individual particles from the graphite samples. Once an individual graphite particle was found, the platform was switched to the compressor tip and the hardness test was conducted with indenting (crushing) of the individual graphite particle while measuring both the force and displacement to calculate the pressure (Cx, expressed in MPa) required to deform the graphite particle by 10% (linear dimensions). At least ten graphite particles were measured for each sample and the average Cx was calculated.

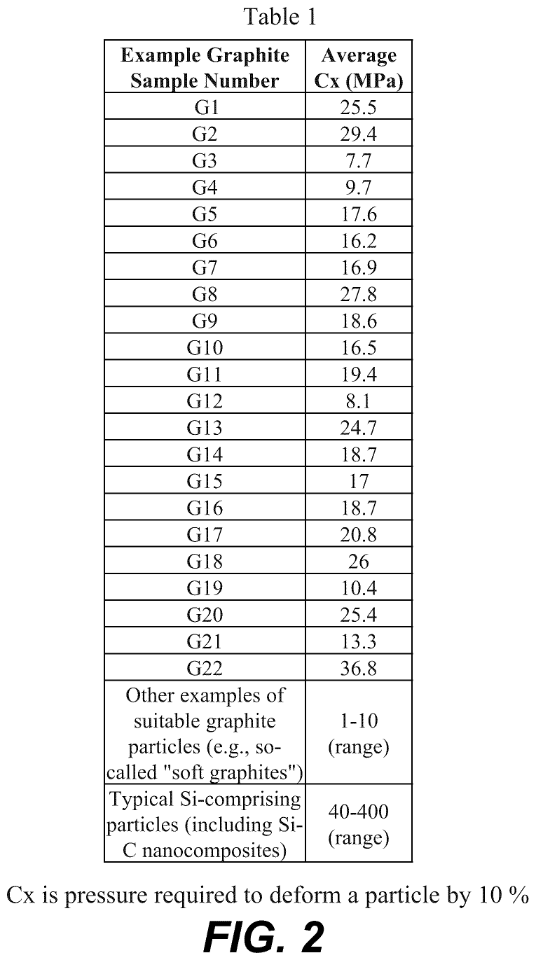

Table 1 in FIG. 2 illustrates example Cx measurements on each of the selected graphite (carbon) samples, numbered G1 through G22, as well as other examples of suitable graphite particles including graphite materials that are referred to as “soft graphites”. Herein, graphite particles exhibiting average Cx values in a range of 1 to 10 MPa are sometimes referred to as “soft graphites”. It was found that Cx values in the range from about 1 MPa to about 30 MPa made graphite samples most suitable for use as GRSBA(s) in some or all of the described blended anodes. In some designs, it may be preferable for the GRSBA (or at least majority, 50 wt. % or more of the GRSBA) to exhibit average Cx values of less than around 30 MPa; in other designs, it may be more preferable for the GRSBA (or at least majority, 50 wt. % or more of the GRSBA) to exhibit average Cx values of less than around 25 MPa; in other designs, it may be more preferable for the GRSBA (or at least majority, 50 wt. % or more of the GRSBA) to exhibit average Cx values of less than around 20 MPa; in other designs, it may be more preferable for the GRSBA (or at least majority, 50 wt. % or more of the GRSBA) to exhibit average Cx values of less than around 15 MPa; in other designs, it may be more preferable for the GRSBA (or at least majority, 50 wt. % or more of the GRSBA) to exhibit average Cx values of less than around 11 MPa; in other designs, it may be more preferable for the GRSBA (or at least majority, 50 wt. % or more of the GRSBA) to exhibit average Cx values of less than around 10 MPa; in other designs, it may be more preferable for the GRSBA (or at least majority, 50 wt. % or more of the GRSBA) to exhibit average Cx values of less than around 9 MPa; in other designs, it may be more preferable for the GRSBA (or at least majority, 50 wt. % or more of the GRSBA) to exhibit average Cx values of less than around 8 MPa; in other designs, it may be more preferable for the GRSBA (or at least majority, 50 wt. % or more of the GRSBA) to exhibit average Cx values of less than around 7 MPa; in other designs, it may be more preferable for the GRSBA (or at least majority, 50 wt. % or more of the GRSBA) to exhibit average Cx values of less than around 6 MPa. In some designs, it may be preferable for the majority of the GRSBA (e.g., about 50-60 wt. % or about 60-70 wt. % or about 70-80 wt. % or about 80-100 wt. %) in the blended anodes to exhibit average Cx values in the range from about 1 MPa to about 18 MPa (e.g., from about 1 MPa to about 7 MPa or from about 7 MPa to about 10 MPa or from about 10 MPa to about 14 MPa or from about 14 MPa to about 18 MPa). In some designs, it may be preferable for the majority of the GRSBA (e.g., about 50-60 wt. % or about 60-70 wt. % or about 70-80 wt. % or about 80-100 wt. %) in the blended anodes to exhibit average Cx values in the range from about 18 MPa to about 30 MPa (e.g., from about 18 MPa to about 20 MPa or from about 20 MPa to about 24 MPa or from about 24 MPa to about 30 MPa or from about 20 MPa to about 30 MPa). Note that in some designs soft graphite that are too soft (e.g., with average Cx values of less than 1 MPa) may lead to anode degradation or inferior rate performance, while too hard graphites (e.g., with average Cx value of more than about 30 MPa; in some designs, of more than about 25 MPa) may not allow sufficient or desirable volumetric capacity or energy density or discharge rate or even cycle stability to be attained, particularly for Si-rich blended anodes. Interestingly, typical measured Cx value of suitable Si-comprising active material particles (e.g., Si—C particles; C-coated SiOₓ particles, etc.) commonly exceeds 40 MPa (e.g., in some designs, Cx may be from about 40 MPa to about 60 MPa; in other designs, from about 60 MPa to about 80 MPa; in other designs, from about 80 MPa to about 120 MPa; in other designs, from about 120 MPa to about 160 MPa; in other designs, from about 160 MPa to about 400 MPa), which makes them rather hard. Furthermore, some of Si-comprising active material particles may be so brittle that they fracture before 10% deformation could be attained and their fracture strength may be below 400 MPa. As such, the reported finding may indicate that combining such rather hard Si-comprising active material particles (e.g., in some designs with Cx values in excess of 40 MPa) with suitable (or desirable) amount of relatively soft GRSBA particles for use in superior blended anodes may be particularly advantageous.

In one or more embodiments of the present disclosure, the tap density of graphite particles may be another one of the key characteristics to provide superior performance as GRSBA(s) in the described blended anodes (with Si-comprising active material particles). For the tap density measurements disclosed herein, graphite (carbon) particles arranged as a dry powder were added into a graduated cylinder, which was then loaded into the TD1 Tap Density Tester tool and initially tapped 10 times. The initial volume [mL] was then determined and documented. Depending on the sample size, the cylinder was further “tapped” a different number of times. For example, the filled 25 mL cylinder, which was commonly suitable for approximately 10 g samples, was tapped 6,000 times. A 100 mL (which was commonly suitable for approximately 50 g samples) filled cylinder was tapped 12,000 times. After the “tapping” was finished, the final volume was measured and the mass added and volume observed was used in tap density calculation (mass/volume), as known in the art.

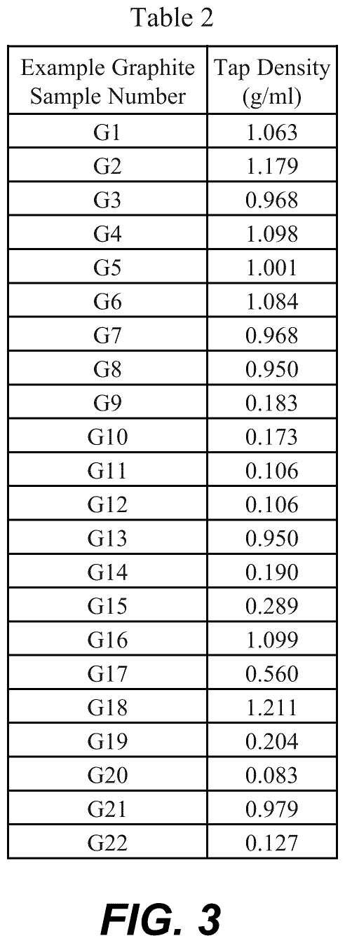

Table 2 of FIG. 3 illustrates example tap density measurements on each of the selected graphite (carbon) samples (example graphite samples G1 through G22, introduced in Table 1). In some designs, suitable tap density values of GRSBA(s) may typically range from about 0.100 g/ml (or g/cc) to about 1.250 g/ml (or g/cc) (e.g., in some designs, from about 0.100 g/ml to about 0.250 g/ml; in other designs, from about 0.250 g/ml to about 0.600 g/ml; in other designs, from about 0.600 g/ml to about 0.900 g/ml; in other designs, from about 0.900 g/ml to about 1.100 g/ml; in yet other designs, from about 1.100 g/ml to about 1.250 g/ml; in yet other designs, from about 0.900 g/ml to about 1.250 g/ml; in yet other designs, from about 0.900 g/ml to about 1.200 g/ml). However, in some designs, too high a density (e.g., in some designs, in excess of about 1.250 g/ml; in other designs, in excess of about 1.100 g/ml; in yet other designs, in excess of about 1.200 g/ml) may undesirably reduce performance of Li-ion battery cells with blended anodes. In some designs, too low a density (e.g., in some designs, below about 0.050 g/ml; in other designs, below about 0.100 g/ml), as, for example, in some expanded graphites may also induce undesirable effects, including, in some cases, lower volumetric capacity performance. In some designs, graphite (carbon) samples with tap density values from about 0.900 g/ml to about 1.100 g/ml (e.g., in some designs, from about 0.900 g/ml to about 0.950 g/ml; in other designs, from about 0.950 g/ml to about 1.000 g/ml; in other designs, from about 0.950 g/ml to about 1.050 g/ml; in yet other designs, from about 1.050 g/ml to about 1.100 g/ml) were often found to work particularly well as GRSBA(s) in blended anodes. In some designs, graphite (carbon) samples with tap density values from about 0.900 g/ml to about 1.200 g/ml (e.g., in some designs, from about 0.900 g/ml to about 0.950 g/ml; in other designs, from about 0.950 g/ml to about 1.000 g/ml; in other designs, from about 0.950 g/ml to about 1.050 g/ml; in yet other designs, from about 1.050 g/ml to about 1.100 g/ml; in yet other designs, from about 1.100 g/ml to about 1.200 g/ml) were often found to work particularly well as GRSBA(s) in blended anodes.

In one or more embodiments of the present disclosure, pycnometry density (as measured by using a nitrogen gas (N₂) pycnometer) of graphite particles may be another one of the key characteristics to provide superior performance as GRSBA(s) in the described blended anodes (with suitable Si-comprising active material particles).

For the pycnometry density measurements described herein, a Micromeritics AccuPyc II 1340 Pycnometer with a 1 cc chamber was used. To prepare the sample, a vial of sample powder was vortexed for 15 seconds and was allowed to sit for a few minutes before use. Using an electronic balance, 195 mg-200 mg of sample powder was weighed out in a designated cup from the instrument for pycnometry density measurements.

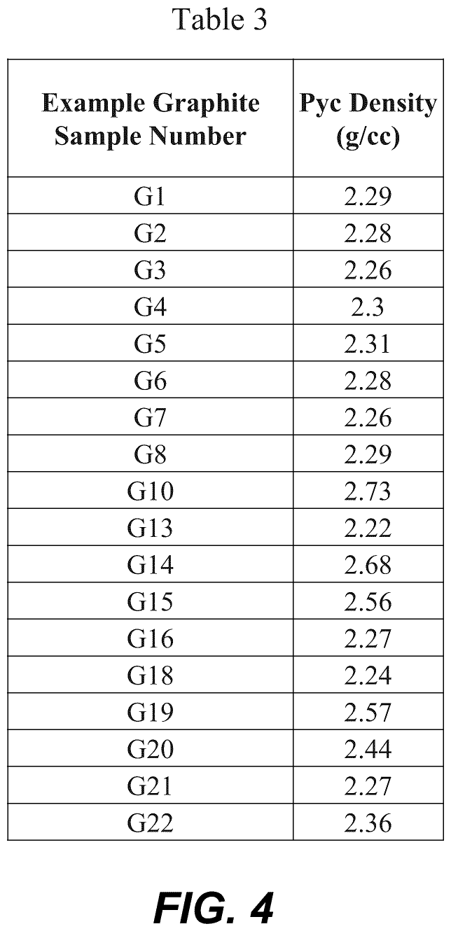

Table 3 of FIG. 4 illustrates example pycnometry density measurements on each of the selected graphite (carbon) samples (example graphite samples G1 through G8, G10, G13 through G16, G18 through G22). In some designs, suitable pycnometry-measured density values of GRSBA(s) may typically range from about 2.150 g/ml (or g/cc) to about 2.350 g/ml (g/cc) (e.g., in some designs, from about 2.150 g/ml to about 2.200 g/ml; in other designs, from about 2.200 g/ml to about 2.250 g/ml; in other designs, from about 2.250 g/ml to about 2.275 g/ml; in other designs, from about 2.275 g/ml to about 2.300 g/ml; in other designs, from about 2.300 g/ml to about 2.325 g/ml; in other designs, from about 2.325 g/ml to about 2.350 g/ml). Note that in some designs the theoretical density of crystallographically perfect graphite at room temperature and atmospheric pressure is around 2.265 g/ml (g/cc). Too low a pycnometry-measured density (e.g., below about 2.150 g/ml or g/cc) may lead to excessive losses during the first or subsequent cycles or other undesirable cell performance characteristics, in some designs. Too high a pycnometry-measured density may also reduce cell performance characteristics or induce challenges during the slurry and electrode preparations, in some designs, and may indicate the presence of small micropores.

In one or more embodiments of the present disclosure, the shape of the graphite samples may also affect their performance for use as GRSBA(s) in the described blended anodes (with suitable Si-comprising active material particles). In some designs, more spheroidal (e.g., spherical or nearly spherical or round shapes that predominantly have rounded edges) GRSBA samples may work better when used in larger fractions relative to Si-comprising active material particles. In some designs, flatter GRSBA samples may work better when used in smaller fractions relative to Si-comprising active material particles. In some designs, it may be advantageous to combine more spheroidal GRSBA samples with flatter (closer to being two dimensional, 2D-shaped) GRSBA samples.

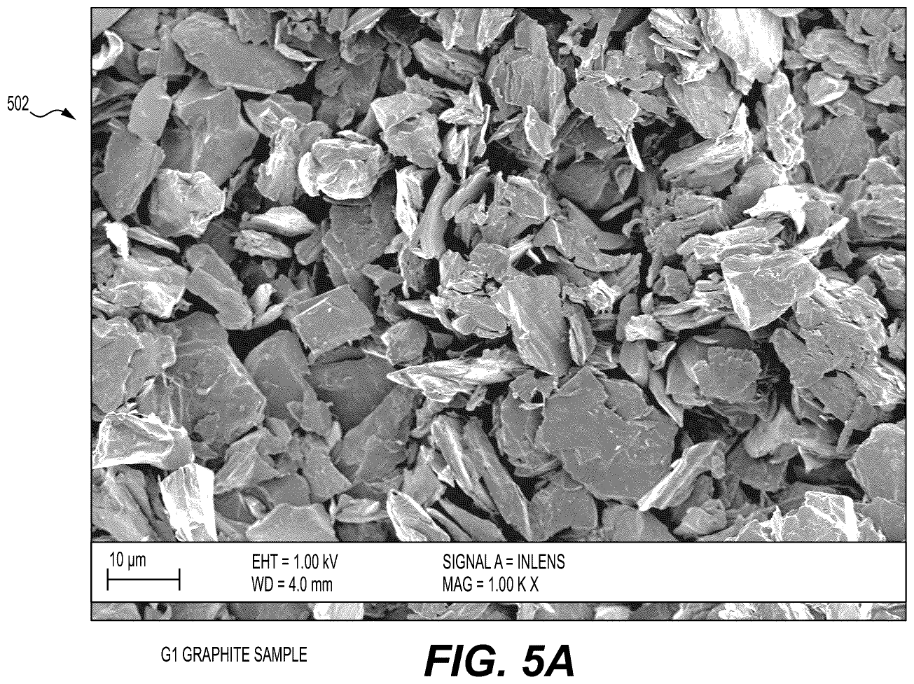

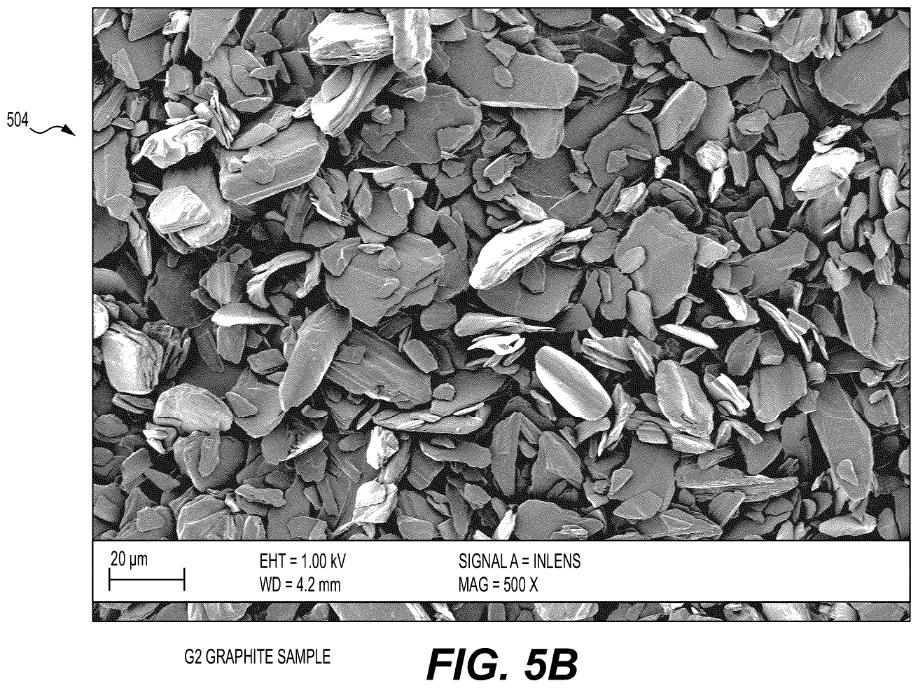

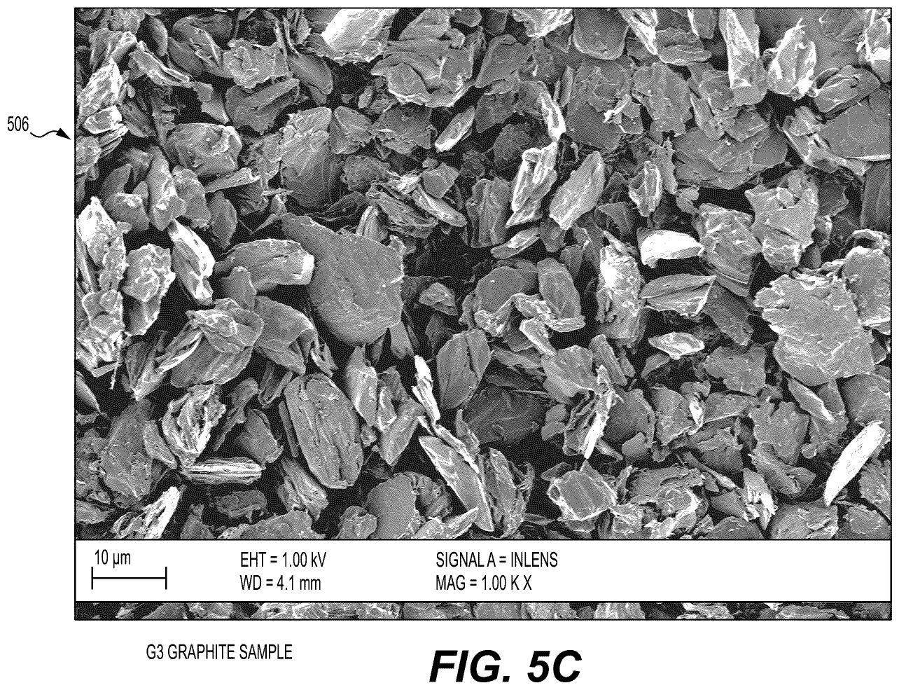

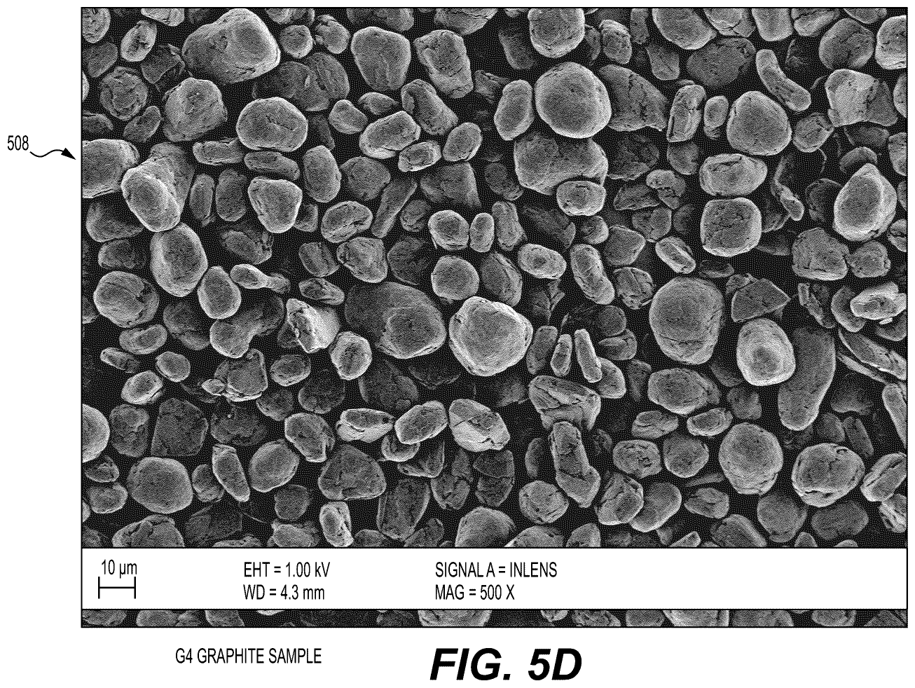

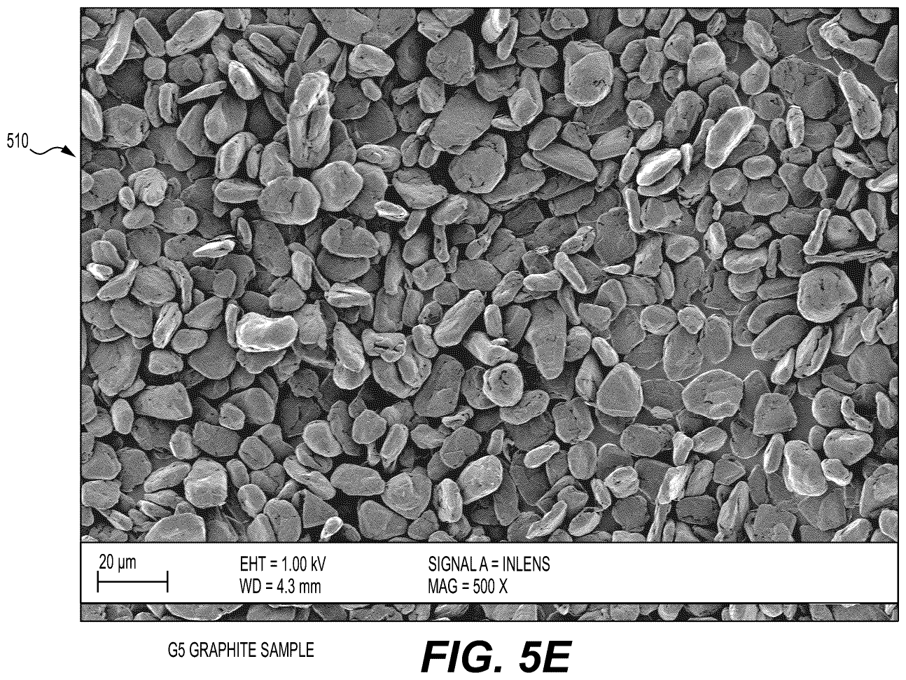

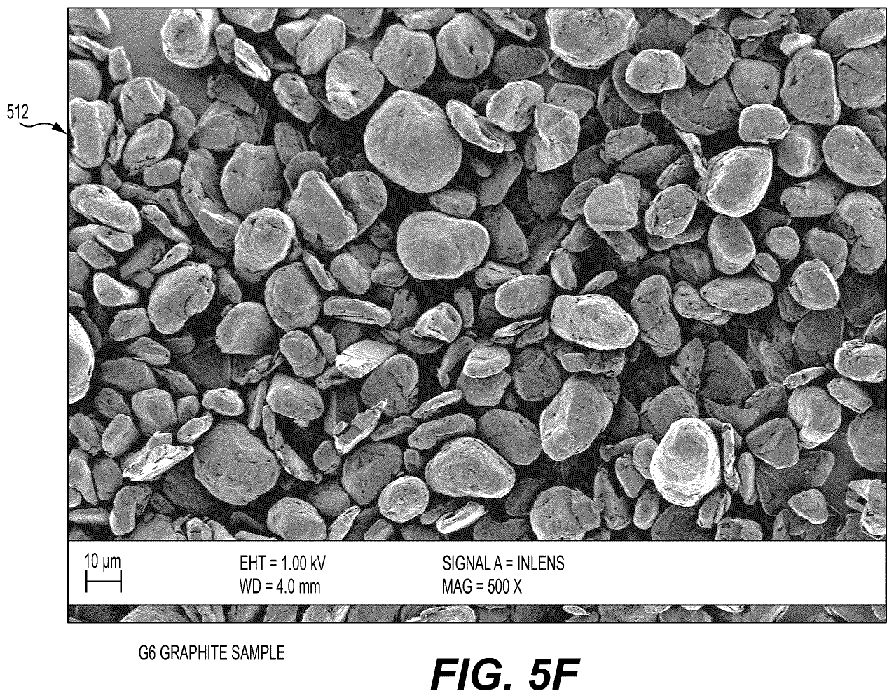

FIGS. 5A, 5B, 5C, 5D, 5E, and 5F illustrate SEM micrographs of respective selected graphite (carbon) samples. FIG. 5A shows an SEM micrograph 502 of a portion of the G1 example graphite sample. FIG. 5B shows an SEM micrograph 504 of a portion of the G2 example graphite sample. FIG. 5C shows an SEM micrograph 506 of a portion of the G3 example graphite sample. FIG. 5D shows an SEM micrograph 508 of a portion of the G4 example graphite sample. FIG. 5E shows an SEM micrograph 510 of a portion of the G5 example graphite sample. FIG. 5F shows an SEM micrograph 512 of a portion of the G6 example graphite sample. Some of the graphite samples have particles with jagged edges (e.g., G1 of 502, G2 of 504, G3 of 506) and some of the graphite samples have particles with rounded edges (e.g., G4 of 508, G5 of 510, G6 of 512). Some of the graphite samples predominantly include flatter particles (e.g., G1 of 502, G2 of 504, G3 of 506) and some of the graphite samples appear to be a mixture of flatter and rounder (more spheroidal) particles (e.g., G4 of 508, G5 of 510, G6 of 512).

For the particle size analysis disclosed herein, samples were prepared within 1 hour of analysis on the Malvern Mastersizer 3000 laser PSA (particle size distribution analysis) instrument. The original sample vial was vortexed for 15 seconds to ensure powder homogeneity. Approximately 20.0 mg (+/−5.0 mg) of thoroughly mixed sample was weighed and transferred into a 20 mL glass vial. Once the sample was transferred to the vial, 15-20 mL of a 20 g/L lecithin in Isopar G solution (the dispersant) was added to the glass vial. To break down agglomerated particles that may be present in some samples, the samples were also sonicated for 30 minutes. The sample vial containing powder, lecithin, and isopar G was then vortexed using the maximum setting on the vortexer for 15 seconds. Once the samples were prepared, the samples were analyzed using the Malvern Mastersizer 3000 laser PSA instrument.

In one or more embodiments of the present disclosure, the size distribution of the graphite particles may also affect their performance for use as GRSBA(s) in the described blended anodes (with suitable Si-comprising active material particles). In some designs, both too large particles and too small particles may reduce performance of Li-ion battery cells with blended anodes. Too large particles, for example, may induce local non-uniformities in both the distribution of mechanical properties of the anodes and their areal capacities. Too small particles, for example, may increase anode tortuosity (e.g., for the same anode density) thus affecting Li-ion battery charging rate performance and power capabilities (e.g., for the fixed areal capacity loadings), require the use of large binder fraction or reduce anode packing and volumetric capacity, in some designs. The total mass fraction (or total capacity fraction of GRSBAs), areal capacity loadings, the size of Si-comprising active material particles, the desired cell characteristics, and/or other factors, however, may affect the most desirable size distribution of the GRSBAs. In some (e.g., most) designs, however, the suitable D₅₀ values of the GRSBAs may range from about 2 m to about 22 m (in some designs, from about 2 m to about 5 m; in other designs, from about 5 m to about 10 m; in other designs, from about 10 m to about 12 m; in other designs, from about 12 m to about 17 am; in other designs, from about 11 m to about 17 am; in yet other designs, from about 17 m to about 22 m). In some (e.g., most) designs, the suitable D₉₀ values of the GRSBAs may range from about 4 m to about 30 μm (in some designs, from about 4 m to about 10 m; in other designs, from about 10 m to about 15 μm; in other designs, from about 15 μm to about 19 μm; in other designs, from about 19 μm to about 26 m; in other designs, from about 19 μm to about 30 m; in yet other designs, from about 26 μm to about 30 m). In some (e.g., most) designs, the suitable D₁₀ values of the GRSBAs may range from about 0.5 m to about 15 μm (in some designs, from about 0.5 μm to about 2.5 μm; in other designs, from about 2.5 μm to about 5 μm; in other designs, from about 5 m to about 7 μm; in other designs, from about 7 μm to about 11 μm; in other designs, from about 5 am to about 11 m; in other designs, from about 11 μm to about 15 μm).

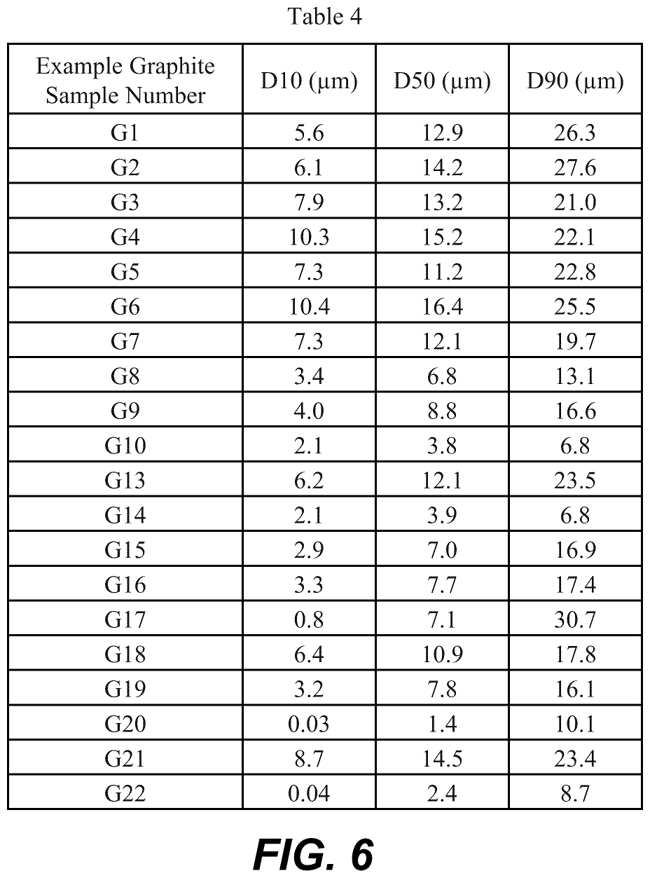

Table 4 of FIG. 6 illustrates D₁₀, D₅₀ and D₉₀ values of the selected graphite (carbon) samples (example graphite samples G1 through G10, G13 through G22). In the examples shown, the particle size distributions (PSDs) were measured using laser particle size distribution analysis (LPSA) as described herein.

In one or more embodiments of the present disclosure, the BET-SSA of the graphite particles may also affect their performance for use as GRSBA(s) in the described blended anodes (with suitable Si-comprising active material particles). In some designs, both too high BET-SSA and too low BET-SSA may reduce performance of Li-ion battery cells with blended anodes. The most optimal BET-SSA value, however, may depend on various factors, including the desired cell characteristics for particular applications. In some (e.g., most) designs, however, the suitable BET-SSA values of the GRSBAs may range from about 0.450 m²/g to about 450 m²/g (in some designs, from about 0.450 m²/g to about 1 m²/g; in other designs, from about 1 m²/g to about 2 m²/g; in other designs, from about 2 m²/g to about 3 m²/g; in other designs, from about 1 m²/g to about 3 m²/g; in other designs, from about 3 m²/g to about 5 m²/g; in other designs, from about 5 m²/g to about 10 m²/g; in other designs, from about 10 m²/g to about 20 m²/g; in other designs, from about 20 m²/g to about 100 m²/g; in yet other designs, from about 100 m²/g to about 450 m²/g). In some designs, however, (e.g., when long calendar or long cycle life is important or when lower fraction of polymer binder may be advantageous, etc.) lower BET-SSA value and more narrow range of BET-SSA values may be advantageous (e.g., from about 0.450 m²/g to about 5-15 m²/g; in some designs, from about 1 m²/g to about 5 m²/g; in yet some other designs, from about 2 m²/g to about 3 m²/g; in yet some other designs, from about 1 m²/g to about 3 m²/g).

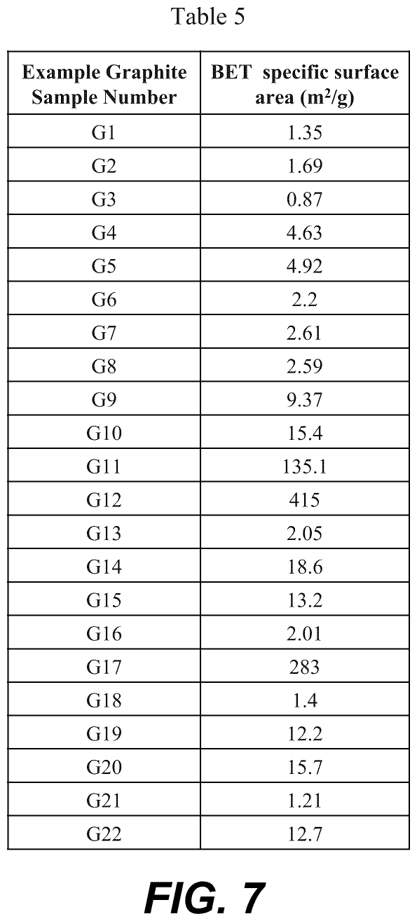

Table 5 of FIG. 7 illustrates BET-SSA values of each of the selected graphite (carbon) samples (example graphite samples G1 through G22). In the examples shown, the BET-SSA of each example population of graphite particles (G1 through G22) was measured by nitrogen gas physisorption (around 77 K) of powder samples that had been degassed at 300° C. for 10 hours under vacuum.

The microstructural features of the graphite (carbon) samples may also affect their performance for use as GRSBA(s) in the described blended anodes (with suitable Si-comprising active material particles). Some of such features may be revealed by X-ray diffraction (XRD) techniques, by Raman spectroscopy and/or other characterization techniques.

For the microstructural feature analysis disclosed herein, graphite (carbon) particles arranged as a powder were prepared for powder XRD using standard material preparation practices. Aluminum sample holders were used with 1 mm glass slides placed in the bottom of the sample well to prevent measurement contribution from the metallic sample holder. Approximately 100-300 mg of each powder was added to the sample holder and smoothed using a glass slide such that a uniform sample surface resulted. A Rigaku Smartlab was used for all measurements utilizing a copper X-Ray source, (λ=1.5406 Å). The Cu anode was operated at a tube voltage and current of 40 kV and 44 mA, respectively. All measurements were performed using Bragg-Brentano measurement geometries between 10 and 90 degrees 2θ, at a continuous scan rate of 1 degree per minute. An incident limiting slit of 10 degrees was used in addition to 5.0 degree Soller slits for both incident and detector. Copper K-beta (K_{β}) radiation was directly filtered through the use of a Ni filter prior to reaching a 1D silicon strip detector. Full width at half maximum (FWHM) values for the graphite (002) reflection peaks were calculated by fitting the respective peak with a Gaussian-Lorentzian cross product function defined as follows:

$$y = {y}_{0} + \frac{A}{1 + \frac{{e}^{\frac{0.5 ( 1 - s ) {( x - {x}_{c} )}^{2}}{{w}^{2}}} {s ( x - {x}_{c} )}^{2}}{{w}^{2}}} \qquad ( Formula 1 )$$

where y₀ is defined as the functions base, x_{c} is the peak center, A is the peak amplitude, w is the peak width, and s is a parameter defining the peak shape. Scherrer crystallite size was calculated directly from the fit data for each graphite (carbon) sample based on the known Scherrer formula:

$$D = \frac{K λ}{β cos θ} \qquad ( Formula 2 )$$

where D is the calculated crystallite size, K is a shape factor set to 0.7, λ is the X-Ray wavelength (1.5406 Å), β is the FWHM of the peak at the Bragg angle, and θ is the Bragg angle which was calculated from the 2θ position of the (002) reflection peak.

Both too narrow and too wide FWHM of the (002) graphite reflection peak and, correspondingly, both too large and too small average crystallite sizes estimated using Scherrer formula for (002) reflection peaks may reduce performance of Li-ion battery cells with blended anodes, in some designs. In some designs, however, the optimal values for particular applications may depend on the fraction of the GRSBA(s) in the described blended anodes, properties of the Si-comprising anode particles, areal capacity loadings, binder amount and type, the desired cell performance characteristics, and/or other factors. However, in some (e.g., most) designs, the suitable FWHM for (002) graphite reflection peak (as measured using the employed analytical procedure and setup) may preferably range from about 0.220 degrees to about 5.620 degrees (in some designs, from about 0.220 degrees to about 0.250 degrees; in other designs, from about 0.250 degrees to about 0.300 degrees; in other designs, from about 0.300 degrees to about 0.340 degrees; in other designs, from about 0.340 degrees to about 0.500 degrees; in other designs, from about 0.500 degrees to about 0.600 degrees; in other designs, from about 0.600 degrees to about 1.220 degrees; in other designs, from about 1.220 degrees to about 5.620 degrees). Also, in some (e.g., most) designs, the suitable for the GRSBA(s) average crystallite sizes estimated using Scherrer formula for (002) reflection peaks (as measured using the employed analytical procedure and setup) may preferably range from about 1 nm to about 40 nm (in some designs, from about 1 nm to about 5 nm; in other designs, from about 5 nm to about 10 nm; in other designs, from about 10 nm to about 15 nm; in other designs, from about 15 nm to about 21 nm; in other designs, from about 15 nm to about 30 nm; in other designs, from about 21 nm to about 26 nm; in other designs, from about 26 nm to about 29 nm; in other designs, from about 29 nm to about 40 nm).

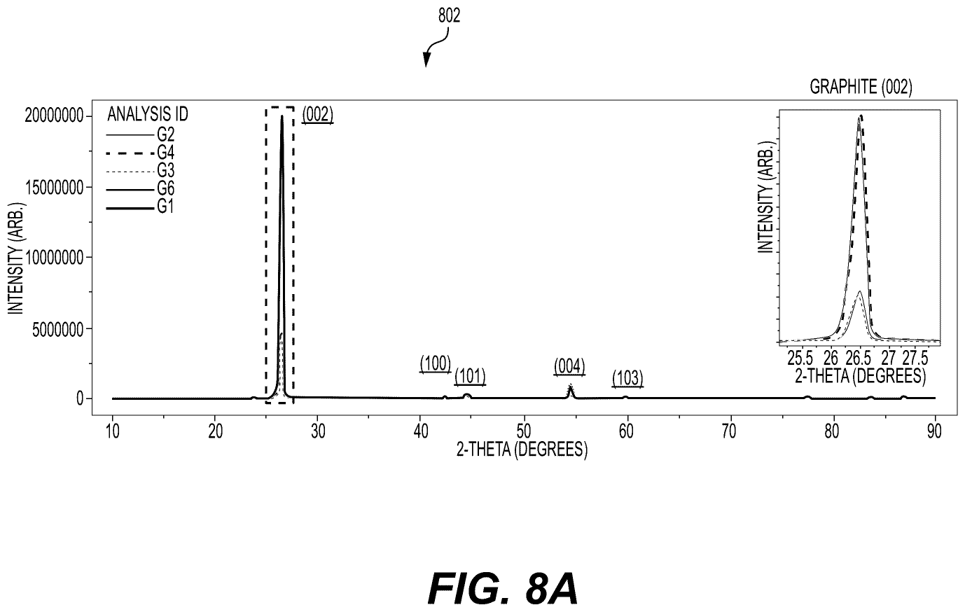

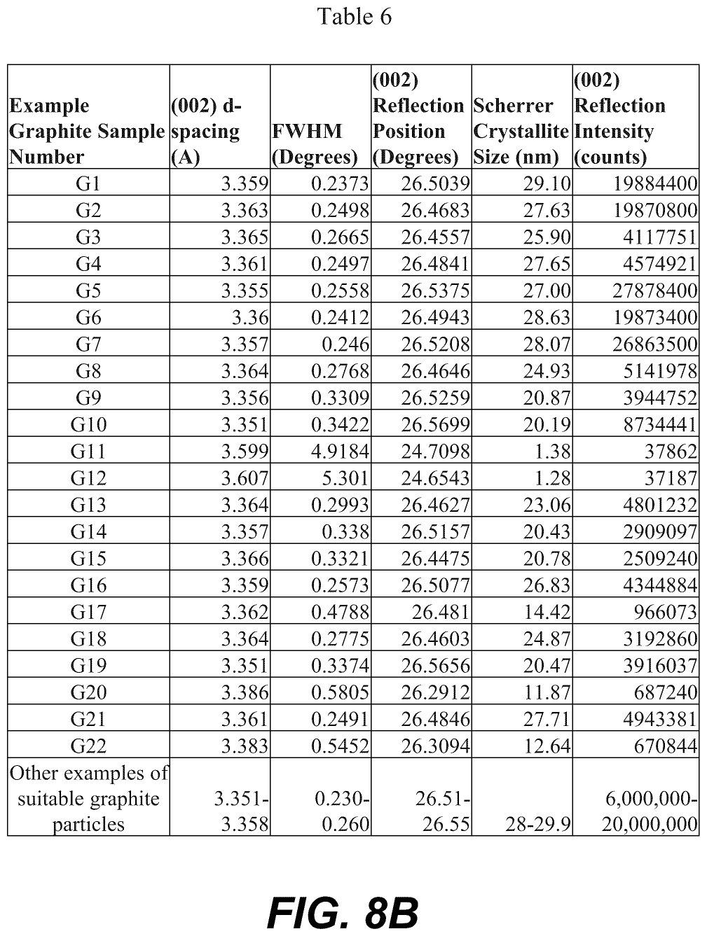

FIG. 8A shows a graphical plot 802 of the XRD spectra of each of the selected graphite (carbon) samples (example graphite samples G1, G2, G3, G4, and G6).

FIG. 8B shows Table 6 which lists selected results obtained from the x-ray diffraction measurements of selected graphite (carbon) samples (example graphite samples G1 through G22, and some other examples of suitable graphite). The x-ray analysis results shown are, from left to right, (1) the interplanar spacing (also referred to as d-spacing) of each graphite sample as determined from the (002) reflection angle (expressed in A); (2) the FWHM of the (002) reflection peak of each graphite sample, expressed in degrees; (3) the angle of the (002) reflection peak of each graphite sample, expressed in degrees; (4) the average crystallite size of each graphite sample estimated using Scherrer formula for (002) reflection peaks, expressed in nm; and (5) the intensity the (002) reflection peak expressed in counts.

For the Raman analysis described herein, graphite (carbon) particles arranged as a dry powder were prepared for Raman scattering experiments using standard material preparation practices. The graphite (carbon) powder sample was collected and placed in a glass microscope slide with a spatula. The powder was then pressed into the tape on the glass slide firmly to transfer a sufficiently thick layer of the powder from spatula to the top of the tape. This process was repeated until the powder fully coated the tape. Once the tape was fully coated by the powder, a hand-held air pump was used to blow residual powder from the tape. Once the residual powder was blown from the tape, the sample was ready for Raman analysis. A Renishaw In-Via Qontor Raman Microscope was used to analyze the samples using a 532 nm laser diode with a maximum laser power of 3 mW. A laser beam was focused on the sample using a 100×1.2 numerical aperture (NA) objective. The laser beam was purposefully aimed at the center of large particles, unless noted otherwise. Renishaw 1800 diffraction grating was used to record the spectrum with 3 sec acquisition time, 10 spectra were averaged (per sample) to increase signal to noise ratio. The following graphite (carbon) peaks were selected in the spectra: D peak (1200-1500 cm⁻¹), G peak (1500-1750 cm⁻¹), 2D₁ peak (2600-2800 cm⁻¹), and 2D₂ peak (2400-3700 cm⁻¹). For calculating the D/G ratio, the height of the D peak in D peak range (1200-1500 cm⁻¹) was divided by height of the G peak in G peak range (1500-1750 cm⁻¹) after linear background subtraction in the spectra in the 1000-2000 cm⁻¹ range. For calculating the 2D₁/G ratio, the height of the 2D₁ peak in the 2D₁ peak range (2600-2800 cm⁻¹) was divided by the height of the G peak in G peak range (1500-1750 cm⁻¹). Peak heights were calculated after linear background subtraction for each peak in the 1000-2000 cm⁻¹ range for G peak and in the 2000-4000 cm−1 range for 2D₁ peak. FWHM values were calculated using Scipy (scientific Python) peak quantification function scipy.signal.peak_widths with peak width measured at 0.5 of the relative height.

The values of the FWHM of D, G and 2D₁ bands and the values of the D/G and 2D₁/G ratios of graphite (carbon) samples may correlate with the performance of Li-ion battery cells with blended anodes, in some designs. In some designs, however, the optimal values for particular applications may depend on the fraction of the GRSBA(s) in the described blended anodes, properties of the Si-comprising anode particles, areal capacity loadings, binder amount and type, the desired cell performance characteristics, and/or other factors. However, in some (e.g., most) designs, the suitable FWHM of D bands for GRSBA(s) (as determined using the described methodology) may typically range from about 30 cm⁻¹ to about 90 cm⁻¹ (in some designs, from about 30 cm⁻¹ to about 40 cm⁻¹; in other designs, from about 40 cm⁻¹ to about 60 cm⁻¹; in other designs, from about 60 cm⁻¹ to about 70 cm⁻¹; in yet other designs, from about 70 cm⁻¹ to about 90 cm⁻¹). In some (e.g., most) designs, the suitable FWHM of G bands for GRSBA(s) (as determined using the described methodology) may typically range from about 5 cm⁻¹ to about 105 cm⁻¹ (in some designs, from about 5 cm⁻¹ to about 15 cm⁻¹; in other designs, from about 15 cm⁻¹ to about 30 cm⁻¹; in other designs, from about 15 cm⁻¹ to about 18 cm⁻¹; in other designs, from about 18 cm⁻¹ to about 22 cm⁻¹; in other designs, from about 22 cm⁻¹ to about 30 cm⁻¹; in other designs, from about 30 cm⁻¹ to about 50 cm⁻¹; in yet other designs, from about 50 cm⁻¹ to about 105 cm⁻¹). In some (e.g., most) designs, the suitable FWHM of 2D₁ bands for GRSBA(s) (as determined using the described methodology) may typically range from about 30 cm⁻¹ to about 110 cm⁻¹ (in some designs, from about 30 cm⁻¹ to about 50 cm⁻¹; in other designs, from about 50 cm⁻¹ to about 65 cm⁻¹; in other designs, from about 65 cm⁻¹ to about 80 cm⁻¹; in yet other designs, from about 80 cm⁻¹ to about 105 cm⁻¹; in yet other designs, from about 105 cm⁻¹ to about 110 cm⁻¹). In some (e.g., most) designs, the suitable D/G peak intensity ratios for GRSBA(s) (as determined using the described methodology) may typically range from about 0.02 to about 1.12 (in some designs, from about 0.02 to about 0.12; in other designs, from about 0.12 to about 0.30; in other designs, from about 0.08 to about 0.30; in other designs, from about 0.30 to about 0.50; in other designs, from about 0.50 to about 0.80; in yet other designs, from about 0.80 to about 1.12). In some (e.g., most) designs, the suitable 2D₁/G ratio for GRSBA(s) (as determined using the described methodology) may typically range from about 0.10 to about 0.90 (in some designs, from about 0.10 to about 0.35; in other designs, from about 0.35 to about 0.50; in other designs, from about 0.41 to about 0.55; in other designs, from about 0.41 to about 0.45; in other designs, from about 0.45 to about 0.50; in other designs, from about 0.50 to about 0.55; in other designs, from about 0.50 to about 0.60; in other designs, from about 0.30 to about 0.65; in other designs, from about 0.60 to about 0.75; in yet other designs, from about 0.75 to about 0.90).

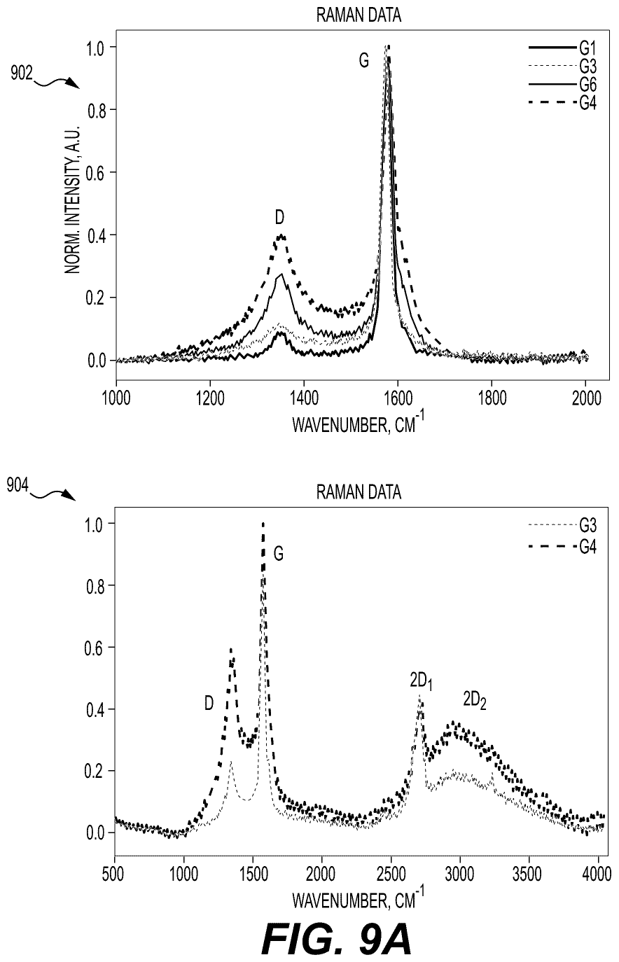

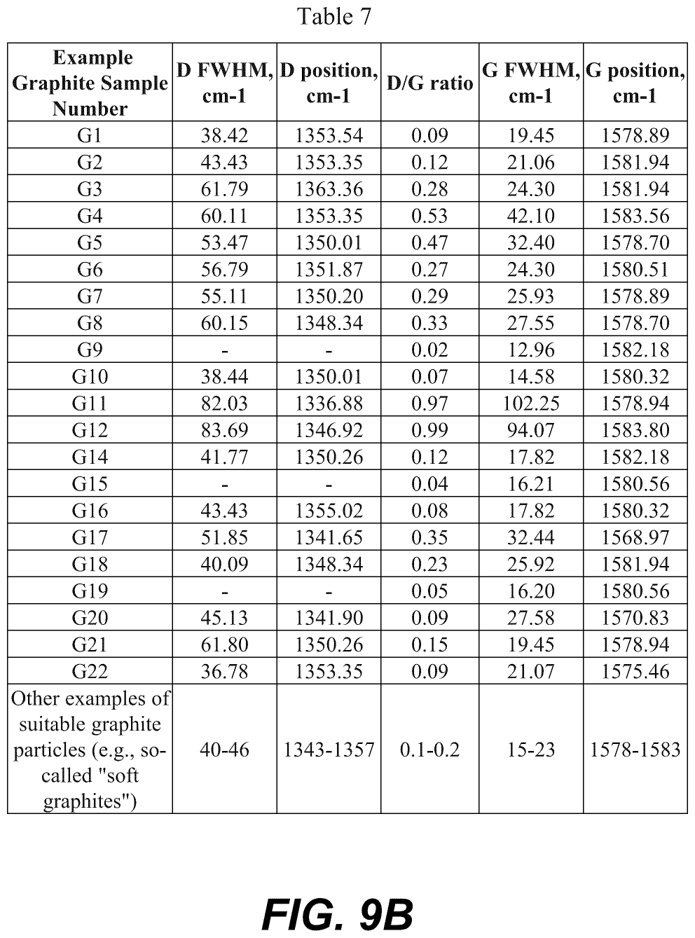

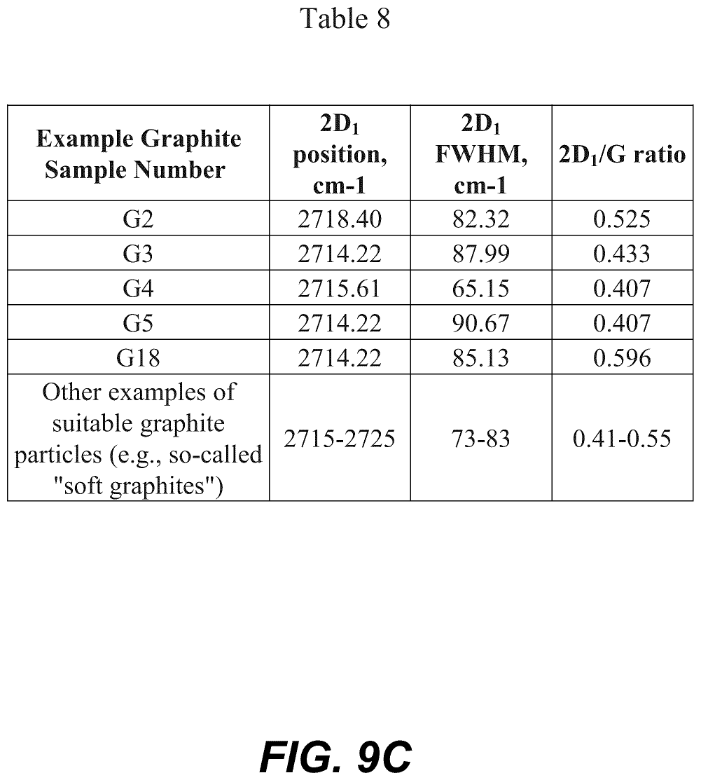

FIG. 9A illustrates typical Raman spectra of selected graphite (carbon) samples. FIG. 9A shows a Raman spectrum 902 including the D band and the G band for example graphite samples G1, G3, G4, and G6. FIG. 9A shows a Raman spectrum 904 including the D band, the G band, the 2D₁ band, and the 2D₂ band for example graphite samples G3 and G4.

Table 7 of FIG. 9B illustrates processed Raman data of the selected graphite (carbon) samples (example graphite samples G1 through G12, G14 through G22, as well as other examples of suitable graphite particles), showing, from left to right, the FWHM of the D band peak expressed in cm¹, the D peak position expressed in cm⁻¹, the D/G ratio, the FWHM of the G band peak expressed in cm⁻¹, and the G band peak position expressed in cm⁻¹.

Table 8 of FIG. 9C illustrates additional processed Raman data of the selected graphite (carbon) samples (example graphite samples G2 through G5, G18, as well as other examples of suitable graphite particles), showing, from left to right, the 2D₁ band peak position expressed in cm⁻¹, the FWHM of the 2D₁ band peak expressed in cm 1, and the 2D₁/G ratio.

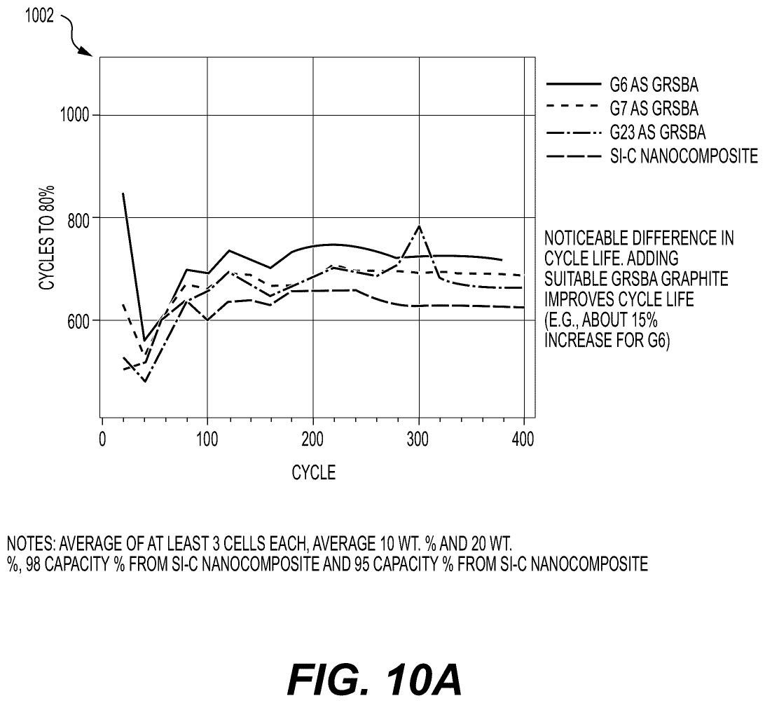

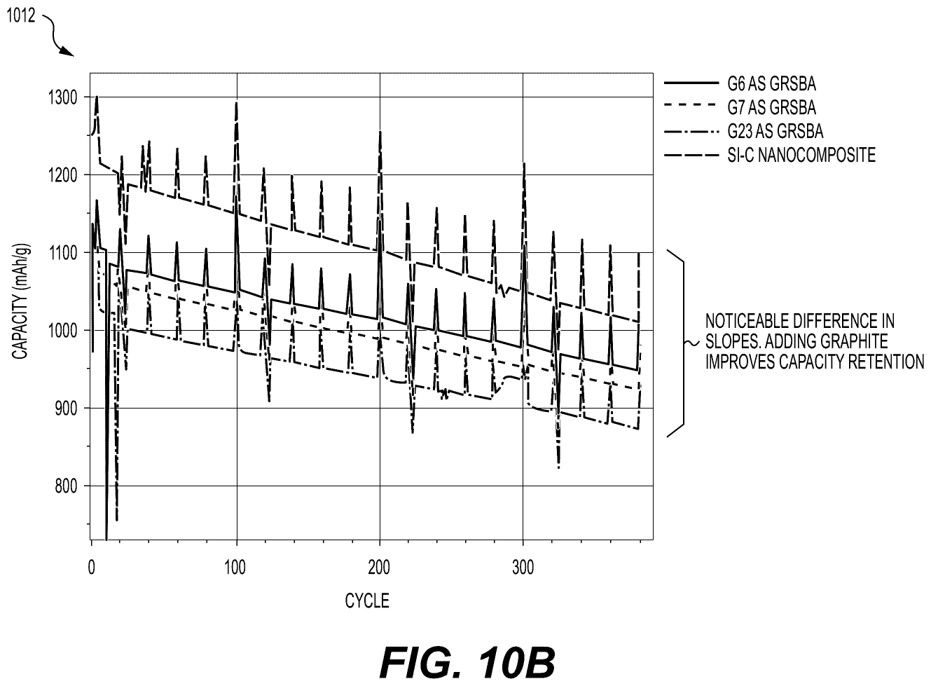

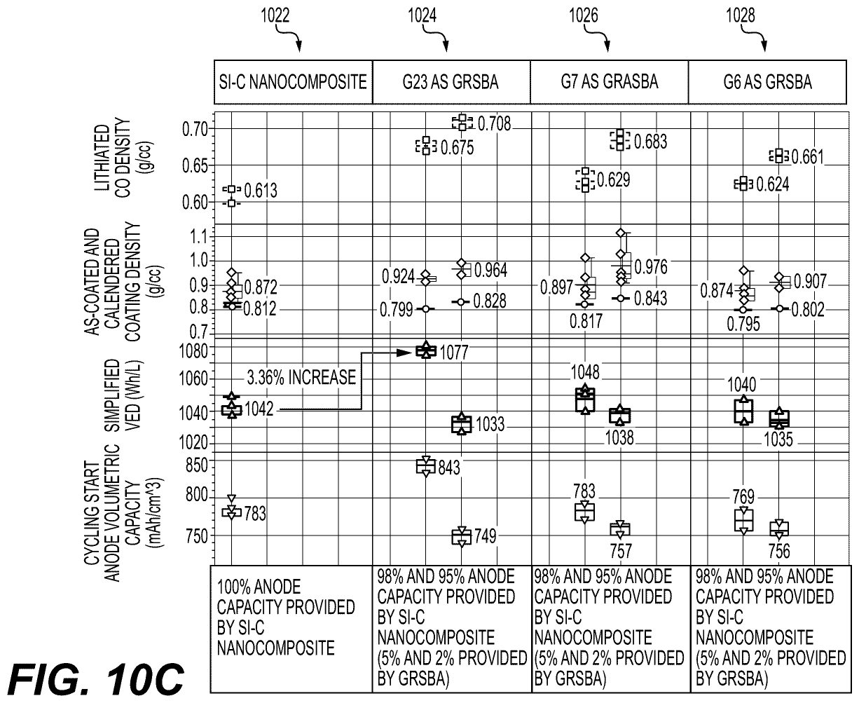

For the examples illustrated in FIGS. 10A, 10B, and 10C, Li-ion battery cells were produced using: (i) anodes with about 95%, about 98% and about 100% of capacity contributed by Si—C nanocomposite active material (e.g., particles) and about 5%, about 2% and about 0% of capacity contributed by GRSBA samples (with specific reversible Si—C nanocomposite capacity of about 1600 to about 1700 mAh/g when normalized by the weight of Si—C nanocomposite, which corresponds to about 40 to about 44 wt. % of silicon mass fraction in Si—C composite particles), respectively, casted on Cu current collector foil from a water-based suspension comprising the following solids: about 89.6 wt. % of active materials (for the anodes with the about 95%, about 98% and about 100% of capacity contributed by Si—C nanocomposite active material and the rest contributed by GRSBAs), a polyacrylic acid (PAA)-based copolymer binder (about 9.6 wt. %) and about 0.79 wt. % Denka acetylene black conductive additive powder, (ii) a cathode comprising about 93 wt. % high-voltage lithium cobalt oxide (LCO) active material (with specific reversible capacity of about 170 mAh/g when normalized by the weight of LCO active materials in the cathode) casted on Al current collector foil from an organic solvent suspension comprising a PVDF-based binder (about 3 wt. %), an artificial graphite (about 2 wt. %) and pure black (about 2 wt. %) conductive additives, matched with the anode at anode:cathode (negative-to-positive, NP) areal capacity ratio of about 1.1:1 and areal reversible capacity loading of about 3.6 mAh/cm², (iii) a polymer-ceramic separator, and (iv) an LiPF₆-based electrolyte comprising: about 14.7 wt. % LiPF₆, about 9.7 wt. % propylene carbonate (PC, cyclic carbonate), about 23.4 wt. % fluoroethylene carbonate (FEC, fluorinated cyclic carbonate), about 8.1 wt. % ethyl methyl carbonate (EMC, linear carbonate), about 7.8 wt. % diethyl carbonate (DEC, linear carbonate), about 34.1 wt. % ethyl propionate (EP, linear ester), and about 2.2 wt. % vinylene carbonate (VC, cyclic carbonate). All electrochemical (ECT) tests were performed using Arbin Instruments LBT battery cyclers, running MITS X PRO software. Cycling was obtained using a voltage range of 2.5-4.4V at a 1C charge and 1 C discharge, with capacity check cycles using a 1C charge to 4.0 V, then 0.5 C charge to 4.4 V, then a voltage hold to 0.05 C, followed by a 0.2 C discharge. Si—C nanocomposite particles with D₅₀ values in a range of 5 to 6 μm were used. In the foregoing example Li-ion battery cells in which Si—C nanocomposite active material contributed about 95% of the capacity, about 20 wt. % of the anode active material was GRSBA particles and about 80 wt. % of the anode active material was Si—C nanocomposite active material particles. In the foregoing example, Li-ion battery cells in which Si—C nanocomposite active material contributed about 98% of the capacity, about 10 wt. % of the anode active material is GRSBA particles and about 90 wt. % of the anode active material is Si—C nanocomposite active material particles.

FIG. 10A shows a graphical plot 1002 showing the estimated number of cycles to reach 80% of state-of-health (SOH) (also sometimes referred to herein as “N80”) of each respective lithium-ion battery test cell for Li-ion battery cells comprising LCO cathodes and Si-comprising anodes (in these illustrative examples based on either pure Si—C nanocomposite particles or Si—C nanocomposite particles blended with suitable GRSBA particles) by the addition of the GRSBA. In some cases, N80 is a convenient metric of the cycle life of a battery cell. N80 is obtained by estimating the number of cycles to reach 80% of cycling start capacity (during cycling at 25° C.). The cycling start capacity is defined as the capacity at the third cycle. In the graphical plot 1002, the lithium-ion battery cells with blended anodes employed example graphite particles G6, G7, and G23, respectively. The G23 graphite sample is an example of a soft graphite. The plotted data for each blend type (example graphite type) represents an average of the data for (a) a blend with about 98% of the capacity contributed by Si—C nanocomposite active material, and (b) a blend with about 95% of the capacity contributed by Si—C nanocomposite active material. In the examples shown, 6-15% improvements in the estimated cycle stability (cycle life) were attained by using G6, G7 and G23 graphite samples.

FIG. 10B shows graphical plots 1012 showing the anode capacity retention during cycling of Li-ion battery cells comprising LCO cathodes and Si-comprising anodes, where the anode active material either comprises only Si—C nanocomposite particles or blends of Si—C nanocomposite particles with suitable GRSBA graphite particles, as detailed above. In this illustrative example G6, G7 and G23 were used as GRSBAs. In the graphical plot 1012, the lithium-ion battery cells with blended anodes employed example graphite particles G6, G7, and G23, respectively. The plotted data for each blend type (example graphite type) represents an average of the data for (a) a blend with about 98% of the capacity contributed by Si—C nanocomposite active material, and (b) a blend with about 95% of the capacity contributed by Si—C nanocomposite active material. Graphical plot 1012 shows the dependence of capacity on cycle number for each battery type (anode comprising G6, G7, G23, or no graphite), and hence the slope of the respective plot is one indication of cycle stability. A less steep slope (smaller slope) is one indication of better cycle stability. Compared to the battery cells comprising Si—C nanocomposite particles only in the anode active material, the battery cells comprising G6, G7, or G23 graphite exhibited a less steep slope (smaller slope). Improved cycle stability (smaller slope in the capacity retention curve) was obtained with the GRSBA additions, with only minor reduction in gravimetric anode capacities. Additionally, the battery cells comprising G6 and G7 graphite samples exhibited relatively small reductions in anode capacities compared to battery cells comprising Si—C nanocomposite particles only in the anode active material.

FIG. 10C shows graphical plots (1022, 1024, 1026, 1028) showing: (a) anode coating densities after first lithiation, (b) as-coated (before calendering) and calendered anode coating densities, (c) estimated volumetric energy densities (simplified VEDs or VEDs), and (d) cycling-start volumetric charge capacities (VQDs) of battery cells (or anode coatings in the case of as-coated and calendered coating densities) employing Si-comprising anodes. In the examples shown, the cathode comprised LCO and the anode active material either comprises only Si—C nanocomposite particles or blends of Si—C nanocomposite particles with suitable GRSBA graphite particles, as detailed above. The VQD is defined as the anode capacity (at the third cycle) (expressed in mAh) divided by anode volume (expressed in cm³). The VED is defined as the cell energy (at the third cycle) (expressed in Wh) divided by the cell's external volume (expressed in liters). In the examples shown, G6, G7, and G23 were used as GRSBAs (2% and 5% of the total anode capacity contributed by GRSBAs and with 98% and 95% of the total anode capacity contributed by the Si—C nanocomposite particles, respectively). In FIG. 10C, in each column of plotted data for the respective graphite-comprising battery cells (from left to right, 1024 for G23, 1026 for G7, 1028 for G6), the data points on the left represent data for the cases in which 98% of the total anode capacity is contributed by the Si—C nanocomposite particles and the data points on the right represent data for the cases in which 95% of the total anode capacity is contributed by the Si—C nanocomposite particles. For example, the VQD of battery cells comprising G7 in which 98% of the total anode capacity is contributed by the Si—C nanocomposite particles is about 783 mAh/cm³ and the VQD of battery cells comprising G7 in which 95% of the total anode capacity is contributed by the Si—C nanocomposite particles is about 757 mAh/cm³ (for comparison, the Si—C nanocomposite particles only battery cells exhibited a VQD of about 783 mAh/cm³). For example, the VED of battery cells comprising G7 in which 98% of the total anode capacity is contributed by the Si—C nanocomposite particles is about 1048 Wh/1 and the VED of battery cells comprising G7 in which 95% of the total anode capacity is contributed by the Si—C nanocomposite particles is about 1038 Wh/1 (for comparison, the Si—C nanocomposite particles only battery cells exhibited a VED of about 1042 Wh/1). Accordingly, despite the dilution of the higher capacity Si—C nanocomposite particles by lower cost, lower-capacity graphite particles, the VED and the VQD values are generally comparable to (or in some cases, greater than) those of the battery cells comprising only Si—C nanocomposite particles in the anode active material, if the graphite particles are chosen judiciously (as detailed herein) and if the mass fraction of the graphite in the anode active material is held relatively low (e.g., about 2 wt. % to about 5 wt. %, about 5 wt. % to about 15 wt. %, about 15 wt. % to about 25 wt. %, about 5 wt. % to about 25 wt. %, or about 5 wt. % to about 20 wt. %, or about 2 wt. % to about 25 wt. %, or about 2 wt. % to about 20 wt. %, or about 2 wt. % to about 15 wt. %, or about 2 wt. % to about 10 wt. %). For example, the as-coated coating density of battery cells comprising G7 in which 98% of the total anode capacity is contributed by the Si—C nanocomposite particles is about 783 mAh/cm³ and the VQD of battery cells comprising G7 in which 95% of the total anode capacity is contributed by the Si—C nanocomposite particles is about 757 mAh/cm³ (for comparison, the Si—C nanocomposite particles only battery cells exhibited a VQD of about 783 mAh/cm³).

FIG. 10C shows the anode coating density as coated (after the slurry has dried and before calendering) and after calendering. The calendering pressure was set at about 5 tons. In the second row of data (for as-coated and calendered coating density) and in each column of plotted data for the respective battery cells (from left to right, 1022 for Si—C nanocomposite particles only in anode active material, 1024 for G23, 1026 for G7, 1028 for G6), the data points on the bottom (smaller values) represent the as-coated density and the data points on the top (greater values) represent the calendered coating density. For example, the as-coated coating density of anode coatings comprising Si—C nanocomposite particles only in the anode active material is about 0.812 g/cc, and the calendered coating density of anode coatings comprising Si—C nanocomposite particles only in the anode active material is about 0.872 g/cc (increase of about 0.060 g/cc from the calendering). For example, the as-coated coating density of anode coatings comprising G7 in which 98% of the total anode capacity is contributed by the Si—C nanocomposite particles (mass fraction of G7 in the anode active material is about 10 wt. %) is about 0.817 g/cc, and the calendered coating density of anode coatings comprising G7 in which 98% of the total anode capacity is contributed by the Si—C nanocomposite particles is about 0.897 g/cc (increase of about 0.080 g/cc from the calendering). For example, the as-coated coating density of anode coatings comprising G7 in which 95% of the total anode capacity is contributed by the Si—C nanocomposite particles (mass fraction of G7 in the anode active material is about 20 wt. %) is about 0.843 g/cc, and the calendered coating density of anode coatings comprising G7 in which 95% of the total anode capacity is contributed by the Si—C nanocomposite particles is about 0.976 g/cc (increase of about 0.133 g/cc from the calendering). In these examples, the increase in coating density from calendering increases with greater mass fractions of G7 graphite particles. The coatings employing other graphite samples (G23, G6) also exhibit increases in coating densities that increase with greater mass fraction of the graphite particles in the anode active material. In these examples a pronounced lubrication effect of certain graphite particles in the blended anode may be advantageously contributing to the greater coating densities. Such a lubrication effect may include improved packing of the particles in the anode coating and/or decreased occurrence of fractures and other damage to the Si—C nanocomposite particles.

Some embodiments of the present disclosure on Li-ion batteries comprising blended anodes with suitable GRSBA graphite particles may benefit from the use of certain binders in their composition. For example, one or more properties of the GRSBA may be suitable to serve as a solid lubricant during slurry processing and calendering, thus facilitating formation of smooth calendered electrodes and reducing or minimizing damages to the suitable binder even if the binder is relatively brittle. In some designs, for example, the suitable binder may be selected to exhibit strong adhesion and good dispersion of the slurry particles rather than facilitating high elasticity.

Illustrative examples of such suitable (in some designs, preferable) binders include, but are not limited to: polyacrylic acid (PAA) and its various derivatives including various salts of PAA (such as Na-PAA, Li-PAA, NH₄—PAA and/or others or their combinations), various co-polymers comprising polyacrylic acid (PAA) and its various derivatives including various salts of PAA (such as Na-PAA, Li-PAA, NH₄—PAA and/or others) (e.g., poly(acrylamide-co-acrylic acid) or partial or full poly(acrylamide-co-acrylic acid) salt (e.g., Na or Li or Ca or K or mixed), to name an illustrative example); alginic acids and its various derivatives including various (full or partial) salts of alginic acid (e.g., Na-alginate, Li-alginate, Ca-alginate, Al-alginate, etc.), various co-polymers comprising alginic acid and its various derivatives including various (full or partial) salts of alginic acid (e.g., poly(acrylamide-co-alginic acid) or partial or full poly(acrylamide-co-alginic acid) salts (e.g., Na or Li or Ca or K or mixed), to name an illustrative example); various salts of carboxymethyl cellulose (CMC) such as Na-CMC and/or others and its various derivatives including various copolymers comprising partial or full CMC salts; various co-polymers comprising styrene (e.g., styrene-butadiene rubber (SBR)), xanthan gum and various co-polymers comprising xanthan gum, polyvinyl chloride (PVC), nanocellulose, chitosan, butylacrylate and its various copolymers, gum Arabic and its various copolymers, guar gum and its various copolymers, carrageenan and its various copolymers, gelatin and its various copolymers, polyvinyl alcohol (PVA) and its various copolymers, maleic acid and their various salts (e.g., Li, Na, K, etc.; in some designs, Li-salt may often be particularly favorable) and copolymers, various (poly)acrylates (including, but not limited to dimethylaminoethyl acrylate and many others) and their copolymers, various (poly)acrylamides and their copolymers, various polyesters and their copolymers, (poly)ethylene oxide (PEO), cyclodextrin, maleic anhydride, methacrylic acid and its various salts (Li, Na, K, etc.; in some designs, Li— salt may often be particularly favorable), various (poly)ethylenimines (PEI) and their copolymers, various (poly)amide imides (PAI) and their copolymers, various (poly)amide amines and their copolymers, various other polyamine-based polymers, various (poly)ethyleneimines and their copolymers, sulfonic acid and their various salts and their copolymers, various catechol group-comprising polymers, various lignin-comprising or lignin-derived polymers, various epoxies, various cellulose-derived polymers (including, but not limited to nanocellulose fibers and nanocrystals, carboxyethyl cellulose, etc.), other polymers (e.g., preferably water-soluble polymers) and their various co-polymers and mixtures.

In some designs, water-soluble copolymer binders may comprise at least one of the following components: vinyl (or butyl or methyl or propyl, etc.) acetate, vinyl (or butyl or methyl or propyl, etc.) acrylic, vinyl (or butyl or methyl or propyl, etc.) alcohol, vinyl (or butyl or methyl or propyl, etc.) acetate-acrylic, vinyl (or butyl or methyl or propyl, etc.) acrylate, styrene-acrylic, alginic acid (or its salts, e.g., Na, K, Ca, Mg, Li, Sr, Cs, Ba, La and/or other salts), acrylic acid (or its salts, e.g., Na, IK, Ca, Mg, Li, Sr, Cs, Ba, La and/or other salts), vinyl (or butyl or methyl or propyl, etc.) siloxane (or other siloxanes), pyrrolidone, sterene, various sulfonates (e.g., styrene sulfonate, among others), various amines (incl. quaternary amines), various dicyandiamide resins, amide-amine, ethyleneimine, and diallyldimethyl ammonium chloride.

In some designs, water-soluble copolymer binders may comprise cellulose. In some designs, such a cellulose-comprising binder may comprise nanocellulose (nanofibers). In some designs, nanocellulose may comprise branched or dendritic cellulose nanofibers. In some designs, a nanocellulose-comprising binder may comprise at least one more binder component (e.g., CMC or others) with strong adhesion to contribute to the superior performance in the blended anode. In some designs, a nanocellulose-comprising binder may be water soluble.

In some designs, copolymer binders may comprise poly(acrylamide) (that is, comprise acrylamide (—CH₂CHCONH₂—) subunits). In some designs, such poly(acrylamide)-comprising copolymer binders may be water soluble. In some designs, such poly(acrylamide)-comprising copolymer binders may also comprise acrylic acid, carboxylic acid, alginic acid or metal salt(s) thereof (e.g., Na, K. Ca, Mg, Li, Sr, Cs, Ba, La and/or other salts of such acids). Such and other additions may be utilized to tune the ionic character of the polymer, its solubility and interactions with both the solvents and active (electrode) particles (e.g., to achieve stability of a slurry, etc.).

In some designs, anion conducting heterogeneous polymers (such as alkoxysilane/acrylate or epoxy alkoxysilane, etc.), various anion conducting interpenetrating polymer networks, various anion conducting poly (ionic liquids) (cross-linked ionic liquids) or poly(acrylonitriles), various anion conducting polyquaterniums, various anion conducting comprising quaternary ammonium salts (e.g., benzyltrialkylammonium tetraalkylammonium, trimethyl ammonium, dimethyl ammonium, diallyldimethylammonium, etc.), various anion conducting copolymers comprising ammonium groups, various anion conducting copolymers comprising norbornene, various anion conducting copolymers comprising cycloalkenes (e.g., cyclooctene), methacrylates, butyl acrylate, vinyl benzyl or poly(phenylene), various anion conducting copolymers comprising organochlorine compounds (e.g., epichlorohydrin, etc.), various anion conducting copolymers comprising ethers, bicyclic amines (e.g., quinuclidine), various anion conducting poly (ionic liquids) (cross-linked ionic liquids), various anion conducting copolymers comprising other amines (e.g., diamines such as ethylene diamine, monoamines, etc.), various anion conducting copolymers comprising poly(ether imides), various polysaccharides (e.g., chitosan, etc.), xylylene, guanidine, and/or pyridinium groups, among other groups (repeat units), may be advantageously used as copolymer binders (or components of the polymer/copolymer binder mixture) for the blended anodes in the context of one or more embodiments of the present disclosure. In some designs, a suitable copolymer binder may be cationic and highly charged.

In some designs, various cation conducting polymers (including interpenetrating polymer networks) and cross-linked ionic liquids (e.g., with cation conductivity above around 10⁻¹ S sm⁻¹) may be advantageously used for the blended anodes as binders or components of binders in the context with one or more embodiments of the present disclosure. In some designs, such polymers may advantageously exhibit medium-to-high conductivity (e.g., above around 10⁻¹ S sm⁻¹, or more preferably above around 10⁻⁶ S sm⁻¹) for Li ions (in the case of Li or Li-ion batteries).

In some designs, various electrically conductive polymers or copolymers (e.g., preferably with electrical conductivity above around 10⁻² S sm⁻¹), particularly those soluble in water (or at least processable in water-based electrode slurries) may be advantageously used as binders or components of binders (e.g., components of the binder mixtures or components of co-polymer binders) for the blended anodes in the context of one or more embodiments of the present disclosure. In particular, sulfur (S) containing polymers/co-polymers, also comprising aromatic cycles, may be advantageously utilized, in some designs. In some examples, S may be in the aromatic cycle (e.g., as in poly(thiophene)s (PT) or as in poly(3,4-ethylenedioxythiophene) (PEDOT)), while in other examples, S may be outside the aromatic cycle (e.g., as in poly(p-phenylene sulfide) (PPS)). In some designs, suitable conductive polymers/co-polymers may also comprise nitrogen (N) as a heteroatom. The N atoms may, for example, be in the aromatic cycle (as in poly(pyrrole)s (PPY), polycarbazoles, polyindoles or polyazepines, etc.) or may be outside the aromatic cycle (e,g., as in polyanilines (PANI)). Some conductive polymers may have no heteroatoms (e.g., as in poly(fluorene)s, polyphenylenes, polypyrenes, polyazulenes, polynaphthalenes, etc,). In some designs, the main chain may comprise double bonds (e.g., as in poly(acetylene)s (PAC) or poly(p-phenylene vinylene) (PPV), etc.). In some designs, it may be advantageous for the polymer/copolymer binders to comprise ionomers (e.g., as in polyelectrolytes where ionic groups are covalently bonded to the polymer backbone or as in ionenes, where ionic group is a part of the actual polymer backbone). In some designs, it may be advantageous to use a polymer mixture of two or more ionomers. In some designs, such ionomers may carry the opposite charges (e.g., one negative and one positive). Examples of ionomers that may carry a negative charge include, but are not limited to various deprotonated compounds (e.g., if parts of the sulfonyl group are deprotonated as in sulfonated polystyrene). Examples of ionomers that may carry a positive charge include, but are not limited to various conjugated polymers, such as PEDOT, among others. An example of the suitable polymer mixture of two ionomers with opposite charges is poly(3,4-ethylenedioxythiophene) polystyrene sulfonate. In some designs, it may be advantageous to use polymer binders that comprise both conductive polymers and another polymer that provides another functionality (e.g., serve as an elastomer to significantly increase maximum binder elongation or serve to enhance bonding to active materials or current collector, or serve to enhance solubility in water or other slurry solvents, etc.).

In some designs, copolymer binders may advantageously comprise halide anions (e.g., chloride anions, fluoride anions, bromide anions, etc.) for the blended anodes. In some designs, copolymer binders may advantageously comprise ammonium cations (e.g., in addition to halide anion, as, for example, in ammonium chloride). In some designs, copolymer binders may advantageously comprise sulfur (S). In some designs, copolymer binders may advantageously comprise allyl group (e.g., in addition to amnnonium cations), For example, such copolymer binders may advantageously comprise diallyldimethylammonium chloride (DADMAC) or diallyldiethylammonium chloride (DADEAC). Other suitable examples of such copolymer binder components may include (but are not limited to): methylammonium chloride, N,N-diallyl-N-propylammonium chloride, methylammonium bromide, ethylammonium bromide, propylammonium bromide, butylammonium bromide, methylammonium fluoride, ethylammonium fluoride, propylammonium fluoride, butylammonium fluoride, to name a few.

In some designs, copolymer binders for the blended anodes may comprise both poly(acrylamide) and ammonium halides (e.g., ammonium chloride) in their structure. As one suitable example, poly(acrylamide-co-diallyldimethylammonium chloride) (PAMAC) may be advantageously used as a copolymer binder in the context of the present disclosure. In some designs, such PAMAC copolymer binders may additionally comprise minor (e.g., less than around 5-10 wt. %) amounts of acrylic acid, carboxylic acid or alginic acid or metal salt(s) thereof (e.g., Na, K, Ca, Mg, Li, Sr, Cs, Ba, La and/or other salts of such acids).

Note that in some designs, the described slurries comprising suitable binders, conductive additives and blended active materials may also comprise dispersants.

In some designs, elastic nanofibers or nanoribbons (e.g., with an average diameter in the range from around 2 nm to around 500 nm, an average length in the range from around 10.0 nm to around 500,000.0 nm and an average aspect ratio in the range from around 3:1 to around 10,000:1) or elastic flakes (e.g., with an average thickness in the range from around 1 nm to around 500 nm, an average length in the range from around 10.0 nm to around 500,000.0 nm and an average aspect ratio in the range from around 3:1 to around 10,000:1; in some designs with holes) may be advantageously used instead of or in addition to conventional elastic nanoparticles. Suitable examples of compositions of such particles include, but are not limited to: SBR, polybutadiene, polyethylene, polyethylene propylene, styrene ethylene butylene, ethylene vinyl acetate, polytetrafluoroethylene, perfluoroalkoxyethylene, isoprene, butyl rubber, nitrile rubber, ethylene propylene rubber, polyacrylic rubber, silicone rubber, fluorosilicone rubber, polyether block amide, polysiloxanes and their various copolymers (such as polydimethylsiloxane), chlorosulfonated polyethylene, ethylene-vinyl acetate, their various mixtures and copolymers, among other suitable elastomers. In some designs, a suitable mass fraction of such elastic nanoparticles (or nanofibers or nanoflakes) may range from around 5 wt. % to around 70 wt. % (as a fraction of the total binder content in the blended anode).

Some embodiments of the present disclosure on Li-ion batteries comprising blended anodes with suitable GRSBA graphite particles may benefit from the use of certain separators in battery cell fabrication. For example, anodes comprising hard Si-comprising active material particles (e.g., Si—C nanocomposites, SiOx-based particles, etc.) or a blend of Si-comprising active material particles and hard graphite (or, broadly, hard carbons) may exhibit some roughness even after calendering (especially for anodes with about 20% or more, or about 30% or more, or about 50% or more, or about 75% or more capacity contributed by Si-comprising active material particles). Such a high roughness may induce stress-concentrated areas within a separator, which may lead to its premature failure during cycling, which, in term, may lead to faster degradation, thermal runaway and/or other undesirable factors, in some designs. In some designs, to reduce or minimize the probability of such undesirable events to acceptable levels, the separator selection may be limited to relatively thick one separators (e.g., in some designs, with thickness in excess of about 12 micron; in other designs, with thickness in excess of about 17 micron; etc.), which reduces battery energy density and increases cost. Furthermore, in such cells, the use of ceramic-based or ceramic-coated separators may be challenging due to the brittle nature of the ceramic layer and/or the potential of forming cracks, in some designs. However, in some designs, ceramic-free separators (e.g., polymer separators) may exhibit insufficient safety or insufficient thermal properties or other limitations. In contrast, with the Li-ion battery cell design where blended anodes comprise a suitable amount of suitable GRSBA graphite (carbon) particles the calendered anodes may be very smooth (e.g., because GRSBA may serve as a solid lubricant during calendering, facilitating formation of densely packed and smooth anode layers). As such, in some designs, relatively thin separators may be used safely and effectively with the disclosed anodes (e.g., with overall separator thickness below about 12 micron (μm); in some designs, below about 10 micron; in some designs, below about 8 micron; in some designs, below about 6 micron; in yet some designs, below about 4 micron). In some designs, a thin separator may have thicknesses of greater than about 0.5 μm; in some other designs, greater than about 1 μm; in some other designs, greater than about 2 μm; and in some other designs, greater than about 3 μm. Furthermore, separators (including such thin separators) may comprise suitable ceramic (e.g., aluminum oxide, aluminum hydroxide, aluminum oxyhydroxide, magnesium oxide, magnesium hydroxide, magnesium oxyhydroxide, lithium oxide, lithium hydroxide, other oxides, hydroxides, oxyhydroxides and their various combinations, etc.) materials (e.g., in the form of ceramic nanofibers, ceramic nanowires, ceramic nanotubes, ceramic particles, ceramic flakes, ceramic surface coatings, ceramic layers, their various combinations, etc.). In some designs, the total weight fraction of the ceramic material in such separators may range from about 10 wt. % to about 100 wt. % (e.g., in some designs, from about 10 wt. % to about 25 wt. %; in other designs, from about 25 wt. % to about 50 wt. %; in other designs, from about 50 wt. % to about 75 wt. %; in yet other designs from about 75 wt. % to about 100 wt. %). In some designs, such separators may comprise two or more layers. In some designs, at least one of such layers may comprise a significantly higher fraction of ceramic materials than one or more other layers. In some implementations in which there are multiple layers and at least one of the layers (“higher-ceramic content layer”) has a higher weight fraction of ceramics than another one of the layers (“lower-ceramic content layer”), the higher-ceramic content layer may have a ceramic weight fraction that is at least about 50% greater than the lower-ceramic content layer. In some other implementations in which there are multiple layers and at least one of the layers (“higher-ceramic content layer”) has a higher weight fraction of ceramics than another one of the layers (“lower-ceramic content layer”), the higher-ceramic content layer may have a ceramic weight fraction that is at least about 100% greater than the lower-ceramic content layer. In some designs, at least a portion of the separator may be deposited directly onto the surface of the blended anode. Alternatively, a solid-state electrolyte interposed between the anode and the cathode may be employed to function as a separator, thereby obviating the need for a polymer or ceramic separator. In such cases, the solid-state electrolyte needs to be sufficiently thick to ensure safe operation, such as greater than about 0.5 μm in some implementations.

Some embodiments of the present disclosure on Li-ion batteries comprising blended anodes with suitable GRSBA graphite particles may benefit from the use of certain electrolyte compositions in battery cell fabrication to attain superior characteristics. In some designs, suitable electrolyte composition may comprise (i) one, two, three or more Li salts with the total concentration in the range from about 0.8M to about 2.0 M (in some designs, from about 0.8M to about 1.0 M; in other designs, from about 1M to about 1.1M; in other designs, from about 1.1M to about 1.2M; in other designs, from about 1.2M to about 1.3M; in other designs, from about 1.3M to about 1.4M; in other designs, from about 1.4M to about 1.6M; in other designs, from about 1.6M to about 1.7M; in other designs, from about 1.7M to about 1.8M; in other designs, from about 1.8M to about 2.0 M); (ii) one, two or more cyclic carbonates (in some designs, fluorinated cyclic carbonates, such as FEC, among others), (iii) zero, one, two, three or more nitrogen-comprising co-solvents (in some designs, at least some of the nitrogen comprising co-solvents may advantageously comprise two or three or more nitrogen atoms per molecules), (iv) zero, one, two, three or more sulfur comprising co-solvents, (v) zero, one, two, three or more phosphorous comprising co-solvents (note that some co-solvents may advantageously comprise both phosphorus and sulfur), (vi) zero, one, two, three or more linear or branched esters as co-solvents, (vii) zero, one, two, or more linear carbonates as co-solvents, (viii) zero, one, two, three or more additional electrolyte co-solvents or additives, or (ix) any combination thereof. In some designs, the volume fraction of linear esters (as a fraction of all co-solvents in the electrolyte) may range from about 20 vol. % to about 85 vol. % (in some designs, from about 20 vol. % to about 40 vol. %; in other designs, from about 40 vol. % to about 60 vol. %; in yet other designs, from about 60 vol. % to about 85 vol. %). In some designs, the volume fraction of branched esters (as a fraction of all co-solvents in the electrolyte) may range from about 10 vol. % to about 80 vol. % (in some designs, from about 10 vol. % to about 30 vol. %; in other designs, from about 30 vol. % to about 60 vol. %; in yet other designs, from about 60 vol. % to about 80 vol. %). In some designs, the volume fraction of cyclic carbonates (as a fraction of all co-solvents in the electrolyte) may range from about 5 vol. % to about 40 vol. % (in some designs, from about 5 vol. % to about 10 vol. %; in other designs, from about 10 vol. % to about 20 vol. %; in yet other designs, from about 20 vol. % to about 40 vol. %). In some designs, the volume fraction of fluorinated cyclic carbonates (as a fraction of all co-solvents in the electrolyte) may range from about 1 vol. % to about 20 vol. % (in some designs, from about 1 vol. % to about 4 vol. %; in other designs, from about 4 vol. % to about 6 vol. %; in other designs, from about 6 vol. % to about 12 vol. %; in yet other designs, from about 12 vol. % to about 20 vol. %). In some designs, the volume fraction of vinylene carbonate (VC) (as a fraction of all co-solvents in the electrolyte) may range from about 0.25 vol. % to about 6 vol. % (in some designs, from about 0.25 vol. % to about 0.5 vol. %; in other designs, from about 0.5 vol. % to about 1 vol. %; in other designs, from about 1 vol. % to about 2 vol. %; in yet other designs, from about 2 vol. % to about 6 vol. %). In some designs, about 50 vol. % or more of the co-solvents may advantageously exhibit a melting point below about minus (˜) 60° C. (in some designs, below about −70° C.; in other designs, below about −80° C.). In some designs utilizing two or more salts (e.g., two salts or three salts or four salts or five salts, etc.), it may be advantageous for at least one of the salts to comprise LiPF₆. In some designs, the incorporation of such salts may enhance properties (e.g., cycle stability, resistance, thermal stability, performance at high or low temperatures, etc.) of the cathode electrolyte interphase (CEI) layer or the anode solid electrolyte interface (SEI) layer or provide other performance advantages. In some designs, it may be further advantageous for at least one other salt to also be a salt of Li. Examples of some of such suitable salts include, but are not limited to: LiFSI, LiTFSI, LiBETI and/or other Li imide salts, Li bis(oxalato)borate (LiBOB), Li difluoro(oxalato)borate (LiDFOB), Li 2-trifluoromethyl-4,5-dicyanoimidazolide (LiTDi), Li 4,5-dicyano-2-(pentafluoroethyl) imidazolide (LiPDi), Li difluorophosphate (LiDFP), Li nitrate (LiNO₃), etc.).

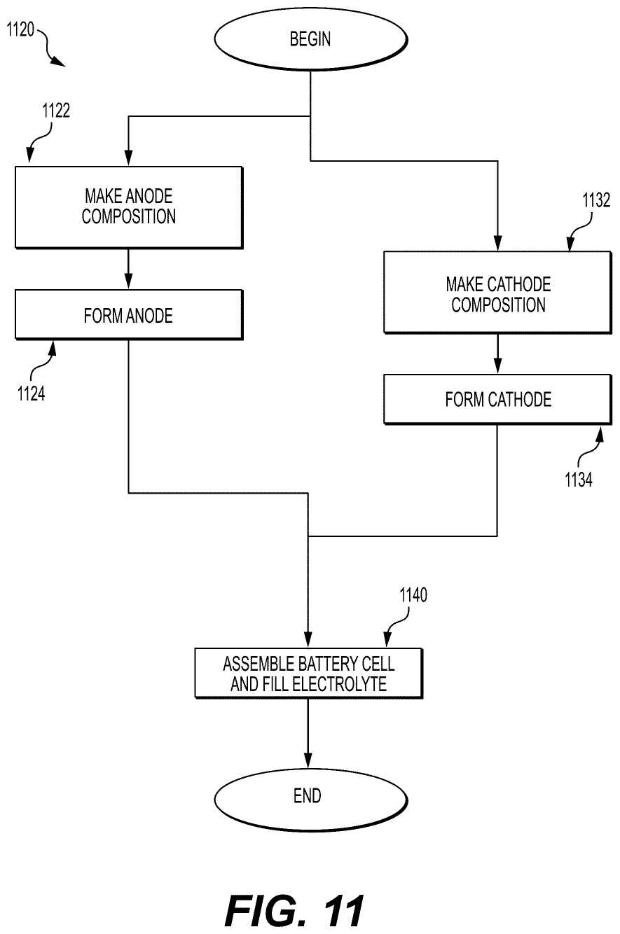

FIG. 11 shows a flow diagram of a suitable process 1120 for making a Li-ion battery, such as the example battery 100 of FIG. 11. In the example shown, process 1120 includes operations 1122, 1124, 1132, 1134, and 1140. The flow diagram includes an anode branch (left branch) that includes operations 1122 and 1124, and a cathode branch (right branch) includes operations 1132 and 1134. At operation 1122, suitable anode particles (e.g., conventional graphite (carbon) anode particles or Si-comprising (e.g., Si—C nanocomposite(s), core-shell, SiOₓ-based, or SiNₓ-based, etc.) particles are provided or made, and at operation 1124, a suitable blended anode is formed. Similarly, at operation 1132, cathode particles (e.g., conventional intercalation-type cathode particles or core-shell cathode particles or composite cathode particles, including but not limited to conversion-type cathode material-comprising composite particles) are provided or made, and at operation 1134, a cathode is formed.

Electrodes utilized in Li-ion batteries are typically produced by (i) formation of a slurry comprising active materials, conductive additives, binder solutions and, in some cases, surfactant or other functional additives; (ii) casting the slurry onto a metal foil current collector (e.g., Cu or Cu-alloy foil for most anodes and Al or Al-alloy foil for most cathodes); and (iii) drying the casted electrodes to completely evaporate the solvent. Note that a metal mesh, metal foam or very rough metal foil (e.g., comprising metal nanowires or metal nanosheets on its surface) may be used as current collector(s) in some designs (e.g., for higher areal capacity loadings or for achieving faster charge, etc.). Also note that a metal coated thin polymer sheet may also be used in some designs as current collector(s) (e.g., to achieve improved safety or lower current collector weight, etc.). Also note that a porous metal foil or composite (e.g., nanocomposite) metal foils may be used in some designs (e.g., for improved properties, lower weight, etc.).

Operation 1124 includes forming an anode electrode, with the anode electrode including the anode particles made at operation 1122. For example, operation 1124 can include (1) making an anode slurry that includes the anode particles (e.g., from operation 1122) and other anode slurry components (e.g., binder, additives, etc.) and (2) casting the anode slurry on and/or (in case of a porous current collector) in an anode current collector (e.g., copper foil or copper-alloy foil current collector, porous copper or copper alloy or nickel or nickel alloy foam or foil, or nickel-alloy current collector or polymer-comprising current collector, etc.). For example, other anode slurry components may include: other electrochemically-active anode active materials (e.g., suitable natural or synthetic graphite, soft carbon or hard carbon (e.g., comprising GRSBA) blended with Si-comprising active material particles, such as Si—C nanocomposite particles, among others), electrically conductive additives (e.g., carbon nanotubes or carbon black or branched carbon or carbon nanofibers or graphite flakes or exfoliated graphite or graphene or graphene oxide or soft graphite or their various combinations, to name a few), binders (e.g., polymer binders), and solvents (e.g., water or a suitable organic solvent). In some designs, solvent-free electrode fabrication may be utilized.

Operation 1134 includes forming a cathode electrode, with the cathode electrode including the cathode particles made at operation 1132. For example, this operation 1134 can include (1) making a cathode slurry that includes the cathode particles (e.g., from operation 1132) and other cathode slurry components and (2) casting the cathode slurry on and/or (in case of a porous current collector) in a cathode current collector (e.g., aluminum foil or aluminum-alloy foil current collector). For example, other cathode slurry components may include: other electrochemically-active cathode active materials, electrically conductive additives (e.g., carbon nanotubes or carbon black or branched carbon or carbon nanofibers or graphite flakes or graphene or graphene oxide or soft graphite or their various combinations, to name a few), binders (e.g., polymer binders), and solvents (e.g., water or a suitable organic solvent or their suitable mixtures). In some designs, solvent-free (“dry”) electrode fabrication may be utilized.

At operation 1140, the Li-ion rechargeable battery cell is assembled from at least the anode electrode (e.g., blended anode comprising GRSBA and Si-comprising active material particles, such as Si—C nanocomposites, among others) and the cathode electrode with an electrolyte interposed between the anode electrode and the cathode electrode. The electrolyte provides ionic conduction between the (e.g., blended) anode and the cathode. The electrolyte ionically couples the anode and the cathode. The electrolyte may comprise a liquid electrolyte or a solid electrolyte (or a mixture of liquid and solid electrolyte) at battery operating temperatures (e.g., in some designs, the solid electrolyte may be molten or semi-molten during melt-infiltration and may subsequently solidify). In some implementations (e.g., implementations in which a liquid electrolyte is used), a separator may be used to maintain a space between the anode and the cathode electrodes (e.g., to avoid a short-circuit).

Battery cell modules or battery cell packs may advantageously comprise cells with electrode and/or electrolyte compositions provided in one or more embodiments of the present disclosure. Such cell modules or packs may offer improved performance characteristics, simplified designs, better safety features or lower cost.

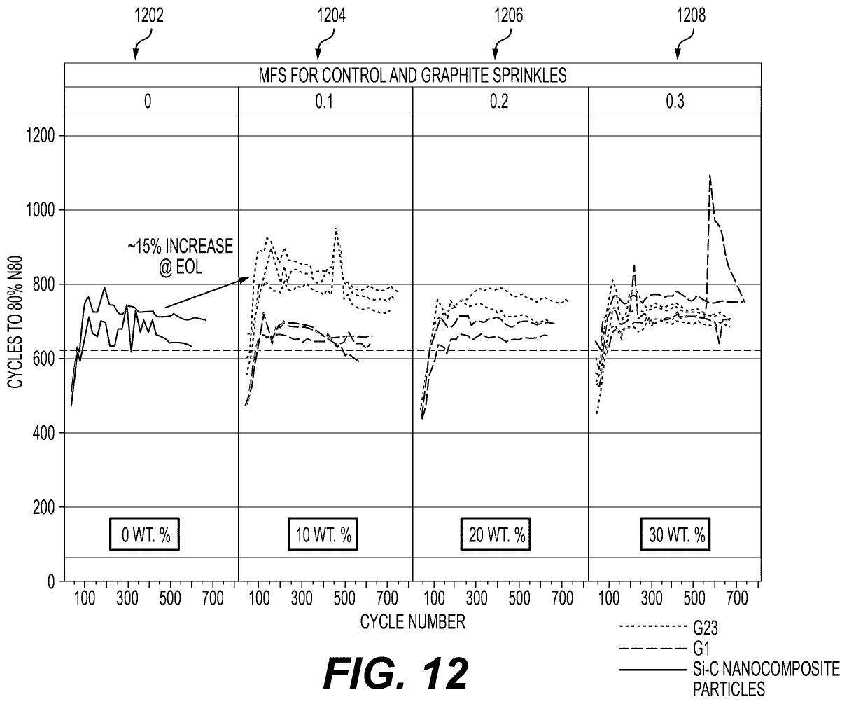

FIG. 12 shows graphical plots of the dependence of estimated cycle life (N80) on cycle number for lithium-ion battery test cells: (1) comprising no graphite particles (graphical plot 1202); (2) comprising graphite particles (G1 or G23) at 10 wt. % of the anode active material (graphical plot 1204); (3) comprising graphite particles (G1 or G23) at 20 wt. % of the anode active material (graphical plot 1206); and (4) comprising graphite particles (G1 or G23) at 30 wt. % of the anode active material (graphical plot 1208). The lithium-ion battery cells used in the measurements were similar to those reported for FIGS. 10A, 10B, and 10C, except that the D₅₀ value of the Si—C nanocomposite particles was about 4.56 μm. In the examples shown, (1) anodes in which the graphite particles are at 10 wt. % of the anode active material (1204) have a mass ratio of the Si—C nanocomposite particles to the graphite active material particles of about 90:10; (2) anodes in which the graphite particles are at 20 wt. % of the anode active material (1206) have a mass ratio of the Si—C nanocomposite particles to the graphite active material particles of about 80:20; and (3) anodes in which the graphite particles are at 30 wt. % of the anode active material (1206) have a mass ratio of the Si—C nanocomposite particles to the graphite active material particles of about 70:30. Among the graphite samples considered, G1 is a relatively hard graphite among the graphite samples studied herein, exhibiting a Cx value of about 25.5 MPa while G23 is considered to be a soft graphite even though its exact Cx value is not known. The cycle life (N80) characteristics differ among the G1 and G23-comprising battery cells. When G23 is employed in a blended anode at 10 wt. % of the anode active material (1204), N80 increases by about 15% compared to the comparative example in which the anode active material comprises no graphite particles and only Si—C nanocomposite particles are employed in the anode active material. When G23 is employed in a blended anode at 20 wt. % of the anode active material (1206), N80 increases by about 5% compared to the comparative example. When G 23 is employed in a blended anode at 30 wt. % of the anode active material (1208), N80 does not appreciably increase compared to the comparative example. Accordingly, in some implementations, soft graphite particles in the blended anode may contribute to an increase in cycle life, particularly at relatively low mass fractions of graphite particles in the anode active material (e.g., in a range of about 2 to about 40 wt. %, in a range of about 2 to about 35 wt. %, in a range of about 2 to about 25 wt. %, in a range of about 2 to about 15 wt. %, in a range of about 5 to about 35 wt. %, in a range of about 5 to about 25 wt. %, or in a range of about 5 to about 15 wt. %). In some implementations, soft graphite particles in the blended anode may contribute to an increase in cycle life, particularly at relatively high mass ratios of Si—C nanocomposite particles (which is an example of Si-comprising active material particles) to graphite active material particles (e.g., in a range of about 60:40 to about 98:2, in a range of about 65:35 to about 98:2, in a range of about 75:25 to about 98:2, in a range of about 85:15 to about 98:2 2, in a range of about 65:35 to about 95:5, in a range of about 75:25 to about 95:5, or in a range of about 85:15 to about 95:5). In contrast, when G1 was employed in a blended anode at 10 wt. % or 20 wt. % of the anode active material (1204, 1206), no appreciable increase in cycle life (N80) compared to the comparative example was observed.

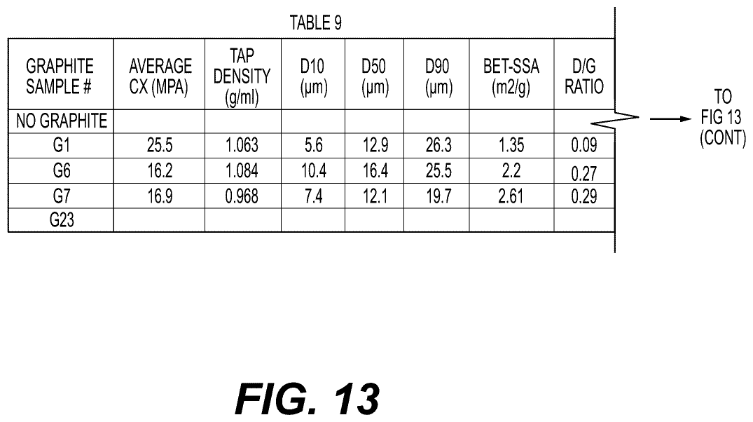

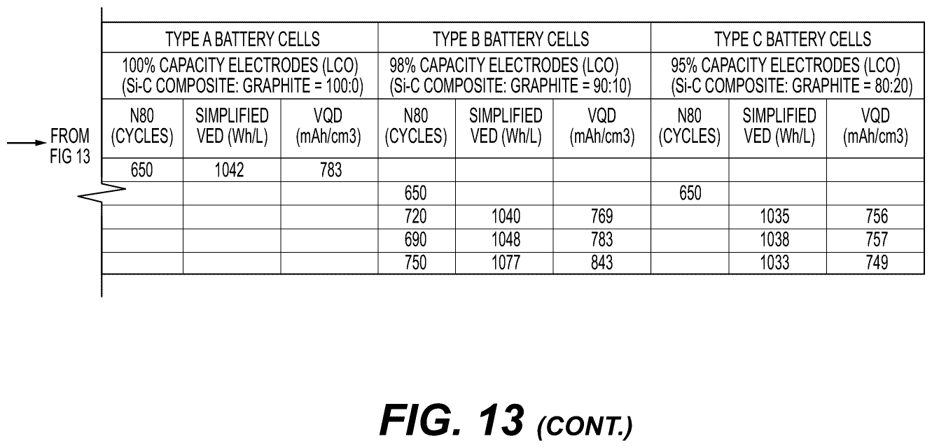

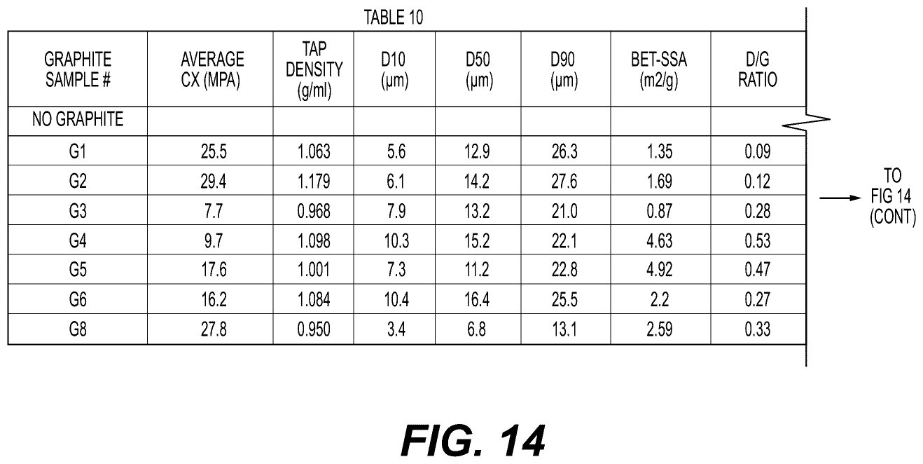

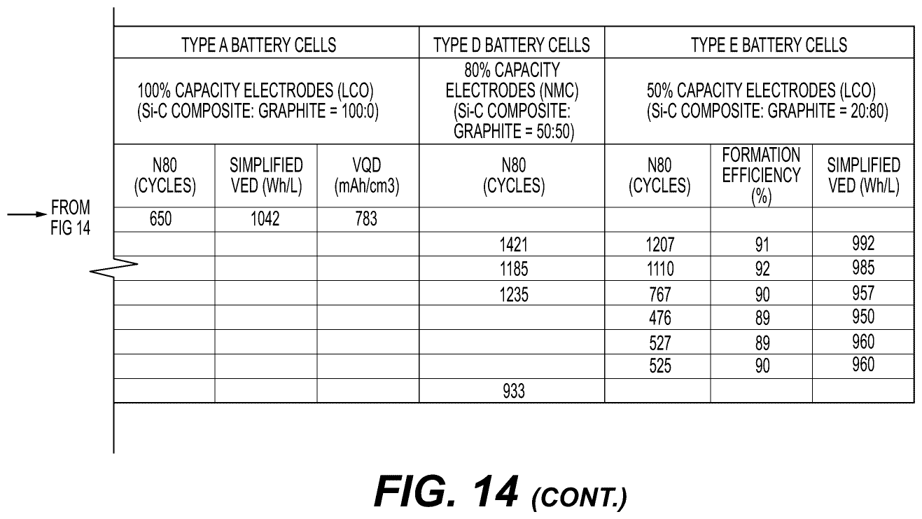

FIG. 13 shows Table 9, listing example graphite particle samples, their selected characteristics (Cx, tap density, particle size distribution (PSD) characteristics, BET-SSA values, and D/G ratio values), and certain battery performance characteristics of lithium-ion battery cells employing the example graphite particle samples, at lower mass fractions of the graphite particles in the respective anode active materials (e.g., compare to Table 10 of FIG. 14). Li-ion battery cells of the following types were considered in Table 9: (A) comparative example in which the anode active material comprises no graphite particles and only Si—C nanocomposite particles are employed in the anode active material (mass ratio of Si—C nanocomposite particles: graphite particles is 100:0, graphite particles are 0 wt. % of the anode active material); (B) examples in which mass ratio of Si—C nanocomposite particles: graphite particles is 90:10 (graphite particles are 10 wt. % of the anode active material) (Si—C nanocomposite particles contribute about 98% of the anode capacity), graphite particles are G1, G6, G7, or G23; and (C) examples in which mass ratio of Si—C nanocomposite particles: graphite particles is 80:20 (graphite particles are 20 wt. % of the anode active material)(Si—C nanocomposite particles contribute about 95% of the anode capacity), graphite particles are G1, G6, G7, or G23. The lithium-ion battery cells used in the measurements were similar to those reported for FIGS. 10A, 10B, and 10C.

In Table 9, the G1-comprising battery cells (10 wt. % and 20 wt. % of G1 in the anode active material) exhibited N80 values similar to the N80 of the comparative example battery cell (about 650 cycles). On the other hand, the G6, the G7, and the G23-comprising battery cells (comprising 10 wt. % of the respective graphite in the respective anode active material) exhibited greater N80 values of ˜720, ˜690, and ˜750 cycles, respectively. The VED and VQD values measured for the G6, G7, and G23-comprising battery cells (comprising 10 wt. % and 20 wt. % of the respective graphite in the respective anode active material) were generally comparable to the VED and VQD values of the comparative example battery cells. Among the graphite samples considered in Table 9, the following are some of the characteristics that distinguish G1 from the other graphite samples: G1 has a relatively large Cx value (25.5 MPa), a relatively small D₁₀ value (5.6 μm), a relatively large D₉₀ value (26.3 μm) (hence, the full width D₉₀-D₁₀ is relatively large), a relatively small BET-SSA value (1.35 m²/g), and a relatively small D/G ratio (0.09). In some implementations, a mass fraction of the graphite active material particles in the anode active material is in a range of about 2 to about 40 wt. % (e.g., about 5 to about 35 wt. %, about 5 to about 25 wt. %, or about 5 to about 15 wt. %). In some implementations, a mass ratio of the Si—C nanocomposite particles to the graphite active material particles is in a range of about 60:40 to about 98:2 (e.g., about 65:35 to about 95:5, about 75:25 to about 95:5, or about 85:15 to about 95:5). In some implementations, the average Cx value of at least some of the graphite active material particles is in a range of about 1 MPa to about 18 MPa (e.g., about 7 MPa to about 18 MPa, about 10 MPa to about 18 MPa, or about 14 MPa to about 18 MPa). In some implementations, the D/G ratio of at least some of the graphite active material particles is in a range of about 0.02 to about 1.12 (e.g., about 0.08 to about 0.30, or about 0.12 to about 0.30). In some implementations, the D₅₀ value of at least some of the graphite active material particles is in a range of about 2 to about 22 μm (e.g., about 11 to about 17 μm, or about 12 to about 17 μm). In some implementations, the D₉₀ value of at least some of the graphite active material particles is in a range of about 4 to about 30 μm (e.g., about 19 to about 30 μm, or about 19 to about 26 μm). In some implementations, the D₁₀ value of at least some of the graphite active material particles is in a range of about 0.5 to about 15 μm (e.g., about 5 to about 11 μm, or about 7 to about 11 μm). In some implementations, the BET-SSA value of at least some of the graphite active material particles is in a range of about 0.450 to about 450 m²/g (e.g., about 1 to about 5 m²/g, or about 1 to about 3 m²/g).

FIG. 14 shows Table 10, listing example graphite particle samples, their selected characteristics (Cx, tap density, particle size distribution (PSD) characteristics, BET-SSA values, and D/G ratio values), and certain battery performance characteristics of lithium-ion battery cells employing the example graphite particle samples, at higher mass fractions of the graphite particles in the respective anode active materials. (e.g., compare to Table 9 of FIG. 13). Li-ion battery cells of the following types were considered in Table 10: (A) comparative example in which the anode active material comprises no graphite particles and only Si—C nanocomposite particles are employed in the anode active material (mass ratio of Si—C nanocomposite particles: graphite particles is 100:0, graphite particles are 0 wt. % of the anode active material); (D) examples in which mass ratio of Si—C nanocomposite particles: graphite particles is 50:50 (graphite particles are 50 wt. % of the anode active material)(Si—C nanocomposite particles contribute about 80% of the anode capacity), graphite particles are G1, G2, G3, or G8; and (E) examples in which mass ratio of Si—C nanocomposite particles: graphite particles is 20:80 (graphite particles are 80 wt. % of the anode active material)(Si—C nanocomposite particles contribute about 50% of the anode capacity), graphite particles are G1, G2, G3, G4, G5, or G6.

Details of the battery cells used in the results reported in Table 10 are as follows. The comparative example battery cells are identical to those reported in Table 9 and are similar to those reported for FIGS. 10A, 10B, and 10C. In the type D battery cells (50 wt. % graphite), (a) the anode composition was adjusted so that the blended anode comprised Si—C nanocomposite particles and graphite particles at a mass ratio of about 50:50; and (b) the cathode was an NCM-based cathode. The cathode comprised NMC811 (composition approximately LiNi_{0.8}Mn_{0.1}Co_{0.1}O₂) active material (with specific reversible capacity of about 200 mAh/g when normalized by the weight of active material particles in the cathode) casted on Al current collector foil from an organic solvent suspension comprising a PVDF-based binder and a carbon black conductive additive. NMC811 is an example of a lithium nickel manganese cobalt oxide (NCM) material. The battery cells were assembled with an anode, a cathode, a polymer-ceramic separator between the anode and the cathode, and a an LiPF₆-based electrolyte comprising: 13.92 wt. % of LiPF₆ (as a primary lithium salt), 13.33 wt. % of fluoroethylene carbonate (FEC), 5.04 wt. % of ethylene carbonate (EC), 3.85 wt. % of ethyl methyl carbonate (EMC), 62.49 wt. % of dimethyl carbonate DMC, 0.52 wt. % of vinylene carbonate (VC), and 0.85 wt. % of lithium difluorophosphate (LFO). In the type E battery cells (80 wt. % graphite), the anode composition was adjusted so that the blended anode comprised Si—C nanocomposite particles and graphite particles at a mass ratio of about 20:80. Except for the blended anode composition, the type E battery cells were similar to those reported for FIGS. 10A, 10B, and 10C.

Among the type E (80 wt. % graphite) battery cells shown in Table 10, large variations in the N80 values (cycle life) were observed, ranging between ˜476 cycles (G4-comprising battery cells) and ˜1207 cycles (G1-comprising battery cells). Notably, G1 is the graphite sample that exhibited the lowest N80 values (˜650 cycles) in the 10 wt. % and 20 wt. % graphite battery cells of Table 9. The graphite samples considered (G1, G2, G3, G4, G5, G6) had D₅₀ values ranging between 11 μm and 17 μm. Among these graphite samples, there is a positive correlation between the N80 values (cycle life) and the Cx values (which is representative of the hardness). There is also a correlation between relatively high BET-SSA values (e.g., in a range of about 2 to about 5 m²/g or about 3 to about 5 m²/g) and low N80 values. There is a correlation between moderate BET-SSA values (e.g., in a range of about 1 to about 3 m²/g or about 1 to about 2 m²/g) and high N80 values. Accordingly, in some implementations, an optimum range of BET-SSA values (e.g., in a range of about 1 to about 3 m²/g or about 1 to about 2 m²/g) of the graphite particles may contribute to increased N80 values (improved cycle life). In the examples shown, the choice of graphite particles appears to be correlated to the N80 performance of battery cells. On the other hand, other performance characteristics (e.g., the formation efficiency and VED) do not appear to be strongly correlated to graphite choice. Formation efficiency is defined as cycling start discharge capacity (discharge capacity at cycle 3) divided by the first cycle charge capacity. Among the type D (50 wt. % graphite) battery cells shown in Table 10, variations in the N80 values (cycle life) were observed, ranging between ˜933 cycles (G8-comprising battery cells) and ˜1421 cycles (G1-comprising battery cells). However, the G8 graphite sample has a D₅₀ value of about 6.8 μm, which is smaller than some of the other graphite samples considered. In some implementations, a mass fraction of the graphite active material particles in the anode active material is in a range of about 60 to about 93 wt. % (e.g., about 60 to about 70 wt. %, about 70 to about 90 wt. %, or about 90 to about 93 wt. %). In some implementations, a mass ratio of the Si—C nanocomposite particles to the graphite active material particles is in a range of about 7:93 to about 40:60 (e.g., about 7:93 to about 10:90, about 10:90 to about 30:70, or about 30:70 to about 40:60). In some implementations, the average Cx value of at least some of the graphite active material particles is in a range of about 18 MPa to about 30 MPa (e.g., about 20 MPa to about 30 MPa, about 18 MPa to about 20 MPa, about 20 MPa to about 24 MPa, or about 24 MPa to about 30 MPa). In some implementations, the D/G ratio of at least some of the graphite active material particles is in a range of about 0.02 to about 1.12 (e.g., about 0.08 to about 0.30, or about 0.12 to about 0.30). In some implementations, the D₅₀ value of at least some of the graphite active material particles is in a range of about 2 to about 22 μm (e.g., about 11 to about 17 μm, or about 12 to about 17 μm). In some implementations, the D₉₀ value of at least some of the graphite active material particles is in a range of about 4 to about 30 μm (e.g., about 19 to about 30 μm, or about 19 to about 26 μm). In some implementations, the D₁₀ value of at least some of the graphite active material particles is in a range of about 0.5 to about 15 μm (e.g., about 5 to about 11 μm, or about 7 to about 11 μm). In some implementations, the BET-SSA value of at least some of the graphite active material particles is in a range of about 0.450 to about 450 m²/g (e.g., about 1 to about 5 m²/g, about 1 to about 2 m²/g, or about 1 to about 3 m²/g). In some implementations, a tap density of the at least some of the graphite active material particles ranges from about 0.10 g/cc to about 1.25 g/cc (e.g., about 0.90 g/cc to about 1.20 g/cc, or about 0.90 g/cc to about 1.10 g/cc).

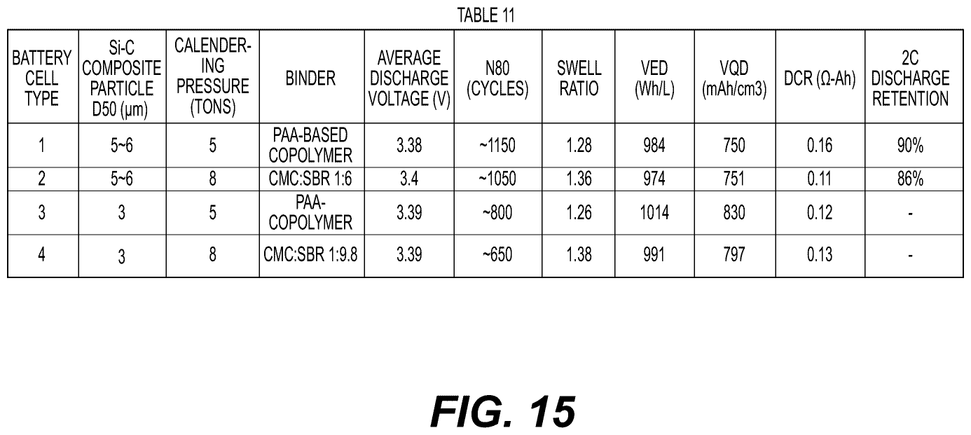

FIG. 15 shows Table 11, listing certain anode characteristics (the particle size (D₅₀) values of the respective Si—C nanocomposite particle populations, calendering pressure during battery anode formation, binder material used in battery anode formation) and certain battery performance characteristics of lithium-ion battery cells employing graphite particles (G1) and the Si—C nanocomposite particles (with the graphite particles G1 at a mass fraction of 10 wt. % in the respective anode active materials in the examples of Table 11). Table 11 compares the performance of battery cells for different binders and different particle sizes (D₅₀ values) of Si—C nanocomposite particles. Battery cells of four different types are represented. Type 1 battery cells are similar to those reported in FIGS. 10A, 10B, and 10C, employing a PAA salt-based copolymer binder in the anode and Si—C nanocomposite particles with D₅₀ values in a range of 5 to 6 μm. Type 3 battery cells are similar to the type 1 battery cells except that the Si—C nanocomposite particles are smaller, with D₅₀ values of about 3 μm. The anode coatings in the type 1 and type 3 battery cells underwent calendering at a calendering pressure of about 5 tons. Type 2 and type 4 battery cells employ a CMC:SBR binder in the anode instead of the PAA salt-based copolymer binder. In the type 2 battery cell, the CMC:SBR mass ratio is about 1:6, and in the type 4 battery cell, the CMC:SBR mass ratio is about 1:9.8. The D₅₀ values of the Si—C nanocomposite particles are 5 to 6 μm for the type 2 battery cells and about 3 μm for the type 4 battery cells. The anode coatings in the type 2 and type 4 battery cells underwent calendering at a calendering pressure of about 8 tons. Table 11 reports the following battery performance characteristics, from left to right: average discharge voltage, N80, swell ratio, VED, VQD, direct current resistance (DCR), and capacity retention at 2C discharge (2C discharge retention). N80, VED, and VQD are defined elsewhere herein. An average discharge voltage of a battery cell is defined as the discharge energy (Wh) divided by discharge capacity (Ah). Swell ratio is a unitless metric that is expressed as the average thickness of the lithiated electrodes divided by the average thickness of the processed electrode prior to electrolyte soaking. DC resistance (DCR) is determined as follows: A series of high-rate current pulses are applied to the cell at a predetermined state-of-charge (e.g., 10% state-of-charge, 50% state-of-charge, etc.), and the resulting voltages are measured. An average voltage is determined by averaging over the respective voltages that are measured for each of the current pulses. The DCR is the average voltage divided by the normalized applied current. The DCR is typically normalized to allow for a comparison that eliminates factors such as cell size, capacity, or energy. When DCR is normalized by capacity, it is expressed in O-Ah. The normalized applied current is expressed as the applied current (expressed in A) divided by the cell's capacity (the capacity is expressed in Ah). In the examples shown in Table 11, DCR was measured at a state-of-charge of 50% at a discharge rate of 2.3C for 30 sec of total pulse time. The capacity retention (also sometimes referred to as normalized capacity or relative discharge capacity) is defined as the charge capacity obtained for a given discharge rate (e.g., 2C rate in this case) (expressed in mAh) normalized to (divided by) the cycling start capacity (capacity at cycle 3) (expressed in mAh), which is typically a low C equilibrium state. The results of Table 11 show that CMC:SBR binders may be substituted for PAA-based binders in blended anodes of Si—C nanocomposite particles and graphite particles. For performance characteristics such as average discharge voltage, DCR, and high-rate capacity retention (e.g., at 2C discharge, or 2.8C discharge), CMC:SBR binders may be preferable in some implementations. PAA-based (copolymer) binders may be preferable for improved VED (larger VED) in some implementations. The anodes employing CMC:SBR exhibit greater swell ratio values, but smaller expansion in the x-y directions parallel to the coating, compared to anodes employing PAA salt-based (copolymer) binders. A change in the Si—C nanocomposite particle size (D₅₀) from 5-6 μm to about 3 μm results in an increase in VED and a decrease in N80. The DCR of the battery cells employing 3 μm Si—C nanocomposite particles (type 3 and type 4) exhibit lower DCR values than the battery cells of 5-6 μm Si—C nanocomposite particles and a PAA-based (copolymer) binder (type 1 battery cells).

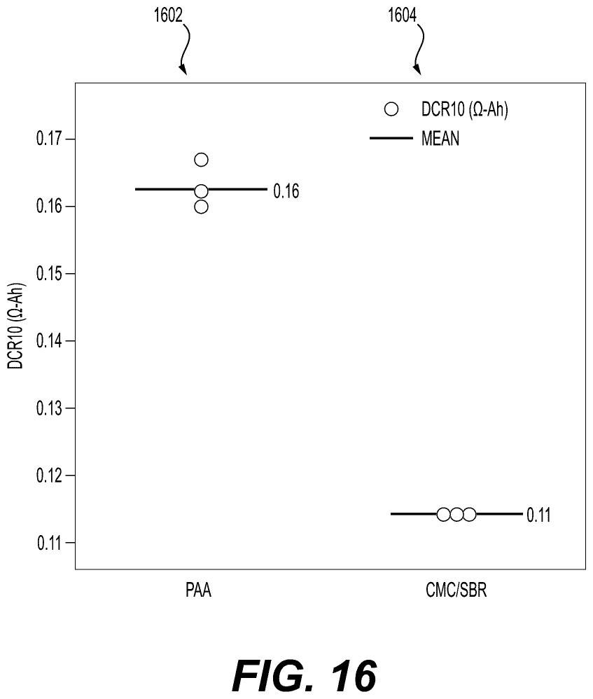

FIG. 16 shows graphical plots of the DC resistance (DCR) values of lithium-ion battery cells employing a PAA copolymer-based binder system (1602) and a CMC:SBR binder system (1604). Both types of lithium-ion battery cells employed a blended anode of Si—C nanocomposite particles and graphite particles (G1) (with the mass fraction of graphite particles G1 at 10 wt. % of the respective anode active materials). Graphical plot 1602 shows the DCR of type 1 battery cells of Table 11. Graphical plot 1604 shows the DCR of type 2 battery cells of Table 11.

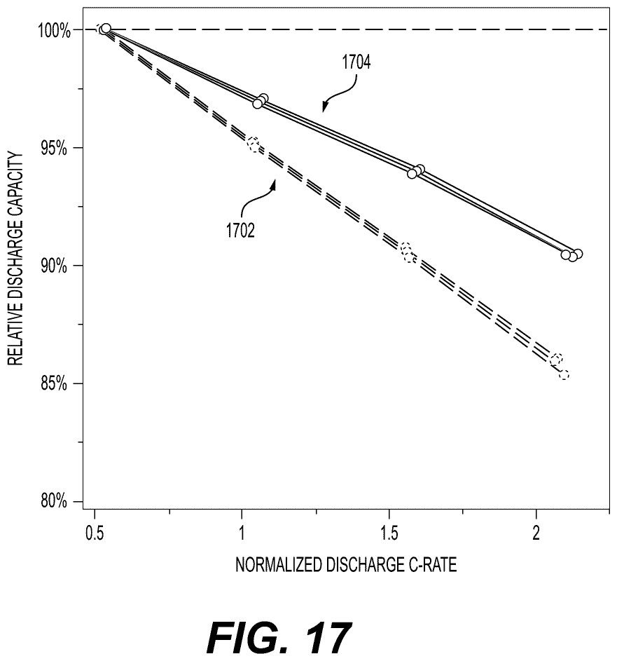

FIG. 17 shows graphical plots of the dependence of the relative discharge capacities (capacity retention) on normalized discharge rate (C-rate) (C-rate ranging between about 0.5 and about 2) for lithium-ion battery cells employing a PAA copolymer-based binder (1702) and a CMC:SBR binder (1704). Both types of lithium-ion battery cells employed a blended anode of Si—C nanocomposite particles and graphite particles (G1) (with the mass fraction of graphite particles G1 at 10 wt. % of the respective anode active materials). Graphical plot 1702 shows the relative discharge capacities (capacity retention) of type 1 battery cells of Table 11. Graphical plot 1704 shows the relative discharge capacities (capacity retention) of type 2 battery cells of Table 11. The discharge capacity retention for type 1 battery cells is higher than those of type 2 battery cells in the C-rate range 0.6 to 2.2.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A battery anode, comprising: a binder; a conductive additive; and an active material blend comprising silicon (Si)-comprising active material particles and graphite active material particles, wherein: the battery anode has a reversible capacity loading in a range of about 2 mAh/cm² to about 16 mAh/cm²; the Si-comprising active material particles exhibit a specific (i.e., lithiation) capacity in a range of about 800 mAh/g to about 3000 mAh/g (e.g., about 800-1400 mAh/g or about 1400-1750 mAh/g or about 1750-2250 mAh/g or about 2250-2500 mAh/g or about 2500-3000 mAh/g); the Si-comprising active material particles contribute from about 25% to about 99% of a total capacity of the battery anode; and at least some of the graphite active material particles are characterized by a Raman spectrum (e.g., collected using 532 nm laser) in which a full-width half-maximum (FWHM) of a D band is in a range of about 30 cm⁻¹ to about 90 cm⁻¹, a FWHM of a G band is in a range from about 5 cm⁻¹ to about 105 cm⁻¹, a FWHM of a 2D₁ band is in a range from about 30 cm⁻¹ to about 110 cm⁻¹, and a D/G peak intensity ratio, defined as an intensity of a D peak divided by an intensity of a G peak, is in a range from about 0.02 to about 1.12.

Clause 2. The battery anode of clause 1, wherein the D/G peak intensity ratio is in a range from about 0.12 to about 0.30.

Clause 3. The battery anode of any of clauses 1 to 2, wherein: a 2D₁/G peak intensity ratio, defined as an intensity of a 2D₁ peak of the Raman spectrum (e.g., collected using 532 nm laser) divided by the intensity of the G peak, is in a range from about 0.10 to about 0.90.

Clause 4. The battery anode of any of clauses 1 to 3, wherein: the at least some of the graphite active material particles are characterized by an X-ray diffraction (XRD) spectrum in which a FWHM of a (002) reflection is within a range from about 0.220 degrees to about 5.620 degrees.

Clause 5. The battery anode of clause 4, wherein the FWHM of the (002) reflection is within a range from about 0.220 degrees to about 0.620 degrees.

Clause 6. The battery anode of any of clauses 4 to 5, wherein: an average crystallite size of the at least some of the graphite active material particles as estimated by applying the Scherrer formula to the (002) reflection is in a range of about 1 nm to about 40 nm.

Clause 7. The battery anode of clause 6, wherein the average crystallite size is within a range of about 15 nm to about 30 nm.

Clause 8. The battery anode of any of clauses 1 to 7, wherein: an average pressure (Cx) required to deform the at least some of the graphite active material particles by 10% during a micro-compression hardness test ranges from about 1 MPa to about 30 MPa.

Clause 9. The battery anode of clause 8, wherein: the average pressure ranges from about 1 MPa to about 18 MPa.

Clause 10. The battery anode of any of clauses 1 to 9, wherein: a tap density of the at least some of the graphite active material particles ranges from about 0.10 g/cc to about 1.25 g/cc.

Clause 11. The battery anode of clause 10, wherein: the tap density ranges from about 0.90 g/cc to about 1.10 g/cc.

Clause 12. The battery anode of any of clauses 1 to 11, wherein: a pycnometry density of the at least some of the graphite active material particles ranges from about 2.15 g/cc to about 2.35 g/cc.

Clause 13. The battery anode of any of clauses 1 to 12, wherein: a fiftieth-percentile volume-weighted particle size parameter D₅₀ of the at least some of the graphite active material particles ranges from about 2 m to about 22 m.

Clause 14. The battery anode of clause 13, wherein: the D₅₀ ranges from about 12 μm to about 17 μm.

Clause 15. The battery anode of any of clauses 1 to 14, wherein: a ninetieth-percentile volume-weighted particle size parameter D₉₀ of the at least some of the graphite active material particles ranges from about 4 m to about 30 m.

Clause 16. The battery anode of clause 15, wherein: the D₉₀ ranges from about 19 μm to about 26 m.

Clause 17. The battery anode of any of clauses 1 to 16, wherein: a tenth-percentile volume-weighted particle size parameter D₁₀ of the at least some of the graphite active material particles ranges from about 0.5 m to about 15 m.

Clause 18. The battery anode of clause 17, wherein: the D₁₀ ranges from about 7 m to about 11 m.

Clause 19. The battery anode of any of clauses 1 to 18, wherein: a Brunauer-Emmett-Teller (BET) specific surface area (SSA) of the at least some of the graphite active material particles ranges from about 0.450 m²/g to about 450 m²/g.

Clause 20. The battery anode of clause 19, wherein: the BET-SSA ranges from about 1 m²/g to about 5 m²/g.

Clause 21. The battery anode of any of clauses 1 to 20, wherein: a weight fraction of the at least some of the graphite active material particles in the battery anode is in a range of about 1 wt. % to about 50 wt. % of the active material blend.

Clause 22. The battery anode of clause 21, wherein: wherein the weight fraction is in a range of about 2 wt. % to about 20 wt. % of the active material blend.

Clause 23. The battery anode of any of clauses 1 to 22, wherein: the Si-comprising active material particles comprise oxygen (O) atoms at about 5 wt. % or less (in other designs, at about 2 wt. % or less; in yet other designs, at about 1 wt. % or less) of a total mass of the Si-comprising active material particles.

Clause 24. The battery anode of any of clauses 1 to 23, wherein: the Si-comprising active material particles comprise silicon (Si) atoms and carbon (C) atoms, in aggregate, in a range of 80 wt. % to about 100 wt. %. of a total mass of the Si-comprising active material particles.

Clause 25. The battery anode of clause 24, wherein: the Si-comprising active material particles comprise Si—C nanocomposite particles.

Clause 26. The battery anode of clause 25, wherein: the Si-comprising active material particles comprise Si nanoparticles.

Clause 27. The battery anode of clause 26, wherein: at least some of the Si nanoparticles are coated with a conductive carbon layer (e.g., about 0.3-10 nm in average thickness).

Clause 27. The battery anode of clause 26, wherein: a weight average size of the Si nanoparticles ranges from about 2 nm to about 40 nm.

Clause 28. The battery anode of clause 26, wherein: an average grain size of the Si nanoparticles ranges from about 1 nm to about 20 nm, as estimated from X-ray diffraction using a Scherrer equation.

Clause 29. The battery anode of clause 25, wherein: the Si-comprising active material particles are Si—C nanocomposite particles that exhibit a true density as measured using N₂ pycnometry in a range from about 1.4 to about 1.9 g/cc (e.g., about 1.4-1.6 g/cc or about 1.6-1.75 g/cc or about 1.75-1.9 g/cc).

Clause 30. The battery anode of clause 25, wherein: the Si-comprising active material particles are Si—C nanocomposite particles exhibit a fiftieth-percentile volume-weighted particle size parameter (D₅₀) in a range from about 4 to about 16 micron (e.g., about 4-7 micron or 7-10 micron or about 10-13 micron or about 13-16 micron or about 7-13 micron).

Clause 31. The battery anode of any of clauses 1 to 30, wherein: the at least some of the graphite active material particles exhibit a specific capacity in a range of about 320 mAh/g to about 372 mAh/g.

Clause 32. A lithium-ion battery, comprising: the battery anode of any of clauses 1 to 31; a cathode; a separator electrically separating the battery anode and the cathode; and an electrolyte ionically coupling the battery anode and the cathode.

Implementation examples are described in the following numbered additional clauses:

Additional clause 1. A battery anode, comprising: a binder; a conductive additive; and an active material blend comprising silicon (Si)-comprising active material particles and graphite active material particles, wherein: the battery anode has a reversible capacity loading in a range of about 2 mAh/cm² to about 16 mAh/cm²; the Si-comprising active material particles exhibit a specific capacity in a range of about 800 mAh/g to about 3000 mAh/g (e.g., about 800-1400 mAh/g or about 1400-1750 mAh/g or about 1750-2250 mAh/g or about 2250-2500 mAh/g or about 2500-3000 mAh/g); the Si-comprising active material particles contribute from about 25% to about 99% of a total capacity of the battery anode; and at least a subset of the graphite active material particles is characterized by a Raman spectrum (e.g., collected using 532 nm laser) in which a full-width half-maximum (FWHM) of a D band is in a range of about 30 cm⁻¹ to about 90 cm⁻¹, a FWHM of a G band is in a range from about 5 cm⁻¹ to about 105 cm¹, a FWHM of a 2D₁ band is in a range from about 30 cm⁻¹ to about 110 cm¹, and a D/G peak intensity ratio, defined as an intensity of a D peak divided by an intensity of a G peak, is in a range from about 0.02 to about 1.12.

Additional clause 2. The battery anode of additional clause 1, wherein the D/G peak intensity ratio is in a range from about 0.12 to about 0.30.

Additional clause 3. The battery anode of any of additional clauses 1 to 2, wherein: a 2D₁/G peak intensity ratio, defined as an intensity of a 2D₁ peak of the Raman spectrum (e.g., collected using 532 nm laser) divided by the intensity of the G peak, is in a range from about 0.10 to about 0.90.

Additional clause 4. The battery anode of any of additional clauses 1 to 3, wherein: the at least the subset of the graphite active material particles is characterized by an X-ray diffraction (XRD) spectrum in which a FWHM of a (002) reflection peak is within a range from about 0.220 degrees to about 5.620 degrees.

Additional clause 5. The battery anode of additional clause 4, wherein the FWHM of the (002) reflection peak is within a range from about 0.220 degrees to about 0.620 degrees.

Additional clause 6. The battery anode of any of additional clauses 4 to 5, wherein: an average crystallite size of the at least the subset of the graphite active material particles as estimated by applying the Scherrer formula to the (002) reflection peak is in a range of about 1 nm to about 40 nm.

Additional clause 7. The battery anode of additional clause 6, wherein the average crystallite size is within a range of about 15 nm to about 30 nm.

Additional clause 8. The battery anode of any of additional clauses 1 to 7, wherein: an average pressure (Cx) required to deform the at least the subset of the graphite active material particles by 10% during a micro-compression hardness test ranges from about 1 MPa to about 30 MPa.

Additional clause 9. The battery anode of additional clause 8, wherein: the average pressure ranges from about 1 MPa to about 18 MPa.

Additional clause 10. The battery anode of any of additional clauses 1 to 9, wherein: a tap density of the at least the subset of the graphite active material particles ranges from about 0.10 g/cc to about 1.25 g/cc.

Additional clause 11. The battery anode of additional clause 10, wherein: the tap density ranges from about 0.90 g/cc to about 1.10 g/cc.

Additional clause 12. The battery anode of any of additional clauses 1 to 11, wherein: a pycnometry density of the at least the subset of the graphite active material particles ranges from about 2.15 g/cc to about 2.35 g/cc.

Additional clause 13. The battery anode of any of additional clauses 1 to 12, wherein: a fiftieth-percentile volume-weighted particle size parameter (D₅₀) of the at least the subset of the graphite active material particles ranges from about 2 m to about 22 m.

Additional clause 14. The battery anode of additional clause 13, wherein: the D₅₀ ranges from about 12 m to about 17 m.

Additional clause 15. The battery anode of any of additional clauses 1 to 14, wherein: a ninetieth-percentile volume-weighted particle size parameter (D₉₀) of the at least the subset of the graphite active material particles ranges from about 4 m to about m.

Additional clause 16. The battery anode of additional clause 15, wherein: the D₉₀ ranges from about 19 μm to about 26 m.

Additional clause 17. The battery anode of any of additional clauses 1 to 16, wherein: a tenth-percentile volume-weighted particle size parameter (D₁₀) of the at least the subset of the graphite active material particles ranges from about 0.5 m to about 15 m.

Additional clause 18. The battery anode of additional clause 17, wherein: the D₁₀ ranges from about 7 μm to about 11 μm.

Additional clause 19. The battery anode of any of additional clauses 1 to 18, wherein: a Brunauer-Emmett-Teller (BET) specific surface area (SSA) of the at least the subset of the graphite active material particles ranges from about 0.450 m²/g to about 450 m²/g.

Additional clause 20. The battery anode of additional clause 19, wherein: the BET-SSA ranges from about 1 m²/g to about 5 m²/g.

Additional clause 21. The battery anode of any of additional clauses 1 to 20, wherein: a weight fraction of the at least the subset of the graphite active material particles in the battery anode is in a range of about 1 wt. % to about 50 wt. % of the active material blend.

Additional clause 22. The battery anode of additional clause 21, wherein: the weight fraction is in a range of about 2 wt. % to about 20 wt. % of the active material blend.

Additional clause 23. The battery anode of any of additional clauses 1 to 22, wherein: the Si-comprising active material particles comprise oxygen (O) atoms at about 5 wt. % or less (in other designs, at about 2 wt. % or less; in yet other designs, at about 1 wt. % or less) of a total mass of the Si-comprising active material particles.

Additional clause 24. The battery anode of any of additional clauses 1 to 23, wherein: the Si-comprising active material particles comprise silicon (Si) atoms and carbon (C) atoms, in aggregate, in a range of 80 wt. % to about 100 wt. %. of a total mass of the Si-comprising active material particles.

Additional clause 25. The battery anode of additional clause 24, wherein: the Si-comprising active material particles comprise Si—C nanocomposite particles.

Additional clause 26. The battery anode of any of additional clauses 1 to 25, wherein: the at least the subset of the graphite active material particles exhibits a specific capacity in a range of about 320 mAh/g to about 372 mAh/g.

Additional clause 27. A lithium-ion battery, comprising: the battery anode of additional clause 1; a cathode; a separator electrically separating the battery anode and the cathode; and an electrolyte ionically coupling the battery anode and the cathode.

Additional clause 28. A battery anode, comprising: a binder; a conductive additive; and an active material blend comprising silicon (Si)-comprising active material particles and graphite active material particles, wherein: a mass fraction of the Si in the Si-comprising active material particles is in a range of about 20 wt. % to about 80 wt. %; a mass ratio of the Si-comprising active material particles to the graphite active material particles is in a range of about 60:40 to about 98:2; at least a subset of the graphite active material particles is characterized by a Raman spectrum (e.g., collected using 532 nm laser) in which a full-width half-maximum (FWHM) of a D band is in a range of about 30 cm⁻¹ to about 90 cm⁻¹, a FWHM of a G band is in a range from about 5 cm⁻¹ to about 105 cm⁻¹, a FWHM of a 2D₁ band is in a range from about 30 cm⁻¹ to about 110 cm⁻¹, and a D/G peak intensity ratio, defined as an intensity of a D peak divided by an intensity of a G peak, is in a range from about 0.02 to about 1.12; and an average pressure (Cx) required to deform the at least the subset of the graphite active material particles by 10% during a micro-compression hardness test ranges from about 1 MPa to about 18 MPa.

Additional clause 29. The battery anode of additional clause 28, wherein: the mass ratio of the Si-comprising active material particles to the graphite active material particles is in a range of about 75:25 to about 95:5.

Additional clause 30. The battery anode of any of additional clauses 28 to 29, wherein: the average pressure ranges from about 7 MPa to about 18 MPa.

Additional clause 31. The battery anode of additional clause 30, wherein: the average pressure ranges from about 10 MPa to about 18 MPa.

Additional clause 32. The battery anode of any of additional clauses 28 to 31, wherein the D/G peak intensity ratio is in a range from about 0.12 to about 0.30.

Additional clause 33. The battery anode of any of additional clauses 28 to 32, wherein: a tap density of the at least the subset of the graphite active material particles ranges from about 0.10 g/cc to about 1.25 g/cc.

Additional clause 34. The battery anode of additional clause 33, wherein: the tap density ranges from about 0.90 g/cc to about 1.10 g/cc.

Additional clause 35. The battery anode of any of additional clauses 28 to 34, wherein: a fiftieth-percentile volume-weighted particle size parameter (D₅₀) of the at least the subset of the graphite active material particles ranges from about 2 m to about 22 m.

Additional clause 36. The battery anode of additional clause 35, wherein: the D₅₀ ranges from about 11 m to about 17 m.

Additional clause 37. The battery anode of additional clause 36, wherein: the D₅₀ ranges from about 12 m to about 17 m.

Additional clause 38. The battery anode of any of additional clauses 28 to 37, wherein: a ninetieth-percentile volume-weighted particle size parameter (D₉₀) of the at least the subset of the graphite active material particles ranges from about 4 m to about 30 μm.

Additional clause 39. The battery anode of additional clause 38, wherein: the D₉n ranges from about 19 μm to about 30 μm.

Additional clause 40. The battery anode of additional clause 39, wherein: the D₉₀ ranges from about 19 μm to about 26 m.

Additional clause 41. The battery anode of any of additional clauses 28 to 40, wherein: a tenth-percentile volume-weighted particle size parameter (D₁₀) of the at least the subset of the graphite active material particles ranges from about 0.5 m to about 15 m.

Additional clause 42. The battery anode of additional clause 41, wherein: the D₁₀ ranges from about 5 m to about 11 m.

Additional clause 43. The battery anode of additional clause 42, wherein: the D₁₀ ranges from about 7 m to about 11 μm.

Additional clause 44. The battery anode of any of additional clauses 28 to 43, wherein: a Brunauer-Emmett-Teller (BET) specific surface area (SSA) of the at least the subset of the graphite active material particles ranges from about 0.450 m²/g to about 450 m²/g.

Additional clause 45. The battery anode of additional clause 44, wherein: the BET-SSA ranges from about 1 m²/g to about 5 m²/g.

Additional clause 46. The battery anode of additional clause 45, wherein: the BET-SSA ranges from about 1 m²/g to about 3 m²/g.

Additional clause 47. The battery anode of any of additional clauses 28 to 46, wherein: the Si-comprising active material particles comprise oxygen (O) atoms at about 5 wt. % or less (in other designs, at about 2 wt. % or less; in yet other designs, at about 1 wt. % or less) of a total mass of the Si-comprising active material particles.

Additional clause 48. The battery anode of any of additional clauses 28 to 47, wherein: the Si-comprising active material particles comprise silicon (Si) atoms and carbon (C) atoms, in aggregate, in a range of about 80 wt. % to about 100 wt. %. of a total mass of the Si-comprising active material particles.

Additional clause 49. The battery anode of additional clause 48, wherein: the Si-comprising active material particles comprise Si—C nanocomposite particles.

Additional clause 50. The battery anode of any of additional clauses 28 to 49, wherein: the at least the subset of the graphite active material particles exhibits a specific capacity in a range of about 320 mAh/g to about 372 mAh/g.

Additional clause 51. The battery anode of any of additional clauses 28 to 50, wherein: the battery anode has a reversible capacity loading in a range of about 2 mAh/cm² to about 16 mAh/cm².

Additional clause 52. A lithium-ion battery, comprising: the battery anode of additional clause 28; a cathode; a separator electrically separating the battery anode and the cathode; and an electrolyte ionically coupling the battery anode and the cathode.

Additional clause 53. A battery anode, comprising: a binder; a conductive additive; and an active material blend comprising silicon (Si)-comprising active material particles and graphite active material particles, wherein: a mass fraction of the Si in the Si-comprising active material particles is in a range of about 20 wt. % to about 80 wt. %; a mass ratio of the Si-comprising active material particles to the graphite active material particles is in a range of about 7:93 to about 40:60; at least a subset of the graphite active material particles is characterized by a Raman spectrum (e.g., collected using 532 nm laser) in which a full-width half-maximum (FWHM) of a D band is in a range of about 30 cm⁻¹ to about 90 cm⁻¹, a FWHM of a G band is in a range from about 5 cm⁻¹ to about 105 cm⁻¹, a FWHM of a 2D₁ band is in a range from about 30 cm⁻¹ to about 110 cm⁻¹, and a D/G peak intensity ratio, defined as an intensity of a D peak divided by an intensity of a G peak, is in a range from about 0.02 to about 1.12; and an average pressure (Cx) required to deform the at least the subset of the graphite active material particles by 10% during a micro-compression hardness test ranges from about 20 MPa to about 30 MPa.

Additional clause 54. The battery anode of additional clause 53, wherein: the mass ratio of the Si-comprising active material particles to the graphite active material particles is in a range of about 10:90 to about 30:70.

Additional clause 55. The battery anode of any of additional clauses 53 to 54, wherein: the average pressure ranges from about 24 MPa to about 30 MPa.

Additional clause 56. The battery anode of any of additional clauses 53 to 55, wherein the D/G peak intensity ratio is in a range from about 0.08 to about 0.30.

Additional clause 57. The battery anode of any of additional clauses 53 to 56, wherein: a tap density of the at least the subset of the graphite active material particles ranges from about 0.10 g/cc to about 1.25 g/cc.

Additional clause 58. The battery anode of additional clause 57, wherein: the tap density ranges from about 0.90 g/cc to about 1.20 g/cc.

Additional clause 59. The battery anode of additional clause 58, wherein: the tap density ranges from about 0.90 g/cc to about 1.10 g/cc.

Additional clause 60. The battery anode of any of additional clauses 53 to 59, wherein: a fiftieth-percentile volume-weighted particle size parameter (D₅₀) of the at least the subset of the graphite active material particles ranges from about 2 m to about 22 m.

Additional clause 61. The battery anode of additional clause 60, wherein: the D₅₀ ranges from about 11 m to about 17 m.

Additional clause 62. The battery anode of additional clause 61, wherein: the D₅₀ ranges from about 12 m to about 17 m.

Additional clause 63. The battery anode of any of additional clauses 53 to 62, wherein: a ninetieth-percentile volume-weighted particle size parameter (D₉₀) of the at least the subset of the graphite active material particles ranges from about 4 m to about m.

Additional clause 64. The battery anode of additional clause 63, wherein: the D₉₀ ranges from about 19 μm to about 30 m.

Additional clause 65. The battery anode of any of additional clauses 53 to 64, wherein: a tenth-percentile volume-weighted particle size parameter (D₁₀) of the at least the subset of the graphite active material particles ranges from about 0.5 m to about 15 m.

Additional clause 66. The battery anode of additional clause 65, wherein: the D₁₀ ranges from about 5 μm to about 11 μm.

Additional clause 67. The battery anode of any of additional clauses 53 to 66, wherein: a Brunauer-Emmett-Teller (BET) specific surface area (SSA) of the at least the subset of the graphite active material particles ranges from about 0.450 m²/g to about 450 m²/g.

Additional clause 68. The battery anode of additional clause 67, wherein: the BET-SSA ranges from about 1 m²/g to about 5 m²/g.

Additional clause 69. The battery anode of additional clause 68, wherein: the BET-SSA ranges from about 1 m²/g to about 3 m²/g.

Additional clause 70. The battery anode of any of additional clauses 53 to 69, wherein: the Si-comprising active material particles comprise oxygen (O) atoms at about 5 wt. % or less (in other designs, at about 2 wt. % or less; in yet other designs, at about 1 wt. % or less) of a total mass of the Si-comprising active material particles.

Additional clause 71. The battery anode of any of additional clauses 53 to 70, wherein: The Si-comprising active material particles comprise silicon (Si) atoms and carbon (C) atoms, in aggregate, in a range of about 80 wt. % to about 100 wt. %. of a total mass of the Si-comprising active material particles.

Additional clause 72. The battery anode of additional clause 71, wherein: the Si-comprising active material particles comprise Si—C nanocomposite particles.

Additional clause 73. The battery anode of any of additional clauses 53 to 72, wherein: the at least the subset of the graphite active material particles exhibits a specific capacity in a range of about 320 mAh/g to about 372 mAh/g.

Additional clause 74. The battery anode of any of additional clauses 53 to 73, wherein: the battery anode has a reversible capacity loading in a range of about 2 mAh/cm² to about 16 mAh/cm².

Additional clause 75. A lithium-ion battery, comprising: the battery anode of additional clause 53; a cathode; a separator electrically separating the battery anode and the cathode; and an electrolyte ionically coupling the battery anode and the cathode.

Additional clause 76. The battery anode of any of additional clauses 1 to 75, wherein: the Si-comprising active material particles comprise Si nanoparticles.

Additional clause 77. The battery anode of additional clause 75, wherein: at least some of the Si nanoparticles are coated with a conductive carbon layer (e.g., about 0.3-10 nm in average thickness).

Additional clause 78. The battery anode of additional clause 75, wherein: a weight average size of the Si nanoparticles ranges from about 2 nm to about 40 nm.

Additional clause 79. The battery anode of additional clause 75, wherein: an average grain size of the Si nanoparticles ranges from about 1 nm to about 20 nm, as estimated from X-ray diffraction using a Scherrer equation.

Additional clause 80. The battery anode of any of additional clauses 1 to 79, wherein: the Si-comprising active material particles are Si—C nanocomposite particles that exhibit a true density as measured using N₂ pycnometry in a range from about 1.4 to about 1.9 g/cc (e.g., about 1.4-1.6 g/cc or about 1.6-1.75 g/cc or about 1.75-1.9 g/cc).

Additional clause 81. The battery anode of any of additional clauses 1 to 79, wherein: the Si-comprising active material particles are Si—C nanocomposite particles that exhibit a fiftieth-percentile volume-weighted particle size parameter (D₅₀) in a range from about 4 to about 16 micron (e.g., about 4-7 micron or 7-10 micron or about 10-13 micron or about 13-16 micron or about 7-13 micron).

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A battery anode, comprising:
a binder;
a conductive additive; and
an active material blend comprising silicon (Si)-comprising active material particles and graphite active material particles,
wherein:
the battery anode has a reversible capacity loading in a range of about 2 mAh/cm² to about 16 mAh/cm²;
the Si-comprising active material particles exhibit a specific capacity in a range of about 800 mAh/g to about 3000 mAh/g;
the Si-comprising active material particles contribute from about 25% to about 99% of a total capacity of the battery anode; and
at least a subset of the graphite active material particles is characterized by a Raman spectrum in which a full-width half-maximum (FWHM) of a D band is in a range of about 30 cm⁻¹ to about 90 cm¹, a FWHM of a G band is in a range from about 5 cm⁻¹ to about 105 cm¹, a FWHM of a 2D₁ band is in a range from about 30 cm⁻¹ to about 110 cm⁻¹, and a D/G peak intensity ratio, defined as an intensity of a D peak divided by an intensity of a G peak, is in a range from about 0.02 to about 1.12.

2. The battery anode of claim 1, wherein the D/G peak intensity ratio is in a range from about 0.12 to about 0.30.

3. The battery anode of claim 1, wherein:
a 2D₁/G peak intensity ratio, defined as an intensity of a 2D₁ peak of the Raman spectrum divided by the intensity of the G peak, is in a range from about 0.10 to about 0.90.

4. The battery anode of claim 1, wherein:
the at least the subset of the graphite active material particles is characterized by an X-ray diffraction (XRD) spectrum in which a FWHM of a (002) reflection peak is within a range from about 0.220 degrees to about 5.620 degrees.

5. The battery anode of claim 4, wherein the FWHM of the (002) reflection peak is within a range from about 0.220 degrees to about 0.620 degrees.

6. The battery anode of claim 4, wherein:
an average crystallite size of the at least the subset of the graphite active material particles as estimated by applying the Scherrer formula to the (002) reflection peak is in a range of about 1 nm to about 40 nm.

7. The battery anode of claim 6, wherein the average crystallite size is within a range of about 15 nm to about 30 nm.

8. The battery anode of claim 1, wherein:
an average pressure (Cx) required to deform the at least the subset of the graphite active material particles by 10% during a micro-compression hardness test ranges from about 1 MPa to about 30 MPa.

9. The battery anode of claim 8, wherein:
the average pressure ranges from about 1 MPa to about 18 MPa.

10. The battery anode of claim 1, wherein:
a tap density of the at least the subset of the graphite active material particles ranges from about 0.10 g/cc to about 1.25 g/cc.

11. The battery anode of claim 10, wherein:
the tap density ranges from about 0.90 g/cc to about 1.10 g/cc.

12. The battery anode of claim 1, wherein:
a pycnometry density of the at least the subset of the graphite active material particles ranges from about 2.15 g/cc to about 2.35 g/cc.

13. The battery anode of claim 1, wherein:
a fiftieth-percentile volume-weighted particle size parameter (D₅₀) of the at least the subset of the graphite active material particles ranges from about 2 m to about 22 m.

14. The battery anode of claim 13, wherein:
the D₅₀ ranges from about 12 m to about 17 m.

15. The battery anode of claim 1, wherein:
a ninetieth-percentile volume-weighted particle size parameter (D₉₀) of the at least the subset of the graphite active material particles ranges from about 4 m to about 30 m.

16. The battery anode of claim 15, wherein:
the D₉₀ ranges from about 19 μm to about 26 m.

17. The battery anode of claim 1, wherein:
a tenth-percentile volume-weighted particle size parameter (D₁₀) of the at least the subset of the graphite active material particles ranges from about 0.5 m to about 15 m.

18. The battery anode of claim 17, wherein:
the D₁₀ ranges from about 7 m to about 11 m.

19. The battery anode of claim 1, wherein:
a Brunauer-Emmett-Teller (BET) specific surface area (SSA) of the at least the subset of the graphite active material particles ranges from about 0.450 m²/g to about 450 m²/g.

20. The battery anode of claim 19, wherein:
the BET-SSA ranges from about 1 m²/g to about 5 m²/g.

21. The battery anode of claim 1, wherein:
a weight fraction of the at least the subset of the graphite active material particles in the battery anode is in a range of about 1 wt. % to about 50 wt. % of the active material blend.

22. The battery anode of claim 21, wherein:
the weight fraction is in a range of about 2 wt. % to about 20 wt. % of the active material blend.

23. The battery anode of claim 1, wherein:
the Si-comprising active material particles comprise oxygen (O) atoms at about 5 wt. % or less of a total mass of the Si-comprising active material particles.

24. The battery anode of claim 1, wherein:
the Si-comprising active material particles comprise silicon (Si) atoms and carbon (C) atoms, in aggregate, in a range of 80 wt. % to about 100 wt. % of a total mass of the Si-comprising active material particles.

25. The battery anode of claim 24, wherein:
the Si-comprising active material particles comprise Si—C nanocomposite particles.

26. The battery anode of claim 1, wherein:
the at least the subset of the graphite active material particles exhibits a specific capacity in a range of about 320 mAh/g to about 372 mAh/g.

27. A lithium-ion battery, comprising:
the battery anode of claim 1;
a cathode;
a separator electrically separating the battery anode and the cathode; and
an electrolyte ionically coupling the battery anode and the cathode.

28. A battery anode, comprising:
a binder;
a conductive additive; and
an active material blend comprising silicon (Si)-comprising active material particles and graphite active material particles,
wherein:
a mass fraction of the Si in the Si-comprising active material particles is in a range of about 20 wt. % to about 80 wt. %;
a mass ratio of the Si-comprising active material particles to the graphite active material particles is in a range of about 60:40 to about 98:2;
at least a subset of the graphite active material particles is characterized by a Raman spectrum in which a full-width half-maximum (FWHM) of a D band is in a range of about 30 cm⁻¹ to about 90 cm⁻¹, a FWHM of a G band is in a range from about 5 cm⁻¹ to about 105 cm⁻¹, a FWHM of a 2D₁ band is in a range from about 30 cm⁻¹ to about 110 cm⁻¹, and a D/G peak intensity ratio, defined as an intensity of a D peak divided by an intensity of a G peak, is in a range from about 0.02 to about 1.12; and
an average pressure (Cx) required to deform the at least the subset of the graphite active material particles by 10% during a micro-compression hardness test ranges from about 1 MPa to about 18 MPa.

29. The battery anode of claim 28, wherein:
the mass ratio of the Si-comprising active material particles to the graphite active material particles is in a range of about 75:25 to about 95:5.

30. The battery anode of claim 28, wherein:
the average pressure ranges from about 7 MPa to about 18 MPa.

31. The battery anode of claim 30, wherein:
the average pressure ranges from about 10 MPa to about 18 MPa.

32. The battery anode of claim 28, wherein the D/G peak intensity ratio is in a range from about 0.12 to about 0.30.

33. The battery anode of claim 28, wherein:
a tap density of the at least the subset of the graphite active material particles ranges from about 0.10 g/cc to about 1.25 g/cc.

34. The battery anode of claim 33, wherein:
the tap density ranges from about 0.90 g/cc to about 1.10 g/cc.

35. The battery anode of claim 28, wherein:
a fiftieth-percentile volume-weighted particle size parameter (D₅₀) of the at least the subset of the graphite active material particles ranges from about 2 m to about 22 m.

36. The battery anode of claim 35, wherein:
the D₅₀ ranges from about 11 m to about 17 m.

37. The battery anode of claim 36, wherein:
the D₅₀ ranges from about 12 m to about 17 m.

38. The battery anode of claim 28, wherein:
a ninetieth-percentile volume-weighted particle size parameter (D₉₀) of the at least the subset of the graphite active material particles ranges from about 4 m to about 30 m.

39. The battery anode of claim 38, wherein:
the D₉₀ ranges from about 19 μm to about 30 am.

40. The battery anode of claim 39, wherein:
the D₉₀ ranges from about 19 μm to about 26 am.

41. The battery anode of claim 28, wherein:
a tenth-percentile volume-weighted particle size parameter (D₁₀) of the at least the subset of the graphite active material particles ranges from about 0.5 m to about 15 am.

42. The battery anode of claim 41, wherein:
the D₁₀ ranges from about 5 m to about 11 m.

43. The battery anode of claim 42, wherein:
the D₁₀ ranges from about 7 m to about 11 m.

44. The battery anode of claim 28, wherein:
a Brunauer-Emmett-Teller (BET) specific surface area (SSA) of the at least the subset of the graphite active material particles ranges from about 0.450 m²/g to about 450 m²/g.

45. The battery anode of claim 44, wherein:
the BET-SSA ranges from about 1 m²/g to about 5 m²/g.

46. The battery anode of claim 45, wherein:
the BET-SSA ranges from about 1 m²/g to about 3 m²/g.

47. The battery anode of claim 28, wherein:
the Si-comprising active material particles comprise oxygen (O) atoms at about 5 wt. % or less of a total mass of the Si-comprising active material particles.

48. The battery anode of claim 28, wherein:
the Si-comprising active material particles comprise silicon (Si) atoms and carbon (C) atoms, in aggregate, in a range of about 80 wt. % to about 100 wt. % of a total mass of the Si-comprising active material particles.

49. The battery anode of claim 48, wherein:
the Si-comprising active material particles comprise Si—C nanocomposite particles.

50. The battery anode of claim 28, wherein:
the at least the subset of the graphite active material particles exhibits a specific capacity in a range of about 320 mAh/g to about 372 mAh/g.

51. The battery anode of claim 28, wherein:
the battery anode has a reversible capacity loading in a range of about 2 mAh/cm² to about 16 mAh/cm².

52. A lithium-ion battery, comprising:
the battery anode of claim 28;
a cathode;
a separator electrically separating the battery anode and the cathode; and
an electrolyte ionically coupling the battery anode and the cathode.

53. A battery anode, comprising:
a binder;
a conductive additive; and
an active material blend comprising silicon (Si)-comprising active material particles and graphite active material particles,
wherein:
a mass fraction of the Si in the Si-comprising active material particles is in a range of about 20 wt. % to about 80 wt. %;
a mass ratio of the Si-comprising active material particles to the graphite active material particles is in a range of about 7:93 to about 40:60;
at least a subset of the graphite active material particles is characterized by a Raman spectrum in which a full-width half-maximum (FWHM) of a D band is in a range of about 30 cm⁻¹ to about 90 cm⁻¹, a FWHM of a G band is in a range from about 5 cm⁻¹ to about 105 cm⁻¹, a FWHM of a 2D₁ band is in a range from about 30 cm⁻¹ to about 110 cm⁻¹, and a D/G peak intensity ratio, defined as an intensity of a D peak divided by an intensity of a G peak, is in a range from about 0.02 to about 1.12; and
an average pressure (Cx) required to deform the at least the subset of the graphite active material particles by 10% during a micro-compression hardness test ranges from about 20 MPa to about 30 MPa.

54. The battery anode of claim 53, wherein:
the mass ratio of the Si-comprising active material particles to the graphite active material particles is in a range of about 10:90 to about 30:70.

55. The battery anode of claim 53, wherein:
the average pressure ranges from about 24 MPa to about 30 MPa.

56. The battery anode of claim 53, wherein the D/G peak intensity ratio is in a range from about 0.08 to about 0.30.

57. The battery anode of claim 53, wherein:
a tap density of the at least the subset of the graphite active material particles ranges from about 0.10 g/cc to about 1.25 g/cc.

58. The battery anode of claim 57, wherein:
the tap density ranges from about 0.90 g/cc to about 1.20 g/cc.

59. The battery anode of claim 58, wherein:
the tap density ranges from about 0.90 g/cc to about 1.10 g/cc.

60. The battery anode of claim 53, wherein:
a fiftieth-percentile volume-weighted particle size parameter (D₅₀) of the at least the subset of the graphite active material particles ranges from about 2 m to about 22 m.

61. The battery anode of claim 60, wherein:
the D₅₀ ranges from about 11 m to about 17 m.

62. The battery anode of claim 61, wherein:
the D₅₀ ranges from about 12 m to about 17 m.

63. The battery anode of claim 53, wherein:
a ninetieth-percentile volume-weighted particle size parameter (D₉₀) of the at least the subset of the graphite active material particles ranges from about 4 m to about 30 μm.

64. The battery anode of claim 63, wherein:
the D₉₀ ranges from about 19 μm to about 30 m.

65. The battery anode of claim 53, wherein:
a tenth-percentile volume-weighted particle size parameter (D₁₀) of the at least the subset of the graphite active material particles ranges from about 0.5 m to about 15 m.

66. The battery anode of claim 65, wherein:
the D₁₀ ranges from about 5 m to about 11 m.

67. The battery anode of claim 53, wherein:
a Brunauer-Emmett-Teller (BET) specific surface area (SSA) of the at least the subset of the graphite active material particles ranges from about 0.450 m²/g to about 450 m²/g.

68. The battery anode of claim 67, wherein:
the BET-SSA ranges from about 1 m²/g to about 5 m²/g.

69. The battery anode of claim 68, wherein:
the BET-SSA ranges from about 1 m²/g to about 3 m²/g.

70. The battery anode of claim 53, wherein:
the Si-comprising active material particles comprise oxygen (O) atoms at about 5 wt. % or less of a total mass of the Si-comprising active material particles.

71. The battery anode of claim 53, wherein:
The Si-comprising active material particles comprise silicon (Si) atoms and carbon (C) atoms, in aggregate, in a range of about 80 wt. % to about 100 wt. % of a total mass of the Si-comprising active material particles.

72. The battery anode of claim 71, wherein:
the Si-comprising active material particles comprise Si—C nanocomposite particles.

73. The battery anode of claim 53, wherein:
the at least the subset of the graphite active material particles exhibits a specific capacity in a range of about 320 mAh/g to about 372 mAh/g.

74. The battery anode of claim 53, wherein:
the battery anode has a reversible capacity loading in a range of about 2 mAh/cm² to about 16 mAh/cm².

75. A lithium-ion battery, comprising:
the battery anode of claim 53;
a cathode;
a separator electrically separating the battery anode and the cathode; and
an electrolyte ionically coupling the battery anode and the cathode.
